(19) United States
(12) Patent Application Publication
(10) Pub. No.: US 2023/0188384 A1
(43) Pub. Date: Jun. 15, 2023

(54) METHOD, APPARATUS, AND SYSTEM FOR WIRELESS SENSING BASED ON MULTIPLE GROUPS OF WIRELESS DEVICES

(71) Applicants: David N. Claffey, Somerville, MA (US); Hung-Quoc Duc Lai, Parkville, MD (US); Linghe Wang, Irvine, CA (US); Chun-I Chen, Brookeville, MD (US); Chun-Chia Jack Shih, Hanover, MD (US); Beibei Wang, Clarksville, MD (US); Oscar Chi-Lim Au, San Jose, CA (US); K. J. Ray Liu, Potomac, MD (US)

(72) Inventors: David N. Claffey, Somerville, MA (US); Hung-Quoc Duc Lai, Parkville, MD (US); Linghe Wang, Irvine, CA (US); Chun-I Chen, Brookeville, MD (US); Chun-Chia Jack Shih, Hanover, MD (US); Beibei Wang, Clarksville, MD (US); Oscar Chi-Lim Au, San Jose, CA (US); K. J. Ray Liu, Potomac, MD (US)

(21) Appl. No.: 18/108,563

(22) Filed: Feb. 10, 2023

Related U.S. Application Data
(63) Continuation-in-part of application No. 17/325,185, filed on May 19, 2021, now Pat. No. 11,512,840.
Application No. 17/325,185 is a continuation-in-part of application No. 16/871,004, filed on May 10, 2020.
Application No. 16/871,004 is a continuation-in-part of application No. 16/909,913, filed on Jun. 23, 2020.
Application No. 16/909,913 is a continuation-in-part of application No. 17/113,023, filed on Dec. 5, 2020.
Application No. 17/113,023 is a continuation-in-part of application No. 17/492,642, filed on Oct. 3, 2021, now Pat. No. 11,639,981.
Application No. 17/492,642 is a continuation-in-part of application No. 17/149,625, filed on Jan. 14, 2021.
Application No. 17/149,625 is a continuation-in-part of application No. 17/180,763, filed on Feb. 20, 2021, now Pat. No. 11,592,913.
Application No. 17/180,763 is a continuation-in-part of application No. 17/180,766, filed on Feb. 20, 2021.
Application No. 17/180,766 is a continuation-in-part of application No. 17/352,306, filed on Jun. 20, 2021.
Application No. 17/352,306 is a continuation-in-part of application No. 17/537,432, filed on Nov. 29, 2021.
Application No. 17/537,432 is a continuation-in-part of application No. 17/539,058, filed on Nov. 30, 2021.
Application No. 17/539,058 is a continuation-in-part of application No. 17/827,902, filed on May 30, 2022.
Application No. 17/827,902 is a continuation-in-part of application No. 17/838,228, filed on Jun. 12, 2022.
Application No. 17/838,228 is a continuation-in-part of application No. 17/838,231, filed on Jun. 12, 2022.
Application No. 17/838,231 is a continuation-in-part of application No. 17/838,244, filed on Jun. 12, 2022.
Application No. 17/838,244 is a continuation-in-part of application No. 17/888,429, filed on Aug. 15, 2022.
Application No. 17/888,429 is a continuation-in-part of application No. 17/891,037, filed on Aug. 18, 2022.
Application No. 17/891,037 is a continuation-in-part of application No. 17/945,995, filed on Sep. 15, 2022.
Application No. 17/945,995 is a continuation-in-part of application No. 17/959,487, filed on Oct. 4, 2022.
Application No. 17/959,487 is a continuation-in-part of application No. 17/960,080, filed on Oct. 4, 2022.
(60) Provisional application No. 63/308,927, filed on Feb. 10, 2022.
(60) Provisional application No. 63/332,658, filed on Apr. 19, 2022.
(60) Provisional application No. 63/349,082, filed on Jun. 4, 2022.
(60) Provisional application No. 63/354,184, filed on Jun. 21, 2022.
(60) Provisional application No. 63/388,625, filed on Jul. 12, 2022.

(51) Int. Cl. H04L 25/02

(52) U.S. Cl. CPC H04L 25/0206; H04L 25/022

(57) ABSTRACT

Methods, apparatus and systems for wireless sensing using multiple groups of wireless devices are described. In one example, a described system comprises: heterogeneous wireless devices in a venue, and a processor. A particular device is configured to communicate with a first device through a first wireless channel based on a first protocol using a first radio, and configured to communicate with a second device through a second wireless channel based on a second protocol using a second radio. The processor is configured for: obtaining a time series of channel information (TSCI) of the second wireless channel based on a wireless signal communicated between the particular device and the second device; computing a pairwise sensing analytics based on the TSCI; and computing a combined sensing analytics based on the pairwise sensing analytics. The particular device transmits the combined sensing analytics to the first device, to perform a wireless sensing task.

### CROSS-REFERENCE TO RELATED APPLICATIONS

The present application hereby incorporates by reference the entirety of the disclosures of, and claims priority to, each of the following cases:
(a) U.S. patent application Ser. No. 16/790,610, entitled “METHOD, APPARATUS, AND SYSTEM FOR WIRELESS GAIT RECOGNITION”, filed Feb. 13, 2020,
(b) U.S. patent application Ser. No. 16/871,004, entitled “METHOD, APPARATUS, AND SYSTEM FOR PEOPLE COUNTING AND RECOGNITION BASED ON RHYTHMIC MOTION MONITORING”, filed on May 10, 2020,
(c) U.S. patent application Ser. No. 16/909,913, entitled “METHOD, APPARATUS, AND SYSTEM FOR IMPROVING TOPOLOGY OF WIRELESS SENSING SYSTEMS”, filed on Jun. 23, 2020,
(d) U.S. patent application Ser. No. 17/113,023, entitled “METHOD, APPARATUS, AND SYSTEM FOR ACCURATE WIRELESS MONITORING”, filed on Dec. 5, 2020,
(e) U.S. patent application Ser. No. 17/492,642, entitled “METHOD, APPARATUS, AND SYSTEM FOR MOVEMENT TRACKING”, filed on Oct. 3, 2021,
(f) U.S. patent application Ser. No. 17/149,625, entitled “METHOD, APPARATUS, AND SYSTEM FOR WIRELESS MONITORING WITH MOTION LOCALIZATION”, filed on Jan. 14, 2021,
(g) U.S. patent application Ser. No. 17/180,763, entitled “METHOD, APPARATUS, AND SYSTEM FOR WIRELESS WRITING TRACKING”, filed on Feb. 20, 2021,
(h) U.S. patent application Ser. No. 17/180,766, entitled “METHOD, APPARATUS, AND SYSTEM FOR WIRELESS MOTION RECOGNITION”, filed on Feb. 20, 2021,
(i) U.S. patent application Ser. No. 17/352,185, entitled “METHOD, APPARATUS, AND SYSTEM FOR WIRELESS MICRO MOTION MONITORING”, filed on Jun. 18, 2021,
(j) U.S. patent application Ser. No. 17/352,306, entitled “METHOD, APPARATUS, AND SYSTEM FOR WIRELESS MONITORING TO ENSURE SECURITY”, filed on Jun. 20, 2021,
(k) U.S. patent application Ser. No. 17/537,432, entitled “METHOD, APPARATUS, AND SYSTEM FOR AUTOMATIC AND ADAPTIVE WIRELESS MONITORING AND TRACKING”, filed on Nov. 29, 2021,
(l) U.S. patent application Ser. No. 17/539,058, entitled “METHOD, APPARATUS, AND SYSTEM FOR HUMAN IDENTIFIATION BASED ON HUMAN RADIO BIOMETRIC INFORMATION”, filed on Nov. 30, 2021,
(m) U.S. Provisional Patent application 63/308,927, entitled “METHOD, APPARATUS, AND SYSTEM FOR WIRELESS SENSING BASED ON MULTIPLE GROUPS OF WIRELESS DEVICES”, filed on Feb. 10, 2022,
(n) U.S. Provisional Patent application 63/332,658, entitled “METHOD, APPARATUS, AND SYSTEM FOR WIRELESS SENSING”, filed on Apr. 19, 2022,
(o) U.S. patent application Ser. No. 17/827,902, entitled “METHOD, APPARATUS, AND SYSTEM FOR SPEECH ENHANCEMENT AND SEPARATOIN BASED ON AUDIO AND RADIO SIGNALS”, filed on May 30, 2022,
(p) U.S. Provisional Patent application 63/349,082, entitled “METHOD, APPARATUS, AND SYSTEM FOR WIRELESS SENSING VOICE ACTIVITY DETECTION”, filed on Jun. 4, 2022,
(q) U.S. patent application Ser. No. 17/838,228, entitled “METHOD, APPARATUS, AND SYSTEM FOR WIRELESS SENSING BASED ON CHANNEL INFORMATION”, filed on Jun. 12, 2022,
(r) U.S. patent application Ser. No. 17/838,231, entitled “METHOD, APPARATUS, AND SYSTEM FOR IDENTIFYING AND QUALIFYING DEVICES FOR WIRELESS SENSING”, filed on Jun. 12, 2022,
(s) U.S. patent application Ser. No. 17/838,244, entitled “METHOD, APPARATUS, AND SYSTEM FOR WIRELESS SENSING BASED ON LINKWISE MOTION STATISTICS”, filed on Jun. 12, 2022,
(t) U.S. Provisional Patent application 63/354,184, entitled “METHOD, APPARATUS, AND SYSTEM FOR MOTION LOCALIZATION AND OUTLIER REMOVAL”, filed on Jun. 21, 2022,
(u) U.S. Provisional Patent application 63/388,625, entitled “METHOD, APPARATUS, AND SYSTEM FOR WIRELESS SENSING AND INDOOR LOCALIZATION”, filed on Jul. 12, 2022,
(v) U.S. patent application Ser. No. 17/888,429, entitled “METHOD, APPARATUS, AND SYSTEM FOR RADIO BASED SLEEP TRACKING”, filed on Aug. 15, 2022,
(w) U.S. patent application Ser. No. 17/891,037, entitled “METHOD, APPARATUS, AND SYSTEM FOR MAP RECONSTRUCTION BASED ON WIRELESS TRACKING”, filed on Aug. 18, 2022.
(x) U.S. patent application Ser. No. 17/945,995, entitled “METHOD, APPARATUS, AND SYSTEM FOR WIRELESS VITAL MONITORING USING HIGH FREQUENCY SIGNALS”, filed on Sep. 15, 2022,
(y) U.S. patent application Ser. No. 17/959,487, entitled “METHOD, APPARATUS, AND SYSTEM FOR VOICE ACTIVITY DETECTION BASED ON RADIO SIGNALS”, filed on Oct. 4, 2022,
(z) U.S. patent application Ser. No. 17/960,080, entitled “METHOD, APPARATUS, AND SYSTEM FOR ENHANCED WIRELESS MONITORING OF VITAL SIGNS”, filed on Oct. 4, 2022.

### TECHNICAL FIELD

The present teaching generally relates to wireless sensing. More specifically, the present teaching relates to wireless sensing using multiple groups of wireless devices.

### BACKGROUND

With the proliferation of Internet of Things (IoT) applications, billions of household appliances, phones, smart devices, security systems, environment sensors, vehicles and buildings, and other radio-connected devices will transmit data and communicate with each other or people, and everything will be able to be measured and tracked all the time. Among the various approaches to measure what is happening in the surrounding environment, wireless sensing has received an increasing attention in recent years because of the ubiquitous deployment of wireless radio devices. In addition, human activities affect wireless signal propagations, therefore understanding and analyzing the way how wireless signals react to human activities can reveal rich information about the activities. As more bandwidth becomes available in the new generation of wireless systems, wireless sensing will make many smart IoT applications only imagined today possible in the near future. That is because when the bandwidth increases, one can see many more multipaths, in a rich-scattering environment such as in indoors or metropolitan area, which can be treated as hundreds of virtual antennas/sensors. Because there may be many IoT devices available for wireless sensing, an efficient and effective method for making use multiple devices for wireless sensing is desirable.

### SUMMARY

The present teaching generally relates to wireless sensing. More specifically, the present teaching relates to the present teaching relates to wireless sensing using multiple groups of wireless devices.

In one embodiment, a system for wireless sensing is described. The system comprises: a set of heterogeneous wireless devices in a venue, and a processor. The set of heterogeneous wireless devices comprise: a first device, a second device, and a particular device. The particular device comprises a first radio and a second radio. The particular device is configured to communicate with the first device through a first wireless channel based on a first protocol using the first radio, and configured to communicate with the second device through a second wireless channel based on a second protocol using the second radio. The processor is configured for: obtaining a time series of channel information (TSCI) of the second wireless channel based on a wireless signal that is communicated between the particular device and the second device through the second wireless channel using the second radio of the particular device, wherein each channel information (CI) comprises at least one of: channel state information (CSI), channel impulse response (CIR) or channel frequency response (CFR); computing a pairwise sensing analytics based on the TSCI; and computing a combined sensing analytics based on the pairwise sensing analytics. The particular device is configured to transmit the combined sensing analytics to the first device through the first wireless channel using the first radio of the particular device. The set of heterogeneous wireless devices is configured to perform a wireless sensing task based on the combined sensing analytics.

In another embodiment, a method performed by a set of heterogeneous wireless devices in a venue for wireless sensing, is described. The method comprises: communicatively coupling a particular device of the set with a first device of the set through a first wireless channel based on a first protocol using a first radio of the particular device; communicatively coupling the particular device with a second device of the set through a second wireless channel based on a second protocol using a second radio of the particular device; performing a pairwise sub-task by the particular device and the second device based on a wireless signal communicated between the particular device and the second device through the second wireless channel using the second radio of the particular device; obtaining by the particular device a pairwise sensing analytics computed based on a time series of channel information (TSCI) of the second wireless channel extracted from the wireless signal, wherein each channel information (CI) comprises at least one of: channel state information (CSI), channel impulse response (CIR) or channel frequency response (CFR); computing a combined sensing analytics by the particular device based on the pairwise sensing analytics; transmitting the combined sensing analytics by the particular device to the first device through the first wireless channel using the first radio of the particular device; and performing a wireless sensing task based on the combined sensing analytics.

Other concepts relate to software for implementing the present teaching on wireless sensing using multiple groups of devices. Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF DRAWINGS

The methods, systems, and/or devices described herein are further described in terms of exemplary embodiments. These exemplary embodiments are described in detail with reference to the drawings. These embodiments are non-limiting exemplary embodiments, in which like reference numerals represent similar structures throughout the several views of the drawings.

FIG. 1 illustrates an exemplary scenario for wireless sensing in a venue, according to some embodiments of the present disclosure.

FIG. 2 illustrates an exemplary floor plan and placement of wireless devices for wireless sensing, according to some embodiments of the present disclosure.

FIG. 3 illustrates an exemplary block diagram of a first wireless device of a system for wireless sensing, according to some embodiments of the present disclosure.

FIG. 4 illustrates an exemplary block diagram of a second wireless device of a system for wireless sensing, according to some embodiments of the present disclosure.

FIG. 5 illustrates a flow chart of an exemplary method for hybrid radio-plus-aux fall-down detection based on wireless sensing, according to some embodiments of the present disclosure.

FIG. 6 illustrates an exemplary system for performing wireless sensing in a venue with multiple groups of devices with a per-room deployment, according to some embodiments of the present disclosure.

FIG. 7 illustrates an exemplary system for performing wireless sensing in a venue with multiple groups of devices with a whole-home deployment, according to some embodiments of the present disclosure.

FIG. 8 illustrates a flow chart of an exemplary method for performing wireless sensing in a venue with multiple groups of devices, according to some embodiments of the present disclosure.

FIG. 9 illustrates an exemplary floor plan for wireless sensing to display sensing motion statistics and analytics, according to some embodiments of the present disclosure.

FIG. 10 illustrates a flow chart of an exemplary method of a wireless sensing presentation system, according to some embodiments of the present disclosure.

FIG. 11 illustrates a flow chart of an exemplary method for performing a selective sensing-by-proxy procedure, according to some embodiments of the present disclosure.

### DETAILED DESCRIPTION

The symbol “/” disclosed herein means “and/or”. For example, “A/B” means “A and/or B.” In some embodiments, a method/device/system/software of a wireless monitoring system is disclosed. A time series of channel information (CI) of a wireless multipath channel is obtained using a processor, a memory communicatively coupled with processor and a set of instructions stored in memory. The time series of CI (TSCI) may be extracted from a wireless signal transmitted from a Type1 heterogeneous wireless device (e.g. wireless transmitter (TX), “Bot” device) to a Type2 heterogeneous wireless device (e.g. wireless receiver (RX), “Origin” device) in a venue through the channel. The channel is impacted by an expression/motion of an object in venue. A characteristics/spatial-temporal information (STI)/motion information (MI) of object/expression/motion may be computed/monitored based on the TSCI. A task may be performed based on the characteristics/STI/MI. A task-related presentation may be generated in a user-interface (UI) on a device of a user.

Expression may comprise placement, placement of moveable parts, location/speed/acceleration/position/orientation/direction/identifiable place/region/presence/spatial coordinate, static expression/presentation/state/size/length/width/height/angle/scale/curve/surface/area/volume/pose/posture/manifestation/body language, dynamic expression/motion/sequence/movement/activity/behavior/gesture/gait/extension/contraction/distortion/deformation, body expression (e.g. head/face/eye/mouth/tongue/hair/voice/neck/limbs/arm/hand/leg/foot/muscle/moveable parts), surface expression/shape/texture/material/color/electromagnetic (EM) characteristics/visual pattern/wetness/reflectance/translucency/flexibility, material property (e.g. living tissue/hair/fabric/metal/wood/leather/plastic/artificial material/solid/liquid/gas/temperature), expression change, and/or some combination.

Wireless multipath channel may comprise: communication channel, analog frequency channel (e.g. with carrier frequency near 700/800/900 MHz, or 1.8/1.9/2.4/3/5/6/27/60/70+GHz), coded channel (e.g. in CDMA), and/or channel of wireless/cellular network/system (e.g. WLAN, WiFi, mesh, 4G/LTE/5G/6G/7G/8G, Bluetooth, Zigbee, UWB, RFID, microwave). It may comprise multiple channels, which may be consecutive (e.g. adjacent/overlapping bands) or non-consecutive (e.g. non-overlapping bands, 2.4 GHz/5 GHz). While channel is used to transmit wireless signal and perform sensing measurements, data (e.g. TSCI/feature/component/characteristics/STI/MIanalytics/task outputs, auxiliary/non-sensing data/network traffic) may be communicated/transmitted in channel.

Wireless signal may comprise a series of probe signals. It may be any of: EM radiation, radio frequency (RF)/light/bandlimited/baseband signal, signal in licensed/unlicensed/ISM band, wireless/mobile/cellular/optical communication/network/mesh/downlink/uplink/unicast/multicast/broadcast signal. It may be compliant to standard/protocol (e.g. WLAN, WWAN, WPAN, WBAN, international/national/industry/defacto, IEEE/802/802.11/15/16, WiFi, 802.11n/ac/ax/be/bf, 3G/4G/LTE/5G/6G/7G/8G, 3GPP/Bluetooth/BLE/Zigbee/NFC/RFID/UWB/WiMax). A probe signal may comprise any of: protocol/standard/beacon/pilot/sounding/excitation/illumination/handshake/synchronization/reference/source/motion probe/detection/sensing/management/control/data/null-data/beacon/pilot/request/response/association/reassociation/disassociation/authentication/action/report/poll/announcement/extension/enquiry/ac knowledgement frame/packet/signal, and/or null-data-frame (NDP)/RTS/CTS/QoS/CF-Poll/CF-Ack/block acknowledgement/reference/training/synchronization. It may comprise line-of-sight (LOS)/non-LOS components (or paths/links). It may have data embedded. Probe signal may be replaced by (or embedded in) data signal. Each frame/packet/signal may comprise: preamble/header/payload. It may comprise: training sequence, short (STF)/long (LTF) training field, L-STF/L-LTF/L-SIG/HE-STF/IE-LTF/IE-SIG-A/HE-SIG-B, channel estimation field (CEF). It may be used to transfer power wirelessly from Type1 device to Type2 device. Sounding rate of signal may be adjusted to control amount of transferred power. Probe signals may be sent in burst.

TSCI may be extracted/obtained (e.g. by IC/chip) from wireless signal at a layer of Type2 device (e.g. layer of OSI reference model, PHY/MAC/data link/logical link control/network/transport/session/presentation/application layer, TCP/IP/internet/link layer). It may be extracted from received wireless/derived signal. It may comprise wireless sensing measurements obtained in communication protocol (e.g. wireless/cellular communication standard/network, 4G/LTE/5G/6G/7G/8G, WiFi, IEEE 802.11/11bf/15/16). Each CI may be extracted from a probe/sounding signal, and may be associated with time stamp. TSCI may be associated with starting/stopping time/duration/amount of CI/sampling/sounding frequency/period. A motion detection/sensing signal may be recognized/identified base on probe signal. TSCI may be stored/retrieved/accessed/preprocessed/processed/postprocessed/conditioned/analyzed/monitored. TSCI/features/components/characteristics/STI/MI/analytics/task outcome may be communicated to edge/cloud server/Type1/Type2/hub/data aggregator/another device/system/network.

Type1/Type2 device may comprise components (hardware/software) such as electronics/chip/integrated circuit (IC)/RF circuitry/antenna/modem/TX/RX/transceiver/RF interface (e.g. 2.4/5/6/27/60/70+GHz radio/front/back haul radio)/network/interface/processor/memory/module/circuit/board/software/firmware/connectors/structure/enclosure/housing/structure. It may comprise access point (AP)/base-station/mesh/router/repeater/hub/wireless station/client/terminal/“Origin Satellite”/“Tracker Bot”, and/or internet-of-things (IoT)/appliance/wearable/accessory/peripheral/furniture/amenity/gadget/vehicle/module/wireless- enabled/unicast/multicast/broadcasting/node/hub/target/sensor/portable/mobile/cellular/communication/motion-detection/source/destination/standard-compliant device. It may comprise additional attributes such as auxiliary functionality/network connectivity/purpose/brand/model/appearance/form/shape/color/material/specification. It may be heterogeneous because the above (e.g. components/device types/additional attributes) may be different for different Type1 (or Type2) devices.

Type1/Type2 devices may/may not be authenticated/associated/collocated. They may be same device. Type1/Type2/portable/nearby/another device, sensing/measurement session/link between them, and/or object/expression/motion/characteristics/STI/MI/task may be associated with an identity/identification/identifier (ID) such as UUID, associated/unassociated STA ID (ASID/USID/AID/UID). Type2 device may passively observe/monitor/receive wireless signal from Type1 device without establishing connection (e.g. association/authentication/handshake) with, or requesting service from, Type1 device. Type1/Type2 device may move with object/another object to be tracked.

Type1 (TX) device may function as Type2 (RX) device temporarily/sporadically/continuously/repeatedly/interchangeably/alternately/simultaneously/contemporaneously/concurrently; and vice versa. Type1 device may be Type2 device. A device may function as Type1/Type2 device temporarily/sporadically/continuously/repeatedly/simultaneously/concurrently/contemporaneously. There may be multiple wireless nodes each being Type1/Type2 device. TSCI may be obtained between two nodes when they exchange/communicate wireless signals. Characteristics/STI/MI of object may be monitored individually based on a TSCI, or jointly based on multiple TSCI.

Motion/expression of object may be monitored actively with Type1/Type2 device moving with object (e.g. wearable devices/automated guided vehicle/AGV), or passively with Type1/Type2 devices not moving with object (e.g. both fixed devices).

Task may be performed with/without reference to reference/trained/initial database/profile/baseline that is trained/collected/processed/computed/transmitted/stored in training phase. Database may be re-training/updated/reset.

Presentation may comprise UI/GUI/text/message/form/webpage/visual/image/video/graphics/animation/graphical/symbol/emoticon/sign/color/shade/sound/music/speech/audio/mechanical/gesture/vibration/haptics presentation. Time series of characteristic/STI/MI/task outcome/another quantity may be displayed/presented in presentation. Any computation may be performed/shared by processor (or logic unit/chip/IC)/Type1/Type2/user/nearby/another device/local/edge/cloud server/hub/data/signal analysis subsystem/sensing initiator/response/SBP initiator/responder/AP/non-AP. Presentation may comprise any of: monthly/weekly/daily/simplified/detailed/cross-sectional/small/large/form-factor/color-coded/comparative/summary/web view, animation/voice announcement/another presentation related to periodic/repetition characteristics of repeating motion/expression.

Multiple Type1 (or Type 2) devices may interact with a Type2 (or Type1) device. The multiple Type1 (or Type2) devices may be synchronized/asynchronous, and/or may use same/different channels/sensing parameters/settings (e.g. sounding frequency/bandwidth/antennas). Type2 device may receive another signal from Type1/another Type1 device. Type1 device may transmit another signal to Type2/another Type2 device. Wireless signals sent (or received) by them may be sporadic/temporary/continuous/repeated/synchronous/simultaneous/concurrent/contemporaneous. They may operate independently/collaboratively. Their data (e.g. TSCI/feature/characteristics/STI/MI/intermediate task outcomes) may be processed/monitored/analyzed independently or jointly/collaboratively.

Any devices may operate based on some state/internal state/system state. Devices may communicate directly, or via another/nearby/portable device/server/hub device/cloud server. Devices/system may be associated with one or more users, with associated settings. Settings may be chosen/selected/pre-programmed/changed/adjusted/modified/varied over time. The method may be performed/executed in shown order/another order. Steps may be performed in parallel/iterated/repeated. Users may comprise human/adult/older adult/man/woman/juvenile/child/baby/pet/animal/creature/machine/computer module/software. Step/operation/processing may be different for different devices (e.g. based on locations/orientation/direction/roles/user-related characteristics/settings/configurations/available resources/bandwidth/power/network connection/hardware/software/processor/co-processor/memory/battery life/antennas/directional antenna/power setting/device parameters/characteristics/conditions/status/state). Any/all device may be controlled/coordinated by a processor (e.g. associated with Type1/Type2/nearby/portable/another device/server/designated source). Some device may be physically in/of/attached to a common device.

Type1 (or Type2) device may be capable of wirelessly coupling with multiple Type2 (or Type1) devices. Type1 (or Type2) device may be caused/controlled to switch/establish wireless coupling (e.g. association/authentication) from Type2 (or Type1) device to another Type2 (or another Type1) device. The switching may be controlled by server/hub device/processor/Type1 device/Type2 device. Radio channel may be different before/after switching. A second wireless signal may be transmitted between Type1 (or Type2) device and second Type2 (or second Type1) device through the second channel. A second TSCI of second channel may be extracted/obtained from second signal. The first/second signals, first/second channels, first/second Type1 device, and/or first/second Type2 device may be same/similar/co-located.

Type1 device may transmit/broadcast wireless signal to multiple Type2 devices, with/without establishing connection (association/authentication) with individual Type2 devices. It may transmit to a particular/common MAC address, which may be MAC address of some device (e.g. dummy receiver). Each Type2 device may adjust to particular MAC address to receive wireless signal. Particular MAC address may be associated with venue, which may be recorded in an association table of an Association Server (e.g. hub device). Venue may be identified by Type1 device/Type2 device based on wireless signal received at particular MAC address.

For example, Type2 device may be moved to a new venue. Type1 device may be newly set up in venue such that Type1 and Type2 devices are not aware of each other. During set up, Type1 device may be instructed/guided/caused/controlled (e.g. by dummy receiver, hardware pin setting/connection, stored setting, local setting, remote setting, downloaded setting, hub device, and/or server) to send wireless signal (e.g. series of probe signals) to particular MAC address. Upon power up, Type2 device may scan for probe signals according to a table of MAC addresses (e.g. stored in designated source, server, hub device, cloud server) that may be used for broadcasting at different locations (e.g. different MAC address used for different venue such as house/office/enclosure/floor/multi-storey building/store/airport/mall/stadium/hall/station/subway/lot/area/zone/region/district/city/country/continent). When Type2 device detects wireless signal sent to particular MAC address, it can use the table to identify venue.

Channel may be selected from a set of candidate/selectable/admissible channels. Candidate channels may be associated with different frequency bands/bandwidth/carrier frequency/modulation/wireless standards/coding/encryption/payload characteristics/network/ID/SSID/characteristics/settings/parameters. Particular MAC address/selected channel may be changed/adjusted/varied/modified over time (e.g. according to time table/rule/policy/mode/condition/situation/change). Selection/change may be based on availability/collision/traffic pattern/co-channel/inter-channel interference/effective bandwidth/random selection/pre-selected list/plan. It may be done by a server (e.g. hub device). They may be communicated (e.g. from/to Type1/Type2/hub/another device/local/edge/cloud server).

Wireless connection (e.g. association/authentication) between Type1 device and nearby/portable/another device may be established (e.g. using signal handshake). Type1 device may send first handshake signal (e.g. sounding frame/probe signal/request-to-send RTS) to the nearby/portable/another device. Nearby/portable/another device may reply to first signal by sending second handshake signal (e.g. command/clear-to-send/CTS) to Type1 device, triggering Type1 device to transmit/broadcast wireless signal to multiple Type2 devices without establishing connection with the Type2 devices. Second handshake signals may be response/acknowledge (e.g. ACK) to first handshake signal. Second handshake signal may contain information of venue/Type1 device. Nearby/portable/another device may be a dummy device with purpose (e.g. primary purpose, secondary purpose) to establish wireless connection with Type1 device, to receive first signal, or send second signal. Nearby/portable/another device may be physically attached to Type1 device.

In another example, nearby/portable/another device may send third handshake signal to Type1 device triggering Type1 device to broadcast signal to multiple Type2 devices without establishing connection with them. Type1 device may reply to third signal by transmitting fourth handshake signal to the another device.

Nearby/portable/another device may be used to trigger multiple Type1 devices to broadcast. It may have multiple RF circuitries to trigger multiple transmitters in parallel. Triggering may be sequential/partially sequential/partially/fully parallel. Parallel triggering may be achieved using additional device (s) to perform similar triggering in parallel to nearby/portable/another device. After establishing connection with Type1 device, nearby/portable/another device may suspend/stop communication with Type1 device. It may enter an inactive/hibernation/sleep/stand-by/low-power/OFF/power-down mode. Suspended communication may be resumed. Nearby/portable/another device may have the particular MAC address and Type1 device may send signal to particular MAC address.

The (first) wireless signal may be transmitted by a first antenna of Type1 device to some first Type2 device through a first channel in a first venue. A second wireless signal may be transmitted by a second antenna of Type1 device to some second Type2 device through a second channel in a second venue. First/second signals may be transmitted at first/second (sounding) rates respectively, perhaps to first/second MAC addresses respectively. Some first/second channels/signals/rates/MAC addresses/antennas/Type2 devices may be same/different/synchronous/asynchronous. First/second venues may have same/different sizes/shape/multipath characteristics. First/second venues/immediate areas around first/second antennas may overlap. First/second channels/signals may be WiFi+LTE (one being WiFi, one being LTE), or WiFi+WiFi, or WiFi (2.4 GHz)+WiFi (5 GHz), or WiFi (5 GHz, channel=a1, BW=a2)+WiFi (5 GHz/channel=b1, BW=b2). Some first/second items (e.g. channels/signals/rates/MAC addresses/antennas/Type1/Type2 devices) may be changed/adjusted/varied/modified over time (e.g. based on time table/rule/policy/mode/condition/situation/another change).

Each Type1 device may be signal source of multiple Type2 devices (i.e. it sends respective probe signal to respective Type2 device). Each respective Type2 device may choose asynchronously the Type1 device from among all Type1 devices as its signal source. TSCI may be obtained by each respective Type2 device from respective series of probe signals from Type1 device. Type2 device may choose Type1 device from among all Type1 devices as its signal source (e.g. initially) based on identity/identification/identifier of Type1/Type2 device, task, past signal sources, history, characteristics, signal strength/quality, threshold for switching signal source, and/or information of user/account/profile/access info/parameters/input/requirement/criteria.

Database of available/candidate Type1 (or Type2) devices may be initialized/maintained/updated by Type2 (or Type1) device. Type2 device may receive wireless signals from multiple candidate Type1 devices. It may choose its Type1 device (i.e. signal source) based on any of: signal quality/strength/regularity/channel/traffic/characteristics/properties/states/task requirements/training task outcome/MAC addresses/identity/identifier/past signal source/history/user instruction/another consideration.

An undesirable/bad/poor/problematic/unsatisfactory/unacceptable/intolerable/faulty/demanding/undesirable/inadequate/lacking/inferior/unsuitable condition may occur when (1) timing between adjacent probe signals in received wireless signal becomes irregular, deviating from agreed sounding rate (e.g. time perturbation beyond acceptable range), and/or (2) processed/signal strength of received signal is too weak (e.g. below third threshold, or below fourth threshold for significant percentage of time), wherein processing comprises any lowpass/bandpass/highpass/median/moving/weighted average/linear/nonlinear/smoothing filtering. Any thresholds/percentages/parameters may be time-varying. Such condition may occur when Type1/Type2 device become progressively far away, or when channel becomes congested.

Some settings (e.g. Type1-Type2 device pairing/signal source/network/association/probe signal/sounding rate/scheme/channel/bandwidth/system state/TSCI/TSMA/task/task parameters) may be changed/varied/adjusted/modified. Change may be according to time table/rule/policy/mode/condition (e.g. undesirable condition)/another change. For example, sounding rate may normally be 100 Hz, but changed to 1000 Hz in demanding situations, and to 1 Hz in low power/standby situation.

Settings may change based on task requirement (e.g. 100 Hz normally and 1000 Hz momentarily for 20 seconds). In task, instantaneous system may be associated adaptively/dynamically to classes/states/conditions (e.g. low/normal/high priority/emergency/critical/regular/privileged/non-subscription/subscription/paying/non-paying). Settings (e.g. sounding rate) may be adjusted accordingly. Change may be controlled by: server/hub/Type1/Type2 device. Scheduled changes may be made according to time table. Changes may be immediate when emergency is detected, or gradual when developing condition is detected.

Characteristics/STI/MI may be monitored/analyzed individually based on a TSCI associated with a particular Type1/Type2 device pair, or jointly based on multiple TSCI associated multiple Type1/Type2 pairs, or jointly based on any TSCI associated with the particular Type2 device and any Type1 devices, or jointly based on any TSCI associated with the particular Type1 device and any Type2 devices, or globally based on any TSCI associated with any Type1/Type2 devices.

A classifier/classification/recognition/detection/estimation/projection/feature extraction/processing/filtering may be applied (e.g. to CI/CI-feature/characteristics/STI/I), and/or trained/re-trained/updated. In a training stage, training may be performed based on multiple training TSCI of some training wireless multipath channel, or characteristic/STI/I computed from training TSCI, the training TSCI obtained from training wireless signals transmitted from training Type1 devices and received by training Type2 devices. Re-training/updating may be performed in an operating stage based on training TSCI/current TSCI. There may be multiple classes (e.g. groupings/categories/events/motions/expression/activities/objects/locations) associated with venue/regions/zones/location/environment/home/office/building/warehouse/facility object/expression/motion/movement/process/event/manufacturing/assembly-line/maintenance/repairing/navigation/object/emotional/mental/state/condition/stage/gesture/gait/action/motion/presence/movement/daily/activity/history/event.

Classifier may comprise linear/nonlinear/binary/multiclass/Bayes classifier/Fisher linear discriminant/logistic regression/Markov chain/Monte Carlo/deep/neural network/perceptron/self-organization maps/boosting/meta algorithm/decision tree/random forest/genetic programming/kernel learning/KNN/support vector machine (SVM).

Feature extraction/projection may comprise any of: subspace projection/principal component analysis (PCA)/independent component analysis (ICA)/vector quantization/singular value decomposition (SVD)/eigen-decomposition/eigenvalue/time/frequency/orthogonal/non-orthogonal decomposition, processing/preprocessing/postprocessing. Each CI may comprise multiple components (e.g. vector/combination of complex values). Each component may be preprocessed to give magnitude/phase or a function of such.

Feature may comprise: output of feature extraction/projection, amplitude/magnitude/phase/energy/power/strength/intensity, presence/absence/proximity/likelihood/histogram, time/period/duration/frequency/component/decomposition/projection/band, local/global/maximum (max)/minimum (min)/zero-crossing, repeating/periodic/typical/habitual/one-time/atypical/abrupt/mutually-exclusive/evolving/transient/changing/time/related/correlated feature/pattern/trend/profile/events/tendency/inclination/behavior, cause-and-effect/short-term/long-term/correlation/statistics/frequency/period/duration, motion/movement/location/map/coordinate/height/speed/acceleration/angle/rotation/size/volume, suspicious/dangerous/alarming event/warning/belief/proximity/collision, tracking/breathing/heartbeat/gait/action/event/statistical/hourly/daily/weekly/monthly/yearly parameters/statistics/analytics, well-being/health/disease/medical statistics/analytics, an early/instantaneous/contemporaneous/delayed indication/suggestion/sign/indicator/verifier/detection/symptom of a state/condition/situation/disease/biometric, baby/patient/machine/device/temperature/vehicle/parking lot/venue/lift/elevator/spatial/road/fluid flow/home/room/office/house/building/warehouse/storage/system/ventilation/fan/pipe/duct/people/human/car/boat/truck/airplane/drone/downtown/crowd/impulsive event/cyclo-stationary/environment/vibration/material/surface/3D/2D/local/global, and/or another measurable quantity/variable. Feature may comprise monotonic function of feature, or sliding aggregate of features in sliding window.

Training may comprise AI/machine/deep/supervised/unsupervised/discriminative training/auto-encoder/linear discriminant analysis/regression/clustering/tagging/labeling/Monte Carlo computation.

A current event/motion/expression/object in venue at current time may be classified by applying classifier to current TSCI/characteristics/STI/MI obtained from current wireless signal received by Type2 device in venue from Type1 devices in an operating stage. If there are multiple Type1/Type2 devices, some/all (or their locations/antenna locations) may be a permutation of corresponding training Type1/Type2 devices (or locations/antenna locations). Type1/Type2 device/signal/channel/venue/object/motion may be same/different from corresponding training entity. Classifier may be applied to sliding windows. Current TSCI/characteristics/STI/MI may be augmented by training TSCI/characteristics/STI/I (or fragment/extract) to bootstrap classification/classifier.

A first section/segment (with first duration/starting/ending time) of a first TSCI (associated with first Type1-Type2 device pair) may be aligned (e.g. using dynamic time warping/DTW/matched filtering, perhaps based on some mismatch/distance/similarity score/cost, or correlation/autocorrelation/cross-correlation) with a second section/segment (with second duration/starting/ending time) of a second TSCI (associated with second Type1-Type2 device pair), with each CI in first section mapped to a CI in second section. First/second TSCI may be preprocessed. Some similarity score (component/item/link/segment-wise) may be computed. The similarity score may comprise any of: mismatch/distance/similarity score/cost. Component-wise similarity score may be computed between a component of first item (CI/feature/characteristics/STI/MI) of first section and corresponding component of corresponding mapped item (second item) of second section. Item-wise similarity score may be computed between first/second items (e.g. based on aggregate of corresponding component-wise similarity scores). An aggregate may comprise any of: sum/weighted sum, weighted average/robust/trimmed mean/arithmetic/geometric/harmonic mean, median/mode. Link-wise similarity score may be computed between first/second items associated with a link (TX-RX antenna pair) of first/second Type1-Type2 device pairs (e.g. based on aggregate of corresponding item-wise similarity scores). Segment-wise similarity score may be computed between first/second segments (e.g. based on aggregate of corresponding link-wise similarity scores). First/second segment may be sliding.

In DTW, a function of any of: first/second segment, first/second item, another first (or second) item of first (or second) segment, or corresponding timestamp/duration/difference/differential, may satisfy a constraint. Time difference between first/second items may be constrained (e.g. upper/lower bounded). First (or second) section may be entire first (or second) TSCI. First/second duration/starting/ending time may be same/different.

In one example, first/second Type1-Type2 device pairs may be same and first/second TSCI may be same/different. When different, first/second TSCI may comprise a pair of current/reference, current/current or reference/reference TSCI. For “current/reference”, first TSCI may be current TSCI obtained in operating stage and second TSCI may be reference TSCI obtained in training stage. For “reference/reference”, first/second TSCI may be two TSCI obtained during training stage (e.g. for two training events/states/classes). For “current/current”, first/second TSCI may be two TSCI obtained during operating stage (e.g. associated with two different antennas, or two measurement setups). In another example, first/second Type1-Type2 device pairs may be different, but share a common device (Type1 or Type2).

Aligned first/second segments (or portion of each) may be represented as first/second vectors. Portion may comprise all items (for “segment-wise”), or all items associated with a TX-RX link (for “link-wise”), or an item (for “item-wise”), or a component of an item (for “component-wise”). Similarity score may comprise combination/aggregate/function of any of: inner product/correlation/autocorrelation/correlation indicator/covariance/discriminating score/distance/Euclidean/absolute/L_k/weighted distance (between first/second vectors). Similarity score may be normalized by vector length. A parameter derived from similarity score may be modeled with a statistical distribution. A scale/location/another parameter of the statistical distribution may be estimated.

Recall there may be multiple sliding segments. Classifier may be applied to a sliding first/second segment pair to obtain a tentative classification result. It may associate current event with a particular class based on one segment pair/tentative classification result, or multiple segment pairs/tentative classification results (e.g. associate if similarity scores prevail (e.g. being max/min/dominant/matchless/most significant/excel) or significant enough (e.g. higher/lower than some threshold) among all candidate classes for N consecutive times, or for a high/low enough percentage, or most/least often in a time period).

Channel information (CI) may comprise any of: signal strength/amplitude/phase/timestamp, spectral power measurement, modem parameters, dynamic beamforming information, transfer function components, radio state, measurable variables, sensing data/measurement, coarse/fine-grained layer information (e.g. PHY/MAC/datalink layer), digital gain/RF filter/frontend-switch/DC offset/correction/IQ-compensation settings, environment effect on wireless signal propagation, channel input-to-output transformation, stable behavior of environment, state profile, wireless channel measurements/received signal strength indicator (RSSI)/channel state information (CSI)/channel impulse response (CIR)/channel frequency response (CFR)/characteristics of frequency components (e.g. subcarriers)/channel characteristics/channel filter response, auxiliary information, data/meta/user/account/access/security/session/status/supervisory/device/network/household/neighborhood/environment/real- time/sensor/stored/encrypted/compressed/protected data, identity/identifier/identification.

Each CI may be associated with timestamp/arrival time/frequency band/signature/phase/amplitude/trend/characteristics, frequency-like characteristics, time/frequency/time-frequency domain element, orthogonal/non-orthogonal decomposition characteristics of signal through channel. Timestamps of TSCI may be irregular and may be corrected (e.g. by interpolation/resampling) to be regular, at least for a sliding time window.

TSCI may be/comprise a link-wise TSCI associated with an antenna of Type1 device and an antenna of Type2 device. For Type1 device with M antennas and Type2 device with N antennas, there may be MN link-wise TSCI.

CI/TSCI may be preprocessed/processed/postprocessed/stored/retrieved/transmitted/received. Some modem/radio state parameter may be held constant. Modem parameters may be applied to radio subsystem and may represent radio state. Motion detection signal (e.g. baseband signal, packet decoded/demodulated from it) may be obtained by processing (e.g. down-converting) wireless signal (e.g. RF/WiFi/LTE/5G/6G signal) by radio subsystem using radio state represented by stored modem parameters. Modem parameters/radio state may be updated (e.g. using previous modem parameters/radio state). Both previous/updated modem parameters/radio states may be applied in radio subsystem (e.g. to process signal/decode data). In the disclosed system, both may be obtained/compared/analyzed/processed/monitored.

Each CI may comprise N1 CI components (CIC) (e.g. time/frequency domain component, decomposition components), each with corresponding CIC index. Each CIC may comprise a real/imaginary/complex quantity, magnitude/phase/Boolean/flag, and/or some combination/subset. Each CI may comprise a vector/matrix/set/collection of CIC. CIC of TSCI associated with a particular CIC index may form a CIC time series. TSCI may be divided into N1 time series of CIC (TSCIC), each associated with respective CIC index. Characteristics/STI/MI may be monitored based on TSCIC. Some TSCIC may be selected based on some criteria/cost function/signal quality metric (e.g. SNR, interference level) for further processing.

Multi-component characteristics/STI/MI of multiple TSCIC (e.g. two components with indices 6 and 7, or three components indexed at 6, 7, 10) may be computed. In particular, k-component characteristics may be a function of k TSCIC with k corresponding CIC indices. With k=1, it is single-component characteristics which may constitute/form a one-dimensional (1D) function as CIC index spans all possible values. For k=2, two-component characteristics may constitute/form a 2D function. In special case, it may depend only on difference between the two indices. In such case, it may constitute 1D function. A total characteristics may be computed based on one or more multi-component characteristics (e.g. weighted average/aggregate). Characteristics/STI/MI of object/motion/expression may be monitored based on any multi-component characteristics/total characteristics.

Characteristics/STI/MI may comprise: instantaneous/short-/long- term/historical/repetitive/repeated/repeatable/recurring/periodic/pseudoperiodic/regular/habitual/incremental/average/initial/final/current/past/future/predicted/changing/deviational/change/time/frequency/orthogonal/non- orthogonal/transform/decomposition/deterministic/stochastic/probabilistic/dominant/key/prominent/representative/characteristic/significant/insignificant/indicative/common/averaged/shared/typical/prototypical/persistent/abnormal/a brupt/impulsive/sudden/unusual/unrepresentative/atypical/suspicious/dangerous/alarming/evolving/transient/one-time quantity/characteristics/analytics/feature/information, cause-and-effect, correlation indicator/score, auto/cross correlation/covariance, autocorrelation function (ACF), spectrum/spectrogram/power spectral density, time/frequency function/transform/projection, initial/final/temporal/change/trend/pattern/tendency/inclination/behavior/activity/history/profile/event, location/position/localization/spatial coordinate/change on map/path/navigation/tracking, linear/rotational/horizontal/vertical/location/distance/displacement/height/speed/velocity/acceleration/change/angular speed, direction/orientation, size/length/width/height/azimuth/area/volume/capacity, deformation/transformation, object/motion direction/angle/shape/form/shrinking/expanding, behavior/activity/movement, occurrence, fall-down/accident/security/event, period/frequency/rate/cycle/rhythm/count/quantity, timing/duration/interval, starting/initiating/ending/current/past/next time/quantity/information, type/grouping/classification/composition, presence/absence/proximity/approaching/receding/entrance/exit, identity/identifier, head/mouth/eye/breathing/heart/hand/handwriting/arm/body/gesture/leg/gait/organ characteristics, tidal volume/depth of breath/airflow rate/inhale/exhale time/ratio, gait/walking/tool/machine/complex motion, signal/motion characteristic/information/feature/statistics/parameter/magnitude/phase/degree/dynamics/anomaly/variability/detection/estimation/recognition/identification/indication, slope/derivative/higher order derivative of function/feature/mapping/transformation of another characteristics, mismatch/distance/similarity score/cost/metric, Euclidean/statistical/weighted distance, L1/L2/Lk norm, inner/outer product, tag, test quantity, consumed/unconsumed quantity, state/physical/health/well-being/emotional/mental state, output responses, any composition/combination, and/or any related characteristics/information/combination.

Test quantities may be computed. Characteristics/STI/I may be computed/monitored based on CI/TSCI/features/similarity scores/test quantities. Static (or dynamic) segment/profile may be identified/computed/analyzed/monitored/extracted/obtained/marked/presented/indicated/highlighted/stored/communicated by analyzing CUTSCI/features/functions of features/test quantities/characteristics/STI/MI (e.g. target motion/movement presence/detection/estimation/recognition/identification). Test quantities may be based on CUTSCI/features/functions of features/characteristics/STI/MI. Test quantities may be processed/tested/analyzed/compared.

Test quantity may comprise any/any function of: data/vector/matrix/structure, characteristics/STI/MI, CI information (CII, e.g. C/CIC/feature/magnitude/phase), directional information (DI, e.g. directional CII), dominant/representative/characteristic/indicative/key/archetypal/exemplary/paradigmatic/prominent/common/shared/typical/prototypical/averaged/regular/persistent/usual/normal/atypical/unusual/abnormal/unrepresentative data/vector/matrix/structure, similarity/mismatch/distance score/cost/metric, auto/cross correlation/covariance, sum/mean/average/weighted/trimmed/arithmetic/geometric/harmonic mean, variance/deviation/absolute/square deviation/averaged/median/total/standard deviation/derivative/slope/variation/total/absolute/square variation/spread/dispersion/variability, divergence/skewness/kurtosis/range/interquartile range/coefficient of variation/dispersion/L-moment/quartile coefficient of dispersion/mean absolute/square difference/Gini coefficient/relative mean difference/entropy/maximum (max)/minimum (min)/median/percentile/quartile, variance-to-mean ratio, max-to-min ratio, variation/regularity/similarity measure, transient event/behavior, statistics/mode/likelihood/histogram/probability distribution function (pdf)/moment generating function/expected function/value, behavior, repeatedness/periodicity/pseudo-periodicity, impulsiveness/suddenness/occurrence/recurrence, temporal profile/characteristics, time/timing/duration/period/frequency/trend/history, starting/initiating/ending time/quantity/count, motion classification/type, change, temporal/frequency/cycle change, etc.

Identification/identity/identifier/ID may comprise: MAC address/ASID/USID/AID/UID/UUID, label/tag/index, web link/address, numeral/alphanumeric ID, name/password/account/account ID, and/or another ID. ID may be assigned (e.g. by software/firmware/user/hardware, hardwired, via dongle). ID may be stored/retrieved (e.g. in database/memory/cloud/edge/local/hub server, stored locally/remotely/permanently/temporarily). ID may be associated with any of: user/customer/household/information/data/address/phone number/social security number, user/customer number/record/account, timestamp/duration/timing. ID may be made available to Type1/Type2 device/sensing/SBP initiator/responder. ID may be for registration/initialization/communication/identification/verification/detection/recognition/authentication/access control/cloud access/networking/social networking/logging/recording/cataloging/classification/tagging/association/pairing/transaction/electronic transaction/intellectual property control (e.g. by local/cloud/server/hub, Type1/Type2/nearby/user/another device, user).

Object may be person/pet/animal/plant/machine/user, baby/child/adult/older person, expert/specialist/leader/commander/manager/personnel/staff/officer/doctor/nurse/worker/teacher/technician/serviceman/repairman/passenger/patient/customer/student/traveler/inmate/high-value person/, object to be tracked, vehicle/car/AGV/drone/robot/wagon/transport/remote-controlled machinery/cart/moveable objects/goods/items/material/parts/components/machine/lift/elevator, merchandise/goods/cargo/people/items/food/package/luggage/equipment/cleaning tool in/on workflow/assembly-line/warehouse/factory/store/supermarket/distribution/logistic/transport/manufacturing/retail/wholesale/business center/facility/hub, phone/computer/laptop/tablet/dongle/plugin/companion/tool/peripheral/accessory/wearable/furniture/appliance/amenity/gadget, IoT/networked/smart/portable devices, watch/glasses/speaker/toys/stroller/keys/wallet/purse/handbag/backpack, goods/cargo/luggage/equipment/motor/machine/utensil/table/chair/air-conditioner/door/window/heater/fan, light/fixture/stationary object/television/camera/audio/video/surveillance equipment/parts, ticket/parking/toll/airplane ticket, credit/plastic/access card, object with fixed/changing/no form, mass/solid/liquid/gas/fluid/smoke/fire/flame, signage, electromagnetic (EM) source/medium, and/or another object.

Object may have multiple parts, each with different movement (e.g. position/location/direction change). Object may be a person walking forward. While walking, his left/right hands may move in different directions, with different instantaneous motion/speed/acceleration.

Object may/may not be communicatively coupled with some network, such as WiFi, MiFi, 4G/LTE/5G/6G/7G/8G, Bluetooth/NFC/BLE/WiMax/Zigbee/mesh/adhoc network. Object may be bulky machinery with AC power supply that is moved during installation/cleaning/maintenance/renovation. It may be placed on/in moveable platforms such as elevator/conveyor/lift/pad/belt/robot/drone/forklift/car/boat/vehicle. Type1/Type2 device may attach to/move with object. Type1/Type2 device may be part of/embedded in portable/another device (e.g. module/device with module, which may be large/sizeable/small/heavy/bulky/light, e.g. coin-sized/cigarette-box-sized). Type1/Type2/portable/another device may/may not be attached to/move with object, and may have wireless (e.g. via Bluetooth/BLE/Zigbee/NFC/WiFi) or wired (e.g. USB/micro-USB/Firewire/HDMI) connection with a nearby device for network access (e.g. via WiFi/cellular network). Nearby device may be object/phone/AP/IoT/device/appliance/peripheral/amenity/furniture/vehicle/gadget/wearable/networked/computing device. Nearby device may be connected to some server (e.g. cloud server via network/internet). It may/may not be portable/moveable, and may/may not move with object. Type1/Type2/portable/nearby/another device may be powered by battery/solar/DC/AC/other power source, which may be replaceable/non-replaceable, and rechargeable/non-rechargeable. It may be wirelessly charged.

Type1/Type2/portable/nearby/another device may comprise any of: computer/laptop/tablet/pad/phone/printer/monitor/battery/antenna, peripheral/accessory/socket/plug/charger/switch/adapter/dongle, internet-of-thing (IoT), TV/sound bar/HiFi/speaker/set-top box/remote control/panel/gaming device, AP/cable/broadband/router/repeater/extender, appliance/utility/fan/refrigerator/washer/dryer/microwave/oven/stove/range/light/lamp/tube/pipe/tap/lighting/air-conditioner/heater/smoke detector, wearable/watch/glasses/goggle/button/bracelet/chain/jewelry/ring/belt/clothing/garment/fabric/shirt/pant/dress/glove/handwear/shoe/fo otwear/hat/headwear/bag/purse/wallet/makeup/cosmetic/ornament/book/magazine/paper/stationa ry/signage/poster/display/printed matter, furniture/fixture/table/desk/chair/sofa/bed/cabinet/shelf/rack/storage/box/bucket/basket/packaging/carriage/tile/shingle/brick/block/mat/panel/curtain/cus hion/pad/carpet/material/building material/glass, amenity/sensor/clock/pot/pan/ware/container/bottle/can/utensil/plate/cup/bowl/toy/ball/tool/pen/racket/lock/bell/camera/microphone/painting/f rame/mirror/coffee-maker/door/window, food/pill/medicine, embeddable/implantable/gadget/instrument/equipment/device/apparatus/machine/controller/mechanical tool, garage-opener, key/plastic/payment/credit card/ticket, solar panel, key tracker, fire-extinguisher, garbage can/bin, WiFi-enabled device, smart device/machine/machinery/system/house/office/building/warehouse/facility/vehicle/car/bicycle/motorcycle/boat/vessel/airplane/cart/wagon, home/vehicle/office/factory/building/manufacturing/production/computing/security/another device.

One/two/more of Type1/Type2/portable/nearby/another device/server may determine an initial characteristics/STI/MI of object, and/or may share intermediate information. One of Type1/Type2 device may move with object (e.g. “Tracker Bot”). The other one of Type1/Type2 device may not move with object (e.g. “Origin Satellite”, “Origin Register”). Either may have known characteristics/STI/MI. Initial STI/MI may be computed based on known STI/MI.

Venue may be any space such as sensing area, room/house/home/office/workplace/building/facility/warehouse/factory/store/vehicle/property, indoor/outdoor/enclosed/semi-enclosed/open/semi-open/closed/over-air/floating/underground space/area/structure/enclosure, space/area with wood/glass/metal/material/structure/frame/beam/panel/column/wall/floor/door/ceiling/window/cavity/gap/opening/reflection/refraction medium/fluid/construction material/fixed/adjustable layout/shape, human/animal/plant body/cavity/organ/bone/blood/vessel/air-duct/windpipe/teeth/soft/hard/rigid/non-rigid tissue, manufacturing/repair/maintenance/mining/parking/storage/transportation/shipping/logistic/sports/entertainment/amusement/public/recreatio nal/government/community/seniors/elderly care/geriatric/space facility/terminal/hub, distribution center/store, machine/engine/device/assembly line/workflow, urban/rural/suburban/metropolitan area, staircase/escalator/elevator/hallway/walkway/tunnel/cave/cavern/channel/duct/pipe/tube/lift/well/pathway/roof/basement/den/alley/road/path/highway/sewage/ventilation system/network, car/truck/bus/van/container/ship/boat/submersible/train/tram/airplane/mobile home, stadium/city/playground/park/field/track/court/gymnasium/hall/mart/market/supermarket/plaza/square/construction site/hotel/museum/school/hospital/university/garage/mall/airport/train/bus station/terminal/hub/platform, valley/forest/wood/terrain/landscape/garden/park/patio/land, and/or gas/oil/water pipe/line. Venue may comprise inside/outside of building/facility. Building/facility may have one/multiple floors, with a portion underground.

A event may be monitored based on TSCI. Event may be object/motion/gesture/gait related, such as fall-down, rotation/hesitation/pause, impact (e.g. person hitting sandbag/door/bed/window/chair/table/desk/cabinet/box/another person/animal/bird/fly/ball/bowling/tennis/soccer/volley ball/football/baseball/basketball), two-body action (e.g. person releasing balloon/catching fish/molding clay/writing paper/typing on computer), car moving in garage, person carrying smart phone/walking around venue, autonomous/moveable object/machine moving around (e.g. vacuum cleaner/utility/self-driving vehicle/car/drone).

Task may comprise: (a) sensing task, any of: monitoring/sensing/detection/recognition/estimation/verification/identification/authentication/classification/locationing/guidance/navigation/tracking/counting of/in any of: object/objects/vehicle/machine/tool/human/baby/elderly/patient/intruder/pet presence/proximity/activity/daily-activity/well-being/breathing/vital sign/heartbeat/health condition/sleep/sleep stage/walking/location/distance/speed/acceleration/navigation/tracking/exercise/safety/danger/fall-down/intrusion/security/life- threat/emotion/movement/motion/degree/pattern/periodic/repeated/cyclo-stationary/stationary/regular/transient/sudden/suspicious motion/irregularity/trend/change/breathing/human biometrics/environment informatics/gait/gesture/room/region/zone/venue, (b) computation task, any of: signal processing/preprocess/postprocessing/conditioning/denoising/calibration/analysis/feature extraction/transformation/mapping/supervised/unsupervised/semi-supervised/discriminative/machine/deep learning/training/clustering/training/PCA/eigen-decomposition/frequency/time/functional decomposition/neural network/map-based/model-based processing/correction/geometry estimation/analytics computation, (c) IoT task, any of: smart task for venue/user/object/human/pet/house/home/office/workplace/building/facility/warehouse/factory/store/vehicle/property/structure/assembly-line/IoT/device/system, energy/power management/transfer, wireless power transfer, interacting/engage with user/object/intruder/human/animal (e.g. presence/motion/gesture/gait/activity/behavior/voice/command/instruction/query/music/sound/i mage/video/location/movement/danger/threat detection/recognition/monitoring/analysis/response/execution/synthesis, generate/retrieve/play/display/render/synthesize dialog/exchange/response/presentation/experience/media/multimedia/expression/sound/speech/music/image/imaging/video/animation/webpage/text/message/notification/reminder/enquiry/warning, detect/recognize/monitor/interpret/analyze/record/store user/intruder/object input/motion/gesture/location/activity), activating/controlling/configuring (e.g. turn on/off/control/lock/unlock/open/close/adjust/configure) a device/system (e.g. vehicle/drone/electrical/mechanical/air-conditioning/heating/lighting/ventilation/clearning/entertainment/IoT/security/siren/access system/device/door/window/garage/lift/elevator/escalator/speaker/television/light/peripheral/accessory/wearable/furniture/appliance/amenity/gadget/alarm/camera/gaming/coffee/cooking/he ater/fan/housekeeping/home/office machine/device/robot/vacuum cleaner/assembly line), (d) miscellaneous task, any of: transmission/coding/encryption/storage/analysis of data/parameters/analytics/derived data, upgrading/administration/configuration/coordination/broadcasting/synchronization/networking/encryption/communication/protection/compression/storage/database/archiving/query/cloud computing/presentation/augmented/virtual reality/other processing/task. Task may be performed by some of: Type1/Type2/nearby/portable/another device, and/or hub/local/edge/cloud server.

Task may also comprise: detect/recognize/monitor/locate/interpret/analyze/record/store user/visitor/intruder/object/pet, interact/engage/converse/dialog/exchange with user/object/visitor/intruder/human/baby/pet, detect/locate/localize/recognize/monitor/analyze/interpret/learn/train/respond/execute/synthesize/generate/record/store/summarize health/well-being/daily-life/activity/behavior/pattern/exercise/food-intake/restroom visit/work/play/rest/sleep/relaxation/danger/routine/timing/habit/trend/normality/normalcy/anomaly/regularity/irregularity/change/presence/motion/gesture/gait/expression/emotion/state/stage/voice/command/instruction/question/quer y/music/sound/location/movement/fall-down/threat/discomfort/sickness/environment/, generate/retrieve/play/display/render/synthesize dialog/exchange/response/presentation/report/experience/media/multimedia/expression/sound/speech/music/image/imaging/video/animation/w ebpage/text/message/notification/reminder/enquiry/warning, detect/recognize/monitor/interpret/analyze/record/store user/intruder/object input/motion/gesture/location/activity), detect/check/monitor/locate/manage/control/adjust/configure/lock/unlock/arm/disarm/open/close/fully/partiall y/activate/turn on/off some system/device/object (e.g. vehicle/robot/drone/electrical/mechanical/air-conditioning/heating/ventilation/HVAC/lighting/cleaning/entertainment/IoT/security/siren/access systems/devices/items/components, door/window/garage/lift/elevator/escalator/speaker/television/light/peripheral/accessory/wearable/furniture/appliance/amenity/gadget/alarm/camera/gaming/coffee/cooking/heater/fan/housekeeping/home/office machine/device/vacuum cleaner/assembly line/window/garage/door/blind/curtain/panel/solar panel/sun shade), detect/monitor/locate user/pet do something (e.g. sitting/sleeping on sofa/in bedroom/running on treadmill/cooking/watching TV/eating in kitchen/dining room/going upstairs/downstairs/outside/inside/using rest room), do something (e.g. generate message/response/warning/clarification/notification/report) automatically upon detection, do something for user automatically upon detecting user presence, turn on/off/wake/control/adjust/dim light/music/radio/TV/HiFi/STB/computer/speaker/smart device/air-conditioning/ventilation/heating system/curtains/light shades, turn on/off/pre-heat/control coffee-machine/hot-water-pot/cooker/oven/microwave oven/another cooking device, check/manage temperature/setting/weather forecast/telephone/message/mail/system check, present/interact/engage/dialog/converse (e.g. through smart speaker/display/screen; via webpage/email/messaging system/notification system).

When user arrives home by car, task may be to, automatically, detect user/car approaching, open garage/door upon detection, turn on driveway/garage light as user approaches garage, and/or turn on air conditioner/heater/fan. As user enters house, task may be to, automatically, turn on entrance light/off driveway/garage light, play greeting message to welcome user, turn on user's favorite music/radio/news/channel, open curtain/blind, monitor user's mood, adjust lighting/sound environment according to mood/current/imminent event (e.g. do romantic lighting/music because user is scheduled to eat dinner with girlfriend soon) on user's calendar, warm food in microwave that user prepared in morning, do diagnostic check of all systems in house, check weather forecast for tomorrow/news of interest to user, check calendar/to-do list, play reminder, check telephone answering/messaging system/email, give verbal report using dialog system/speech synthesis, and/or remind (e.g. using audible tool such as speakers/HiFi/speech synthesis/sound/field/voice/music/song/dialog system, using visual tool such as TV/entertainment system/computer/notebook/tablet/display/light/color/brightness/patterns symbols, using haptic/virtual reality/gesture/tool, using smart device/appliance/material/furniture/fixture, using server/hub device/cloud/fog/edge server/home/mesh network, using messaging/notification/communication/scheduling/email tool, using UI/GUI, using scent/smell/fragrance/taste, using neural/nervous system/tool, or any combination) user of someone's birthday/call him, prepare/give report. Task may turn on air conditioner/heater/ventilation system in advance, and/or adjust temperature setting of smart thermostat in advance. As user moves from entrance to living room, task may be to turn on living room light, open living room curtain, open window, turn off entrance light behind user, turn on TV/set-top box, set TV to user's favorite channel, and/or adjust an appliance according to user's preference/conditions/states (e.g. adjust lighting, choose/play music to build romantic atmosphere).

When user wakes up in morning, task may be to detect user moving around in bedroom, open blind/curtain/window, turn off alarm clock, adjust temperature from night-time to day-time profile, turn on bedroom light, turn on restroom light as user approaches restroom, check radio/streaming channel and play morning news, turn on coffee machine, preheat water, and/or turn off security system. When user walks from bedroom to kitchen, task may be to turn on kitchen/hallway lights, turn off bedroom/restroom lights, move music/message/reminder from bedroom to kitchen, turn on kitchen TV, change TV to morning news channel, lower kitchen blind, open kitchen window, unlock backdoor for user to check backyard, and/or adjust temperature setting for kitchen.

When user leaves home for work, task may be to detect user leaving, play farewell/have-a-good-day message, open/close garage door, turn on/off garage/driveway light, close/lock all windows/doors (if user forgets), turn off appliance (e.g. stove/microwave/oven), turn on/arm security system, adjust light/air-conditioning/heating/ventilation systems to “away” profile to save energy, and/or send alerts/reports/updates to user's smart phone.

Motion may comprise any of: no-motion, motion sequence, resting/non-moving motion, movement/change in position/location, daily/weekly/monthly/yearly/repeating/activity/behavior/action/routine, transient/time-varying/fall-down/repeating/repetitive/periodic/pseudo-periodic motion/breathing/heartbeat, deterministic/non-deterministic/probabilistic/chaotic/random motion, complex/combination motion, non-/pseudo-/cyclo-/stationary random motion, change in electro-magnetic characteristics, human/animal/plant/body/machine/mechanical/vehicle/drone motion, air-/wind-/weather-/water-/fluid-/ground/sub-surface/seismic motion, man-machine interaction, normal/abnormal/dangerous/warning/suspicious motion, imminent/rain/fire/flood/tsunami/explosion/collision, head/facial/eye/mouth/tongue/neck/finger/hand/arm/shoulder/upper/lower/body/chest/abdominal/hip/leg/foot/joint/knee/elbow/skin/below-skin/subcutaneous tissue/blood vessel/intravenous/organ/heart/lung/stomach/intestine/bowel/eating/breathing/talking/singing/dancing/coordinated motion, facial/eye/mouth expression, and/or hand/arm/gesture/gait/UI/keystroke/typing stroke.

Type1/Type2 device may comprise heterogeneous IC, low-noise amplifier (LNA), power amplifier, transmit-receive switch, media access controller, baseband radio, and/or 2.4/3.65/4.9/5/6/sub-7/over-7/28/60/76 GHz/another radio. Heterogeneous IC may comprise processor/memory/software/firmware/instructions. It may support broadband/wireless/mobile/mesh/cellular network, WLAN/WAN/MAN, standard/IEEE/3GPP/WiFi/4G/LTE/5G/6G/7G/8G, IEEE 802.11/a/b/g/n/ac/ad/af/ah/ax/ay/az/be/bf/15/16, and/or Bluetooth/BLE/NFC/Zigbee/WiMax.

Processor may comprise any of: general-/special-/purpose/embedded/multi-core processor, microprocessor/microcontroller, multi-/parallel/CISC/RISC processor, CPU/GPU/DSP/ASIC/FPGA, and/or logic circuit. Memory may comprise non-/volatile, RAM/ROM/EPROM/EEPROM, hard disk/SSD, flash memory, CD-/DVD-ROM, magnetic/optical/organic/storage system/network, network/cloud/edge/local/external/internal storage, and/or any non-transitory storage medium. Set of instructions may comprise machine executable codes in hardware/IC/software/firmware, and may be embedded/pre-loaded/loaded upon-boot-up/on-the-fly/on-demand/pre-installed/installed/downloaded.

Processing/preprocessing/postprocessing may be applied to data (e.g. TSCI/feature/characteristics/STI/MI/test quantity/intermediate/data/analytics) and may have multiple steps. Step/pre-/post-/processing may comprise any of: computing function of operands/LOS/non-LOS/single-link/multi-link/component/item/quantity, magnitude/norm/phase/feature/energy/timebase/similarity/distance/characterization score/measure computation/extraction/correction/cleaning, linear/nonlinear/FIR/IIR/MA/AR/ARMA/Kalman/particle filtering, lowpass/bandpass/highpass/median/rank/quartile/percentile/mode/selective/adaptive filtering, interpolation/intrapolation/extrapolation/decimation/subsampling/upsampling/resampling, matched filtering/enhancement/restoration/denoising/smoothing/conditioning/spectral analysis/mean subtraction/removal, linear/nonlinear/inverse/frequency/time transform, Fourier transform (FT)/DTFT/DFT/FFT/wavelet/Laplace/Hilbert/Hadamard/trigonometric/sine/cosine/DCT/power-of-2/sparse/fast/frequency transform, zero/cyclic/padding, graph-based transform/processing, decomposition/orthogonal/non-orthogonal/over-complete projection/eigen-decomposition/SVD/PCA/ICA/compressive sensing, grouping/folding/sorting/comparison/soft/hard/thresholding/clipping, first/second/high order derivative/integration/convolution/multiplication/division/addition/subtraction, local/global/maximization/minimization, recursive/iterative/constrained/batch processing, least mean square/absolute error/deviation, cost function optimization, neural network/detection/recognition/classification/identification/estimation/labeling/association/tagging/mapping/remapping/training/clustering/machine/supervised/unsupervised/semi- supervised learning/network, vector/quantization/encryption/compression/matching pursuit/scrambling/coding/storing/retrieving/transmitting/receiving/time-domain/frequency- domain/normalization/scaling/expansion/representing/merging/combining/splitting/tracking/monitoring/shape/silhouette/motion/activity/analysis, pdf/histogram estimation/importance/Monte Carlo sampling, error detection/protection/correction, doing nothing, time-varying/adaptive processing, conditioning/weighted/averaging/over selected components/links, arithmetic/geometric/harmonic/trimmed mean/centroid/medoid computation, morphological/logical operation/permutation/combination/sorting/AND/OR/XOR/union/intersection, vector operation/addition/subtraction/multiplication/division, and/or another operation. Processing may be applied individually/jointly. Acceleration using GPU/DSP/coprocessor/multicore/multiprocessing may be applied.

Function may comprise: characteristics/feature/magnitude/phase/energy, scalar/vector/discrete/continuous/polynomial/exponential/logarithmic/trigonometric/transcendent al/logical/piecewise/linear/algebraic/nonlinear/circular/piecewise linear/real/complex/vector-valued/inverse/absolute/indicator/limiting/floor/rounding/sign/composite/sliding/moving function, derivative/integration, function of function, one-to-one/one-to-many/many-to-one/many-to-many function, mean/mode/median/percentile/max/min/range/statistics/histogram, local/global max/min/zero-crossing, variance/variation/spread/dispersion/deviation/standard deviation/divergence/range/interquartile range/total variation/absolute/total deviation, arithmetic/geometric/harmonic/trimmed mean/square/cube/root/power, thresholding/clipping/rounding/truncation/quantization/approximation, time function processed with an operation (e.g. filtering), sine/cosine/tangent/cotangent/secant/cosecant/elliptical/parabolic/hyperbolic/game/zeta function, probabilistic/stochastic/random/ergodic/stationary/deterministic/periodic/repeated function, inverse/transformation/frequency/discrete time/Laplace/Hilbert/sine/cosine/triangular/wavelet/integer/power-of-2/sparse transform, orthogonal/non-orthogonal/eigen projection/decomposition/eigenvalue/singular value/PCA/ICA/SVD/compressive sensing, neural network, feature extraction, function of moving window of neighboring items of time series, filtering function/convolution, short-time/discrete transform/Fourier/cosine/sine/Hadamard/wavelet/sparse transform, matching pursuit, approximation, graph-based processing/transform/graph signal processing, classification/identification/class/group/category/labeling, processing/preprocessing/postprocessing, machine/learning/detection/estimation/feature extraction/learning network/feature extraction/denoising/signal enhancement/coding/encryption/mapping/vector quantization/remapping/lowpass/highpass/bandpass/matched/Kalman/particle/FIR/IIR/MA/AR/ARMA/median/mode/adaptive filtering, first/second/high order derivative/integration/zero crossing/smoothing, up/down/random/importance/Monte Carlo sampling/resampling/converting, interpolation/extrapolation, short/long term statistics/auto/cross correlation/moment generating function/time averaging/weighted averaging, special/Bessel/Beta/Gamma/Gaussian/Poisson/integral complementary error function.

Sliding time window may have time-varying width/size. It may be small/large at beginning to enable fast/accurate acquisition and increase/decrease over time to steady-state size comparable to motion frequency/period/transient motion duration/characteristics/STI/MI to be monitored. Window size/time shift between adjacent windows may be constant/adaptively/dynamically/automatically changed/adjusted/varied/modified (e.g. based on battery life/power consumption/available computing power/change in amount of targets/nature of motion to be monitored/user request/choice/instruction/command).

Characteristics/STI/MI may be determined based on characteristic value/point of function and/or associated argument of function (e.g. time/frequency). Function may be outcome of a regression. Characteristic value/point may comprise local/global/constrained/significant/first/second/i\hat{ }maximum/minimum/extremum/zero-crossing (e.g. with positive/negative time/frequency/argument) of function. Local signal-to-noise-ratio (SNR) or SNR-like parameter may be computed for each pair of adjacent local max (peak)/local min (valley) of function, which may be some function (e.g. linear/log/exponential/monotonic/power/polynomial) of fraction or difference of a quantity (e.g. power/magnitude) of local max over the quantity of local min. Local max (or min) may be significant if its SNR is greater than threshold and/or if its amplitude is greater (or smaller) than another threshold. Local max/min may be selected/identified/computed using persistence-based approach. Some significant local max/min may be selected based on selection criterion (e.g. quality criterion/condition, strongest/consistent significant peak in a range). Unselected significant peaks may be stored/monitored as “reserved” peaks for use in future selection in future sliding time windows. E.g. a particular peak (e.g. at particular argument/time/frequency) may appear consistently over time. Initially, it may be significant but not selected (as other peaks may be stronger). Later, it may become stronger/dominant consistently. When selected, it may be back-traced in time and selected in earlier time to replace previously selected peaks (momentarily strong/dominant but not persistent/consistent). Consistency of peak may be measured by trace, or duration of being significant. Alternatively, local max/min may be selected based on finite state machine (FSM). Decision thresholds may be time-varying, adjusted adaptively/dynamically (e.g. based on back-tracing timing/FSM, or data distribution/statistics).

A similarity score (SS)/component SS may be computed based on two temporally adjacent C/CIC, of one TSCI or of two different TSCI. The pair may come from same/different sliding window (s). SS or component SS may comprise: time reversal resonating strength (TRRS), auto/cross correlation/covariance, inner product of two vectors, L1/L2/Lk/Euclidean/statistical/weighted/distance score/norm/metric/quality metric, signal quality condition, statistical characteristics, discrimination score, neural network/deep learning network/machine learning/training/discrimination/weighted averaging/preprocessing/denoising/signal conditioning/filtering/time correction/timing compensation/phase offset compensation/transformation/component-wise operation/feature extraction/FSM, and/or another score.

Any threshold may be fixed (e.g. 0, 0.5, 1, 1.5, 2), pre-determined and/or adaptively/dynamically determined (e.g. by FSM, or based on time/space/location/antenna/path/link/state/battery life/remaining battery life/available resource/power/computation power/network bandwidth). Threshold may be applied to test quantity to differentiate two events/conditions/situations/states, A and B. Data (e.g. CI/TSCI/feature/similarity score/test quantity/characteristics/STI/MI) may be collected under A/B in training situation. Test quantity (e.g. its distribution) computed based on data may be compared under A/B to choose threshold based on some criteria (e.g. maximum likelihood (ML), maximum aposterior probability (MAP), discriminative training, minimum Type 1 (or 2) error for given Type 2 (or 1) error, quality criterion, signal quality condition). Threshold may be adjusted (e.g. to achieve different sensitivity), automatically/semi-automatically/manually/adaptively/dynamically, once/sometimes/often/periodically/repeatedly/occasionally/sporadically/on-demand (e.g. based on object/movement/location direction/action/characteristics/STI/MI/size/property/trait/habit/behavior/venue/feature/fixture/furniture/barrier/material/machine/living thing/thing/boundary/surface/medium/map/constraint/model/event/state/situation/condition/time/timing/duration/state/history/user/preference). An iterative algorithm may stop after N iterations, after time-out period, or after test quantity satisfies a condition (e.g. updated quantity greater than threshold) which may be fixed/adaptively/dynamically adjusted.

Searching for local extremum may comprise constrained/minimization/maximization, statistical/dual/constraint/convex/global/local/combinatorial/infinite-dimensional/multi-objective/multi-modal/non-differentiable/particle-swarm/simulation-based optimization, linear/nonlinear/quadratic/higher-order regression, linear/nonlinear/stochastic/constraint/dynamic/mathematical/disjunctive/convex/semidefinite/conic/cone/interior/fractional/i nteger/sequential/quadratic programming, conjugate/gradient/subgradient/coordinate/reduced descent, Newton's/simplex/iterative/point/ellipsoid/quasi-Newton/interpolation/memetic/genetic/evolutionary/pattern-/gravitational-search method/algorithm, constraint satisfaction, calculus of variations, optimal control, space mapping, heuristics/metaheuristics, numerical analysis, simultaneous perturbation stochastic approximation, stochastic tunneling, dynamic relaxation, hill climbing, simulated annealing, differential evolution, robust/line/Tabu/reactive search/optimization, curve fitting, least square, variational calculus, and/or variant. It may be associated with an objective/loss/cost/utility/fitness/energy function.

Regression may be performed using regression function to fit data, or function (e.g. ACF/transform/mapped) of data, in regression window. During iterations, length/location of regression window may be changed. Regression function may be linear/quadratic/cubic/polynomial/another function. Regression may minimize any of: mean/weighted/absolute/square deviation, error, aggregate/component/weighted/mean/sum/absolute/square/high-order/another error/cost (e.g. in projection domain/selected axes/orthogonal axes), robust error (e.g. first error (e.g. square) for smaller error magnitude, second error (e.g. absolute) for larger error magnitude), and/or weighted sum/mean of multiple errors (e.g. absolute/square error). Error associated with different links/path may have different weights (e.g. link with less noise may have higher weight). Regression parameter (e.g. time-offset associated with max/min regression error of regression function in regression window, location/width of window) may be initialized and/or updated during iterations (e.g. based on target value/range/profile, characteristics/STI/MI/test quantity, object motion/quantity/count/location/state, past/current trend, location/amount/distribution of local extremum in previous windows, carrier/subcarrier frequency/bandwidth of signal, amount of antennas associated with the channel, noise characteristics, histogram/distribution/central/F-distribution, and/or threshold). When converged, current time offset may be at center/left/right (or fixed relative location) of regression window.

In presentation, information may be displayed/presented (e.g. with venue map/environmental model). Information may comprise: current/past/corrected/approximate/map/location/speed/acceleration/zone/region/area/segmentation/coverage-area, direction/path/trace/history/traffic/summary, frequently-visited areas, customer/crowd event/distribution/behavior, crowd-control information, acceleration/speed/vital-sign/breathing/heart-rate/activity/emotion/sleep/state/rest information, motion-statistics/MI/STI, presence/absence of motion/people/pets/object/vital sign, gesture (e.g. hand/arm/foot/leg/body/head/face/mouth/eye)/meaning/control (control of devices using gesture), location-based gesture-control/motion-interpretation, identity/identifier (ID) (e.g. of object/person/user/pet/zone/region, device/machine/vehicle/drone/car/boat/bicycle/TV/air-con/fan/, self-guided machine/device/vehicle), environment/weather information, gesture/gesture control/motion trace, earthquake/explosion/storm/rain/fire/temperature, collision/impact/vibration, event/door/window/open/close/fall-down/accident/burning/freezing/water-/wind-/air-movement event, repeated/pseudo-periodic event (e.g. running on treadmill, jumping up/down, skipping rope, somersault), and/or vehicle event. Location may be one/two/three dimensional (e.g. expressed/represented as 1D/2D/3D rectangular/polar coordinates), relative (e.g. w.r.t. map/environmental model) or relational (e.g. at/near/distance-from a point, halfway between two points, around corner, upstairs, on table top, at ceiling, on floor, on sofa).

Information (e.g. location) may be marked/displayed with some symbol. Symbol may be time-varying/flashing/pulsating with changing color/intensity/size/orientation. Symbol may be a number reflecting instantaneous quantity (e.g. analytics/gesture/state/status/action/motion/breathing/heart rate, temperature/network traffic/connectivity/remaining power). Symbol/size/orientation/color/intensity/rate/characteristics of change may reflect respective motion. Information may be in text or presented visually/verbally (e.g. using pre-recorded voice/voice synthesis)/mechanically (e.g. animated gadget, movement of movable part).

User device may comprise smart phone/tablet/speaker/camera/display/TV/gadget/vehicle/appliance/device/IoT, device with UI/GUI/voice/audio/record/capture/sensor/playback/display/animation/VR/AR (augmented reality)/voice (assistance/recognition/synthesis) capability, and/or tablet/laptop/PC.

Map/floor plan/environmental model (e.g. of home/office/building/store/warehouse/facility) may be 2-/3-/higher-dimensional. It may change/evolve over time (e.g. rotate/zoom/move/jump on screen). Walls/windows/doors/entrances/exits/forbidden areas may be marked. It may comprise multiple layers (overlays). It may comprise maintenance map/model comprising water pipes/gas pipes/wiring/cabling/air ducts/crawl-space/ceiling/underground layout.

Venue may be segmented/subdivided/zoned/grouped into multiple zones/regions/sectors/sections/territories/districts/precincts/localities/neighborhoods/areas/stretches/expance such as bedroom/living/dining/rest/storage/utility/warehouse/conference/work/walkway/kitchen/foyer/garage/first/second floor/offices/reception room/area/regions. Segments/regions/areas may be presented in map/floor plan/model with presentation characteristic (e.g. brightness/intensity/luminance/color/chrominance/texture/animation/flashing/rate).

An example of disclosed system/apparatus/method. Stephen and family want to install disclosed wireless motion detection system to detect motion in their 2000 sqft two-storey town house in Seattle, Wash. Because his house has two storeys, Stephen decides to use one Type2 device (named A) and two Type1 devices (named B and C) in ground floor. His ground floor has three rooms: kitchen, dining and living rooms arranged in straight line, with dining room in middle. He put A in dining room, and B in kitchen and C in living room, partitioning ground floor into 3 zones (dining room, living room, kitchen). When motion is detected by AB pair and/or AC pair, system would analyze TSCI/feature/characteristics/STI/MI and associate motion with one of 3 zones.

When Stephen and family go camping in holiday, he uses mobile phone app (e.g. Android phone app or iPhone app) to turn on motion detection system. If system detects motion, warning signal is sent to Stephen (e.g. SMS, email, push message to mobile phone app). If Stephen pays monthly fee (e.g. $10/month), a service company (e.g. security company) will receive warning signal through wired (e.g. broadband)/wireless (e.g. WiFi/LTE/5G) network and perform security procedure (e.g. call Stephen to verify any problem, send someone to check on house, contact police on behalf of Stephen).

Stephen loves his aging mother and cares about her well-being when she is alone in house. When mother is alone in house while rest of family is out (e.g. work/shopping/vacation), Stephen turns on motion detection system using his mobile app to ensure mother is ok. He uses mobile app to monitor mother's movement in house. When Stephen uses mobile app to see that mother is moving around house among the three regions, according to her daily routine, Stephen knows that mother is ok. Stephen is thankful that motion detection system can help him monitor mother's well-being while he is away from house.

On typical day, mother would wake up at 7 am, cook her breakfast in kitchen for 20 minutes, eat breakfast in dining room for 30 minutes. Then she would do her daily exercise in living room, before sitting down on sofa in living room to watch favorite TV show. Motion detection system enables Stephen to see timing of movement in 3 regions of house. When motion agrees with daily routine, Stephen knows roughly that mother should be doing fine. But when motion pattern appears abnormal (e.g. no motion until 10 am, or in kitchen/motionless for too long), Stephen suspects something is wrong and would call mother to check on her. Stephen may even get someone (e.g. family member/neighbor/paid personnel/friend/social worker/service provider) to check on mother.

One day Stephen feels like repositioning a device. He simply unplugs it from original AC power plug and plugs it into another AC power plug. He is happy that motion detection system is plug-and-play and the repositioning does not affect operation of system. Upon powering up, it works right away.

Sometime later, Stephen decides to install a similar setup (i.e. one Type2 and two Type1 devices) in second floor to monitor bedrooms in second floor. Once again, he finds that system set up is extremely easy as he simply needs to plug Type2 device and Type1 devices into AC power plug in second floor. No special installation is needed. He can use same mobile app to monitor motion in both ground/second floors. Each Type2 device in ground/second floors can interact with all Type1 devices in both ground/second floors. Stephen has more than double capability with combined systems.

Disclosed system can be applied in many applications. Type1/Type2 devices may be any WiFi-enabled devices (e.g. smart IoT/appliance/TV/STB/speaker/refrigerator/stove/oven/microwave/fan/heater/air-con/router/phone/computer/tablet/accessory/plug/pipe/lamp/smoke detector/furniture/fixture/shelf/cabinet/door/window/lock/sofa/table/chair/piano/utensil/wearable/watch/tag/key/ticket/belt/wallet/pen/hat/necklace/implantable/phone/eyeglasses/glass panel/gaming device) at home/office/facility, on table, at ceiling, on floor, or at wall. They may be placed in conference room to count people. They may form a well-being monitoring system to monitor daily activities of older adults and detect any sign of symptoms (e.g. dementia, Alzheimer's disease). They may be used in baby monitors to monitor vital signs (breathing) of babies. They may be placed in bedrooms to monitor sleep quality and detect any sleep apnea. They may be placed in cars to monitor well-being of passengers and drivers, detect sleepy drivers or babies left in hot cars. They may be used in logistics to prevent human trafficking by monitoring any human hidden in trucks/containers. They may be deployed by emergency service at disaster area to search for trapped victims in debris. They may be deployed in security systems to detect intruders.

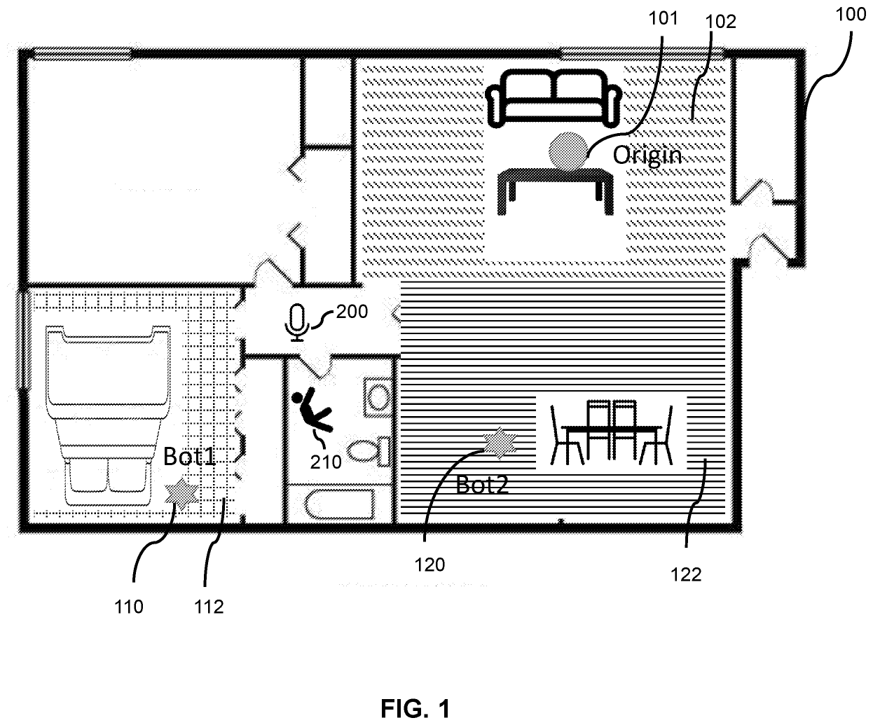

FIG. 1 illustrates an exemplary scenario where a motion/event/activity (e.g. fall/abrupt/impulsive/transient/impactful motion, motion that generates sound/vibration/pressure change, or target motion) is detected (or monitored) based on wireless signal or auxiliary signal or both in a venue, according to one embodiment of the present teaching. For example, as shown in FIG. 1, in a 2-bedroom apartment 100, Origin 101 (Type2 device) may be placed in the living-room area 102, Bot 1 110 (e.g. Type1 device) may be placed in a bedroom1-area 112, and Bot 2 120 (e.g. Type1 device) may be placed in the dining-room area 122. A sensor 200 (e.g. microphone/camera/light sensor/pressure sensor) may also be placed somewhere in the apartment 100 to capture auxiliary sensing signals (e.g. sound/image/video/light/pressure/vibration). During the motion/event/activity (e.g. a person 210 falls down making sound that is picked up by microphone sensor 200), each of Bot 1 110 and Bot 2 120 can transmit a wireless (sounding/probe) signal to the Origin 101, which can obtain channel information of a wireless multipath channel based on the wireless signal. A motion information (MI) or radio-based MI (RMI) can be computed based on the channel information. During the motion/event/activity, the sensor 200 can capture an associated auxiliary signal. An aux-based motion information (AMI) can be computed based on the auxiliary signal. The motion/event/activity can be detected/monitored individually based on the RMI alone (radio-based), individually based on the AMI alone (aux-based), or jointly based on both the RMI and AMI (radio-aux-based, e.g. sequentially radio-based followed by aux-based, or sequentially aux-based followed by radio-based, or simultaneously/contemporaneously by both radio-based and aux-based).

If object motion/activity is detected based on wireless signals transmitted by both Bot 1 110 and Bot 2 120, localization may be performed such that a location of the activity/motion/event or the object (e.g. person/user) may be determined the living-room area 102. If detection is based only on wireless signals transmitted by Bot 1 110, the location may be determined to be in the bedroom-1 area 112. If detection is based only on wireless signals transmitted by Bot 2 120, the location may be determined in the dining-room area 122. If target motion/event/activity cannot be detected based on wireless signals transmitted by either Bot 1 110 or Bot 2 120, then it may be determined that nobody and no object is in the apartment 100. The corresponding area where the activity/motion/event/person/user is detected may be marked with a predetermined pattern.

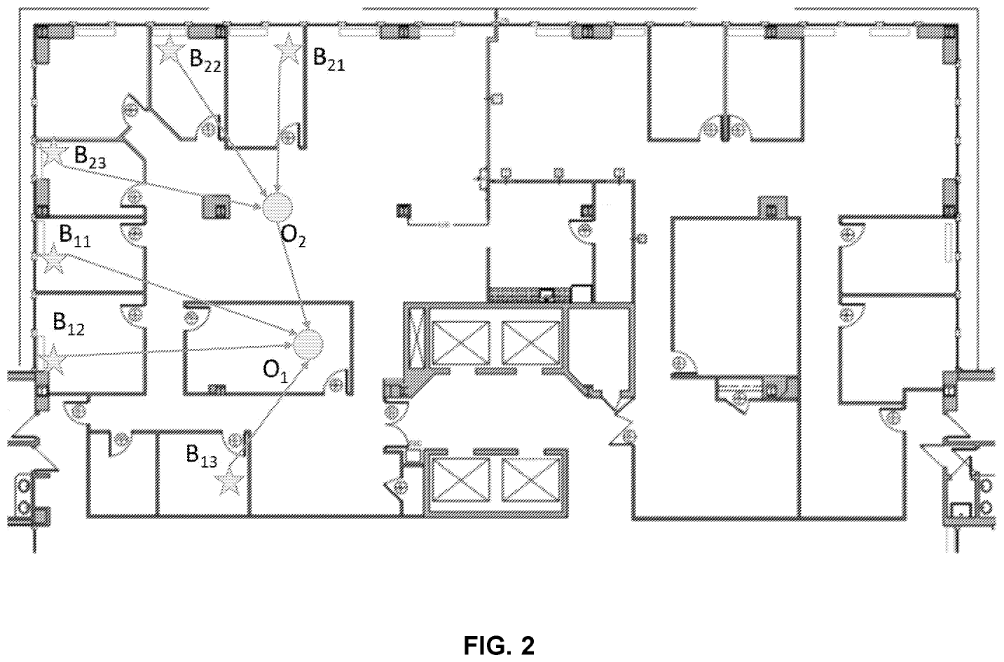

FIG. 2 illustrates an exemplary floor plan and placement of wireless devices for wireless monitoring with motion/event/activity detection and localization, according to some embodiments of the present disclosure. In the example shown in FIG. 2, there are two origins O1 and O2. Each origin is associated with three bots. For example, O1 is associated with bots B11, B12, and B13 (together constitute a first origin group); and O2 is associated with bots B21, B22, and B23 (together constitute a second origin group). Each device of the bots and origins is fixed at a different location. In one embodiment, the origin O1 is called a master origin; and the origin O2 is called a child origin, where the child origin can transmit statistics and information to the master origin for combination.

In some embodiments, the floor plan and placement of wireless devices in FIG. 2 can be used to perform multi-person or multi-object motion localization based on motion statistics. When there are two or more origins, motion statistics (or RMI) measured from different links of different origins are combined to contribute together to the motion localization. For each activated bot, it is determined which origin the bot is associated with, e.g. based on a smoothed motion statistics in a time window. For example, when the smoothed motion statistics of Bot k with respect to Origin j is larger than a threshold, Bot k is determined to be associated with Origin j. The same threshold can be used for other origins. Thus, for each origin, a set of activated bots associated with the origin can be determined. A likelihood is calculated for each activated bot k to detect a motion, and is smoothed over a time window. For each origin group including an origin and its associated bots (e.g. O1, B11, B12, B13), an average motion statistics is computed for the origin group across all the associated bots. Each calculation or computation above can be performed at the origin or the bot.

When there is any motion detected in the environment, an origin group with the highest average motion statistics is chosen. When the average motion statistics of the chosen origin group is larger than a threshold, the motion is determined to be around the origin of the group. Otherwise, when the average motion statistics of the chosen origin group is not larger than a threshold, the motion is determined to be around the bot with the highest likelihood within the origin group.

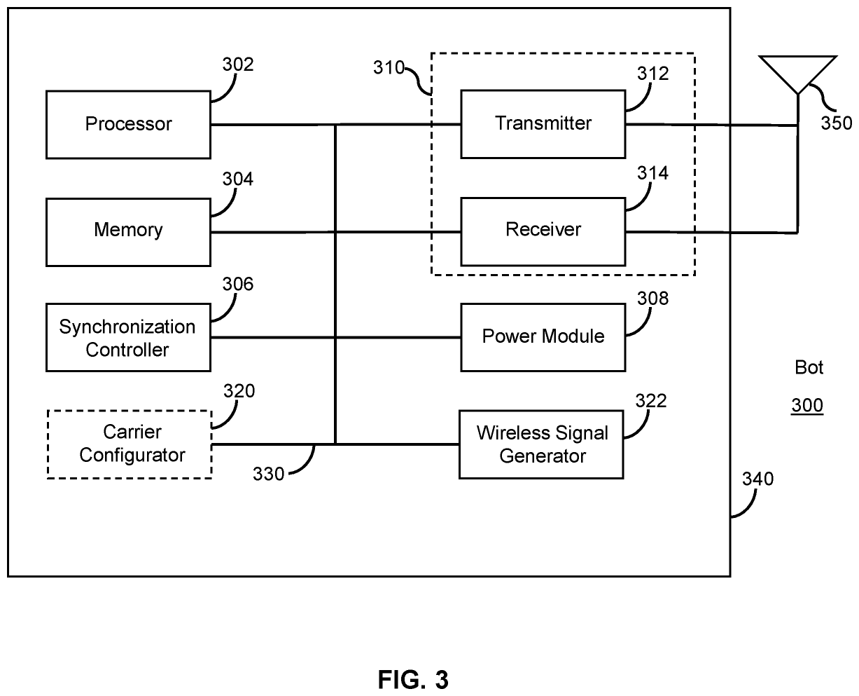

FIG. 3 illustrates an exemplary block diagram of a first wireless device, e.g. a Bot 300, of a wireless sensing system, according to one embodiment of the present teaching. The Bot 300 is an example of a device that can be configured to implement the various methods described herein. As shown in FIG. 3, the Bot 300 includes a housing 340 containing a processor 302, a memory 304, a transceiver 310 comprising a transmitter 312 and receiver 314, a synchronization controller 306, a power module 308, an optional carrier configurator 320 and a wireless signal generator 322.

In this embodiment, the processor 302 controls the general operation of the Bot 300 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 304, which can include both read-only memory (ROM) and random access memory (RAM), can provide instructions and data to the processor 302. A portion of the memory 304 can also include non-volatile random access memory (NVRAM). The processor 302 typically performs logical and arithmetic operations based on program instructions stored within the memory 304. The instructions (a.k.a., software) stored in the memory 304 can be executed by the processor 302 to perform the methods described herein. The processor 302 and the memory 304 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 310, which includes the transmitter 312 and receiver 314, allows the Bot 300 to transmit and receive data to and from a remote device (e.g., an Origin or another Bot). An antenna 350 is typically attached to the housing 340 and electrically coupled to the transceiver 310. In various embodiments, the Bot 300 includes (not shown) multiple transmitters, multiple receivers, and multiple transceivers. In one embodiment, the antenna 350 is replaced with a multi-antenna array 350 that can form a plurality of beams each of which points in a distinct direction. The transmitter 312 can be configured to wirelessly transmit signals having different types or functions, such signals being generated by the processor 302. Similarly, the receiver 314 is configured to receive wireless signals having different types or functions, and the processor 302 is configured to process signals of a plurality of different types.

The Bot 300 in this example may serve as Bot 1 110 or Bot 2 120 in FIG. 1 for detecting object motion in a venue. For example, the wireless signal generator 322 may generate and transmit, via the transmitter 312, a wireless signal through a wireless multipath channel impacted by a motion of an object in the venue. The wireless signal carries information of the channel. Because the channel was impacted by the motion, the channel information includes motion information that can represent the motion of the object. As such, the motion can be indicated and detected based on the wireless signal. The generation of the wireless signal at the wireless signal generator 322 may be based on a request for motion detection from another device, e.g. an Origin, or based on a system pre-configuration. That is, the Bot 300 may or may not know that the wireless signal transmitted will be used to detect motion.

The synchronization controller 306 in this example may be configured to control the operations of the Bot 300 to be synchronized or un-synchronized with another device, e.g. an Origin or another Bot. In one embodiment, the synchronization controller 306 may control the Bot 300 to be synchronized with an Origin that receives the wireless signal transmitted by the Bot 300. In another embodiment, the synchronization controller 306 may control the Bot 300 to transmit the wireless signal asynchronously with other Bots. In another embodiment, each of the Bot 300 and other Bots may transmit the wireless signals individually and asynchronously.

The carrier configurator 320 is an optional component in Bot 300 to configure transmission resources, e.g. time and carrier, for transmitting the wireless signal generated by the wireless signal generator 322. In one embodiment, each CI of the time series of CI has one or more components each corresponding to a carrier or sub-carrier of the transmission of the wireless signal. The detection of the motion may be based on motion detections on any one or any combination of the components.

The power module 308 can include a power source such as one or more batteries, and a power regulator, to provide regulated power to each of the above-described modules in FIG. 3. In some embodiments, if the Bot 300 is coupled to a dedicated external power source (e.g., a wall electrical outlet), the power module 308 can include a transformer and a power regulator.

The various modules discussed above are coupled together by a bus system 330. The bus system 330 can include a data bus and, for example, a power bus, a control signal bus, and/or a status signal bus in addition to the data bus. It is understood that the modules of the Bot 300 can be operatively coupled to one another using any suitable techniques and mediums.

Although a number of separate modules or components are illustrated in FIG. 3, persons of ordinary skill in the art will understand that one or more of the modules can be combined or commonly implemented. For example, the processor 302 can implement not only the functionality described above with respect to the processor 302, but also implement the functionality described above with respect to the wireless signal generator 322. Conversely, each of the modules illustrated in FIG. 3 can be implemented using a plurality of separate components or elements.

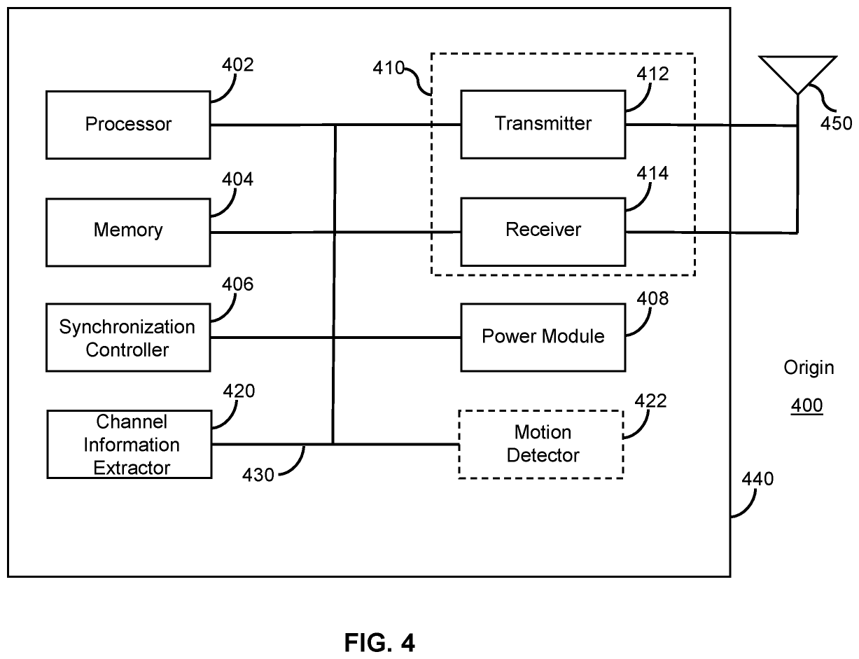

FIG. 4 illustrates an exemplary block diagram of a second wireless device, e.g. an Origin 400, of a wireless sensing system, according to one embodiment of the present teaching. The Origin 400 is an example of a device that can be configured to implement the various methods described herein. The Origin 400 in this example may serve as Origin 101 in FIG. 1 for detecting object motion in a venue. As shown in FIG. 4, the Origin 400 includes a housing 440 containing a processor 402, a memory 404, a transceiver 410 comprising a transmitter 412 and a receiver 414, a power module 408, a synchronization controller 406, a channel information extractor 420, and an optional motion detector 422.

In this embodiment, the processor 402, the memory 404, the transceiver 410 and the power module 408 work similarly to the processor 302, the memory 304, the transceiver 310 and the power module 308 in the Bot 300. An antenna 450 or a multi-antenna array 450 is typically attached to the housing 440 and electrically coupled to the transceiver 410.

The Origin 400 may be a second wireless device that has a different type from that of the first wireless device (e.g. the Bot 300). In particular, the channel information extractor 420 in the Origin 400 is configured for receiving the wireless signal through the wireless multipath channel impacted by the motion of the object in the venue, and obtaining a time series of channel information (CI) of the wireless multipath channel based on the wireless signal. The channel information extractor 420 may send the extracted CI to the optional motion detector 422 or to a motion detector outside the Origin 400 for detecting object motion in the venue.

The motion detector 422 is an optional component in the Origin 400. In one embodiment, it is within the Origin 400 as shown in FIG. 4. In another embodiment, it is outside the Origin 400 and in another device, which may be a Bot, another Origin, a cloud server, a fog server, a local server, and an edge server. The optional motion detector 422 may be configured for detecting the motion of the object in the venue based on motion information related to the motion of the object. The motion information associated with the first and second wireless devices is computed based on the time series of CI by the motion detector 422 or another motion detector outside the Origin 400.

The synchronization controller 406 in this example may be configured to control the operations of the Origin 400 to be synchronized or un-synchronized with another device, e.g. a Bot, another Origin, or an independent motion detector. In one embodiment, the synchronization controller 406 may control the Origin 400 to be synchronized with a Bot that transmits a wireless signal. In another embodiment, the synchronization controller 406 may control the Origin 400 to receive the wireless signal asynchronously with other Origins. In another embodiment, each of the Origin 400 and other Origins may receive the wireless signals individually and asynchronously. In one embodiment, the optional motion detector 422 or a motion detector outside the Origin 400 is configured for asynchronously computing respective heterogeneous motion information related to the motion of the object based on the respective time series of CI.

The various modules discussed above are coupled together by a bus system 430. The bus system 430 can include a data bus and, for example, a power bus, a control signal bus, and/or a status signal bus in addition to the data bus. It is understood that the modules of the Origin 400 can be operatively coupled to one another using any suitable techniques and mediums.

Although a number of separate modules or components are illustrated in FIG. 4, persons of ordinary skill in the art will understand that one or more of the modules can be combined or commonly implemented. For example, the processor 402 can implement not only the functionality described above with respect to the processor 402, but also implement the functionality described above with respect to the channel information extractor 420. Conversely, each of the modules illustrated in FIG. 4 can be implemented using a plurality of separate components or elements.

In one embodiment, in addition to the Bot 300 and the Origin 400, the system may also comprise: an assistance device, a third wireless device, e.g. another Bot, configured for transmitting an additional heterogeneous wireless signal through an additional wireless multipath channel impacted by the motion of the object in the venue, or a fourth wireless device, e.g. another Origin, that has a different type from that of the third wireless device. The fourth wireless device may be configured for: receiving the additional heterogeneous wireless signal through the additional wireless multipath channel impacted by the motion of the object in the venue, and obtaining a time series of additional channel information (CI) of the additional wireless multipath channel based on the additional heterogeneous wireless signal. The additional CI of the additional wireless multipath channel is associated with a different protocol or configuration from that associated with the CI of the wireless multipath channel. For example, the wireless multipath channel is associated with LTE, while the additional wireless multipath channel is associated with Wi-Fi. In this case, the optional motion detector 422 or a motion detector outside the Origin 400 is configured for detecting the motion of the object in the venue based on both the motion information associated with the first and second wireless devices and additional motion information associated with the third and fourth wireless devices computed by at least one of: an additional motion detector and the fourth wireless device based on the time series of additional CI.

In some embodiments, the present teaching discloses systems and methods for fall-down detection. In some embodiments, systems and methods are disclosed for fall-down detection based on radio signal plus auxiliary signal (e.g. speech/audio/sound/light/image/video/vibration/pressure). Fall (or abrupt/impulsive/transient motion, or motion with an impact, or motion that generates sound/vibration/pressure change, or “target motion”) would affect radio channel (e.g. WiFi) in a certain way that can be captured using wireless transceivers (e.g. WiFi chips), and thus radio-based fall detection (or radio-based target motion detection) is possible. But fall-related radio “signature”/profile/pattern may resemble that of other (non-target) events leading to confusion. Fall (or abrupt/impulsive/transient motion, or motion with an impact, or motion that generates sound/vibration/pressure change, or target motion) would usually generate an auxiliary signal (e.g. sound/light/pressure/vibration) that can be captured/sensed using a sensor (e.g. microphones to capture sound, camera/light sensor to capture light, pressure sensor for pressure), and thus aux-based fall detection is possible. But fall-related auxiliary signal (e.g. sound) may be similar to/confusable with that of other (non-target) events leading to confusion/false alarm.

One goal of the present teaching is to use radio signal plus auxiliary (aux) signal to do better hybrid target motion (e.g. fall) detection. For example, the system can combine radio and aux to detect target motion (e.g. fall) jointly. The system may use radio and aux, one-at-a time/sequentially.

Option (a): the system may use radio-based target-motion detection first (tentatively/preliminary/initial) and then use aux-based target-motion detection to confirm/reject. Only when radio-based detection reports a potential target motion (e.g. fall) based on some radio-based criterion, the aux-based target-motion detection starts to check some aux-based criterion (e.g. if auxiliary signal is significant, e.g. sound is loud and brief). If yes, then target motion (e.g. fall) is detected/reported; otherwise, the tentative/preliminary/initial detection a false alarm.

Option (b): the system may use aux-based fall detection first and use radio-based fall detection to confirm/reject.

Instead of one-at-a-time, in option (c): the system may also use both auxiliary and radio together/two-at-a-time to detect target motion.

Radio-based target motion detection: Obtain time series of channel information (TSCI). Features (e.g. magnitude) may be computed. A time series of spatial-temporal information (TSSTI) may be computed based on features of TSCI. Each STI may be speed or acceleration (derivative of speed). Recognition of target radio behavior of TSSTI associated with target motion may be performed. For example, target motion may be fall (fall down). For free fall of an object, the acceleration may abruptly increase from 0 to 1G (i.e. acceleration due to gravity, approx. 9.8 m/s) until it lands on floor abruptly (when acceleration decreases from 1G to 0G abruptly). Sometimes a falling person may try to hold onto/grab something (e.g. furniture/table/chair) slowing him/her down, leading to acceleration abruptly increasing from 0 to less-than-1G. Sometimes a fall person may free fall before holding onto/grabbing/hitting something, such that (s.t.) acceleration increases from 0 to 1G (free fall) and then to less-than-1G. A fall person may fall onto something soft (e.g. sofa, mattress, carpet) and have a soft landing, with acceleration decreasing from 1G to 0G gradually (instead of abruptly).

Aux-based target motion detection: Obtain time series of auxiliary samples (TSAS). Features (e.g. magnitude, magnitude square) may be computed for each AS to get a time series of auxiliary feature (TSAF). Recognition of target auxiliary behavior of TSAF may be performed. If recognized, target motion may be detected. Auxiliary signal may be sound s.t. target auxiliary behavior may be a loud/brief/impulsive sound (target auxiliary behavior). To detect loud sound, AF should be larger than some threshold, or larger than some threshold for a majority of time within a short window (e.g. 0.1 second). Or, AF may be smoothed and the local max should be greater than some threshold to detect the loud sound.

In some embodiments, auxiliary signal is NOT radio signal. It may be audible/acoustic/sound/speech/vocal/audio signal, which may be sensed/captured by acoustic sensor (e.g. microphone). Auxiliary signal may be light/image/video, which may be sensed by camera/IR/PIR/light sensor. Auxiliary signal may be pressure/vibration signal, which may be sensed/captured by pressure/vibration sensor. Auxiliary signal may not be a radio signal. Auxiliary signal may not be data communication signal. Motion may be fall down motion, abrupt motion, transient motion, or motion with an impact. Microphone may be mono (one channel), stereo (two channels), or multiple channels.

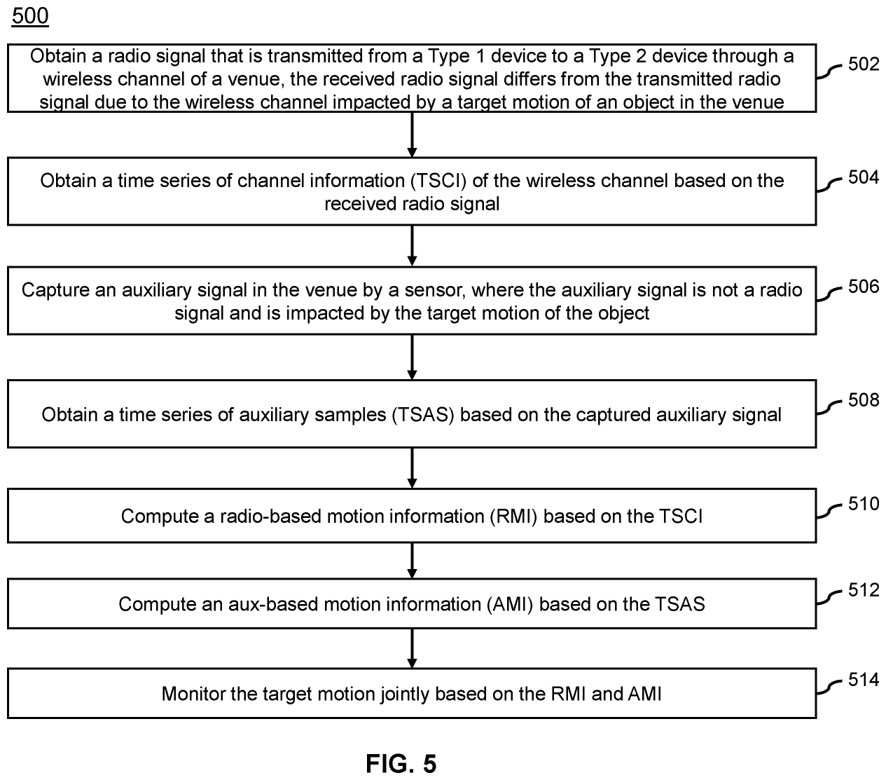

FIG. 5 illustrates a flow chart of an exemplary method 500 for hybrid radio-plus-aux fall-down detection based on wireless sensing, according to some embodiments of the present disclosure. In various embodiments, the method 500 can be performed by the systems disclosed above. At operation 502, a radio signal is obtained, where the radio signal is transmitted from a Type 1 device to a Type 2 device through a wireless channel of a venue, the received radio signal differs from the transmitted radio signal due to the wireless channel impacted by a target motion of an object in the venue. At operation 504, a time series of channel information (TSCI) of the wireless channel is obtained based on the received radio signal. At operation 506, an auxiliary signal is captured in the venue by a sensor, where the auxiliary signal is not a radio signal and is impacted by the target motion of the object.

At operation 508, a time series of auxiliary samples (TSAS) is obtained based on the captured auxiliary signal. At operation 510, a radio-based motion information (RMI) is computed based on the TSCI. At operation 512, an aux-based motion information (AMI) is computed based on the TSAS. At operation 514, the target motion is monitored jointly based on the RMI and AMI. The order of the operations in FIG. 5 may be changed according to various embodiments of the present teaching.

In some embodiments, the system first performs radio-based detection based on RMI and/or radio-based criterion, then performs aux-based detection based on AMI and/or aux-based criterion, sequentially. In some embodiments, the system first performs aux-based detection based on AMI and/or aux-based criterion, then performs radio-based detection based on RMI and/or radio-based criterion, sequentially. In some embodiments, the system simultaneous and contemporaneously performs an aux-radio-based detection based on both RMI and AMI (radio-aux-criterion).

The following numbered clauses provide examples for a hybrid radio-plus-aux fall-down detection.

Clause A1. A method/device/system/software of a hybrid radio-plus-aux monitoring system for monitoring a target motion in a venue, comprising: receiving a radio signal by a Type 2 heterogeneous wireless device in a venue, wherein the radio signal is transmitted to the Type 2 device by a Type 1 heterogeneous wireless device through a wireless multipath channel of the venue, wherein the received radio signal differs from the transmitted radio signal due to the wireless multipath channel impacted by the target motion of an object in the venue; obtaining a time series of channel information (TSCI) of the wireless multipath channel based on the received radio signal based on a processor, a memory and a set of instructions; capturing an auxiliary signal in the venue by a sensor, wherein the auxiliary signal is not a radio signal and comprises at least one of: an audible signal less than 100 kHz, a perceptual signal, an acoustic signal, a sound signal, a speech signal, a vocal signal, an audio signal, a visual signal, a light signal, an image, a video, a mechanical signal, a vibration signal, or a pressure signal, wherein the auxiliary signal is impacted by the target motion of the object; obtaining a time series of auxiliary samples (TSAS) based on the captured auxiliary signal; and monitoring the target motion jointly based on the TSCI and TSAS.

In some embodiments, RMI may be speed/acceleration. AMI may be sound volume/energy score (for detecting “loud” sound). E.g. AMI may be sum of magnitude (or magnitude square) of all AA in a time window.

Clause A2. The method/device/system/software of the hybrid radio-plus-aux monitoring system of clause A1, comprising: computing a radio-based motion information (RMI) based on the TSCI; computing an aux-based motion information (AMI) based on the TSAS; monitoring the target motion jointly based on the RMI and AMI.

In some embodiments, detection can be performed using radio/aux either one-at-a-time (radio-based+aux-based), or two-at-a-time (radio-aux-based).

Clause A3. The method/device/system/software of the hybrid radio-plus-aux monitoring system of clause A2, comprising: computing at least one of: a radio-based detection of the target motion of the object based on the RMI or the TSCI, a aux-based detection of the target motion of the object based on the AMI or the TSAS, or a radio-aux-based detection of the target motion of the object based on the RMI and the AMI, or the TSCI and the TSAS; detecting the target motion of the object jointly based on the at least one of: the radio-based detection, the aux-based detection, or the radio-aux-based detection.

In some embodiments, one-at-a-time (option a or b), in which radio-based and aux-based are performed sequentially.

Clause A4. The method/device/system/software of the hybrid radio-plus-aux monitoring system of clause A3, comprising: computing the radio-based detection and aux-based detection sequentially; detecting the target motion of the object jointly based on the radio-based detection and the aux-based detection.

Clause A5. The method/device/system/software of the hybrid radio-plus-aux monitoring system of clause A4, comprising: wherein the target motion is detected in the radio-based detection when a radio-based criterion is satisfied, and wherein the target motion is detected in the aux-based detection when an aux-based criterion is satisfied.

In some embodiments, one-at-a-time, (option a): radio-based based on RMI first. Then use aux-based based on AMI to confirm.

Clause A6. The method/device/system/software of the hybrid radio-plus-aux monitoring system of clause A5, comprising: computing a tentative detection of the target motion of the object based on the radio-based detection; when the target motion is detected in the tentative detection: computing the AMI based on the TSAS, computing a final detection of the target motion of the object based on the aux-based detection.

In some embodiments, one-at-a-time, (option b): aux-based first. Then use radio-based to confirm.

Clause A7. The method/device/system/software of the hybrid radio-plus-aux monitoring system of clause A5, comprising: computing a tentative detection of the target motion of the object based on the aux-based detection; when the target motion is detected in the tentative detection: computing the RMI based on the TSCI, computing a final detection of the target motion of the object based on the radio-based detection.

In some embodiments, two-at-a-time (option c), in which radio-aux-based detection based on both RMI and AMI is performed.

Clause A8. The method/device/system/software of the hybrid radio-plus-aux monitoring system of clause A3, comprising: computing the radio-aux-based detection; detecting the target motion of the object jointly based on the radio-aux-based detection.

Clause A9. The method/device/system/software of the hybrid radio-plus-aux monitoring system of clause A8, comprising: wherein the target motion is detected in the radio-aux-based detection when a radio-aux-based criterion is satisfied.

In some embodiments, details of RMI and the radio-based criterion, features of CI, and STI can be computed based on the CI features, and RMI based on STI.

Clause A10. The method/device/system/software of the hybrid radio-plus-aux monitoring system of clause A5, comprising: computing a feature for each channel information (CI) of the TSCI, wherein the feature comprises at least one of: transform, magnitude, amplitude, energy, power, intensity, strength, a monotonic function of any of the above, or a sliding aggregate of any of the above, wherein any aggregate comprises at least one of: sum, weighted sum, average, weighted average, trimmed mean, arithmetic mean, geometric mean, harmonic mean, percentile, median, mode, another monotonic function of any of the above, or another aggregate of any of the above. computing a time series of spatial-temporal information (TSSTI) of the target motion of the object based on the feature of CI of the TSCI, wherein each spatial-temporal information (STI) comprises at least one of: a location, a zone, a direction, a speed, or an acceleration; computing the RMI based on the TSSTI.

Clause A11. The method/device/system/software of the hybrid radio-plus-aux monitoring system of clause A10, comprising: recognizing a target radio behavior of the TSSTI associated with the target motion of the object; wherein the radio-based criterion is satisfied when the target radio behavior of the TSSTI is recognized.

In some embodiments, RMI is acceleration, or derivative of speed.

Clause A12. The method/device/system/software of the hybrid radio-plus-aux monitoring system of clause A11, comprising: wherein the target motion is a fall-down motion; wherein the STI is one of: a speed, or an acceleration, of the motion of the object; wherein the speed is non-negative; wherein RMI is the acceleration which is a first-order derivative of speed; wherein the target behavior of TSSTI comprises the following sequence of events: acceleration remaining at near-zero for a first duration; then increasing from near-zero to near-1G within a second duration, then remaining at near-1G for a third duration, then decreasing from near-1G to near-zero within a fourth duration, and then remaining at near-zero for a fifth duration; wherein near-zero is a range of acceleration less than a sixth threshold, comprising zero G, wherein G is acceleration due to gravity; wherein near-1G is a range of acceleration greater than a seventh threshold, comprising one G.

Clause A13. The method/device/system/software of the hybrid radio-plus-aux monitoring system of clause A12, comprising: wherein the first duration is greater than a first threshold; wherein the second duration is less than a second threshold; wherein the third duration is less than a third threshold; wherein the fourth duration is less than a fourth threshold; wherein the fifth duration is greater than a fifth threshold;

Clause A14. The method/device/system/software of the hybrid radio-plus-aux monitoring system of clause A10, comprising: wherein each STI is computed based on a similarity score between a pair of temporally adjacent CI of the TSCI.

Clause A15. The method/device/system/software of the hybrid radio-plus-aux monitoring system of clause A14, comprising: wherein each STI is computed based on a function in a time window associated with the STI; wherein the function comprises at least one of: transform, frequency transform, inverse frequency transform, Fourier transform, inverse Fourier transform, convolution, auto correlation function, cross correlation function, auto covariance function, or cross covariance function, wherein the function is computed based on the TSCI or the features of the TSCI in the time window.

Clause A16. The method/device/system/software of the hybrid radio-plus-aux monitoring system of clause A15, comprising: wherein the STI is computed based on a characteristic point of the function; wherein the characteristic point comprises at least one of: a global maximum, a global minimum, a local maximum, a local minimum, a constrained local maximum, a constrained local minimum, a first local maximum, a first local minimum, a k-th local maximum, a k-th local minimum, a pair of adjacent local maximum and a local minimum, a zero-crossing, an aggregate, an average, a weighted average, a percentile, a median, a mode, a mean, or a trimmed mean.

In some embodiments, details of AMI and the aux-based criterion (detection of loud sound associated with fall). TSAS may be preprocessed. Aux feature may be extracted.

Clause A17. The method/device/system/software of the hybrid radio-plus-aux monitoring system of clause A5, comprising: preprocessing the TSAS, wherein the preprocessing comprises at least one of: denoising, smoothing, lowpass filtering, bandpass filtering, highpass filtering, or conditioning; computing a feature for each preprocessed auxiliary sample (AS) in a time window of the preprocessed TSAS, wherein the feature comprises at least one of: transform, magnitude, amplitude, energy, power, intensity, strength, a monotonic function of any of the above, or a sliding aggregate of any of the above, wherein any aggregate comprises at least one of: sum, weighted sum, average, weighted average, trimmed mean, arithmetic mean, geometric mean, harmonic mean, percentile, auxiliary, mode, another monotonic function of any of the above, or another aggregate of any of the above.

Clause A18. The method/device/system/software of the hybrid radio-plus-aux monitoring system of clause A17, comprising: recognizing a target auxiliary behavior of the TSAS associated with the target motion of the object; wherein the aux-based criterion is satisfied when the target auxiliary behavior of the TSAS is recognized.

In some embodiments, possibility 1: AMI is aggregate of AS magnitude in a time window and is greater than a threshold.

Clause A19. The method/device/system/software of the hybrid radio-plus-aux monitoring system of clause A18, comprising: computing the AMI as a second aggregate of the features of the AS in the time window of the TSAS, wherein the target auxiliary behavior of the TSAS is recognized when the AMI is greater than a threshold.

In some embodiments, possibility 2: AMI is all AS magnitude in time window. Each AS magnitude may be compared with a first threshold. The amount (or percentage) of AS magnitude greater than first threshold may be counted/computed. Criterion may be satisfied if the amount (or percentage) is greater than second threshold.

Clause A20. The method/device/system/software of the hybrid radio-plus-aux monitoring system of clause A18, comprising: wherein the AMI comprises all the features of the AS in the time window; wherein the target auxiliary behavior of the TSAS is recognized when the amount of AMI in the time window exceeding a first threshold is greater than a second threshold.

In some embodiments, details of RMI/AMI and the radio-aux-based criterion. CI may have multiple components (e.g. subcarriers). AS may have multiple components (e.g. stereo sound has left/right components/channels, 5.1 surround sound may have 6 components/channels). Feature (e.g. magnitude, magnitude square) of each component may be computed. STI may be computed based on CI component features. AF may be computed by aggregating component features of each AS.

Clause A21. The method/device/system/software of the hybrid radio-plus-aux monitoring system of clause A9, comprising: wherein each CI and each AS comprise at least one component, computing a first component feature for each component of each channel information (CI) of the TSCI; computing a time series of spatial-temporal information (TSSTI) of the target motion of the object based on the first component features of the components of the CI of the TSCI; computing a second component feature for each component of each auxiliary sample (AS) of the TSAS; computing a time series of auxiliary features (TSAF) based on the second component features of the components of the AS of the TSAS, each auxiliary feature being an aggregate of the second component features of a respective AS, wherein any aggregate comprises at least one of: sum, weighted sum, average, weighted average, trimmed mean, arithmetic mean, geometric mean, harmonic mean, percentile, median, mode, another monotonic function of any of the above, or another aggregate of any of the above.

In some embodiments, RMI/AMI may be recognition score of target radio/auxiliary behavior. Target motion may be recognized if RMI>T1 and AMI>T2, or if aggregate of RMI and AMI>T3.

Clause A22. The method/device/system/software of the hybrid radio-plus-aux monitoring system of clause A21, comprising: recognizing a target radio behavior of the TSSTI associated with the target motion of the object; computing the RMI as a recognition score of the recognition of the target radio behavior of the TSSTI; recognizing a target auxiliary behavior of the TSAF associated with the target motion of the object; computing the AMI as a recognition score of the recognition of the target auxiliary behavior of the TSAF; computing a combined motion information (CMI) as an aggregate of the RMI and the AMI; wherein the radio-aux-based criterion is satisfied when the CMI exceeds a first threshold; wherein the radio-aux-based criterion is also satisfied when RMI exceeds a second threshold and AMI exceeds a third threshold.

In some embodiments, the present teaching discloses systems and methods for wireless sensing based on a network comprising local groups of wireless devices.

In some embodiments, a combination of local subsystems with a main system is disclosed. One aspect of the present teaching is about performing wireless sensing in a venue with multiple groups of devices, establishing (a) a local wireless sensing subsystem based on each group of devices, and (b) a main wireless sensing system in the venue linking/connecting all the local wireless sensing subsystems.

Grouping of devices. For a venue, a user may define a number of groups and assign each device in the venue to a group. The user may use a user device (e.g. smart phone, computer, tablet or other smart device) to connect/interact with each device to assign the device to the groups. For example, each group of devices may be associated with a certain area/zone (e.g. bedroom, kitchen, living room) in the venue (e.g. a house). There may be multi-tier or hierarchical grouping. In a high level, there may be no subdivision such that all devices are in the same group (e.g. all devices in a house considered as one group). In the next level, the group may be subdivided into two or more subgroups (e.g. a “first-floor” subgroup comprising devices in first floor of the house, a “second-floor” subgroup comprising devices in second floor). In the next level, a subgroup may be subdivided into two or more sub-sub-groups (e.g. second-floor devices subdivided into sub-subgroups such as “bedroom 1”, “bedroom 2”, etc.; first-floor devices subdivided into sub-subgroups such as “kitchen”, “living room”, “dining room”, etc.) and so on.

Network of networks configuration. The main wireless sensing system comprises a network of devices in a star configuration with a device in the center of the star configuration (called “main center device”) and a number of devices at the vertices of the star configuration (called “main terminal devices”) linked/connected radially to the main center device. Similarly, each subsystem comprises a network (or sub-network, called “local sub-network”) of devices in a star configuration with a corresponding local device in the center of the star configuration (called “local center device”) and a number of devices at the vertices of the star configuration (called “local terminal devices”) linked/connected radially to the local center devices.

In some embodiments, the user may designate each device to the roles of main center device, main terminal devices, local center devices and local terminal devices. A device may be designated to multiple roles (e.g. both a main terminal device and a local terminal device). If the user does not differentiate the devices in a particular into local center device and local terminal device, a certain algorithm may be applied to automatically choose one of a group of devices to be local center device. For example, a criterion for the choice of local center device may be the ability to be an access point (AP), or the ability to multi-cast/broadcast. The device with recent multi-cast may be chosen.

Wireless sensing in local subsystems/networks. Wireless sensing measurements take place in the subsystems (local sub-networks). The devices may be configured to perform wireless sensing in each link (or branch) of each subsystem (local sub-network). In other words, pairwise wireless sensing is performed between the local center device and each local terminal device. In each link, a first device (either the local center device or the local terminal device) functions as a Type1 device to transmit a wireless signal (e.g. a train of sounding signals, null-data-packet, NDP, NDP announcement, NDPA, NDPA sounding, trigger-based (TB) sensing, non-TB sensing, trigger frame (TF) sounding, NDPA sounding, initiator-to responder (I2R) sounding, responder-to-initiator (R2I) sounding) to the second device. The second device (either the local terminal device or the local center device) obtains information of the wireless channel (channel information or CI, such as CSI, CIR, CFR, etc.) based on the received wireless signal. It may perform some WiFi sensing computational tasks based on the CI to obtain raw sensing data. It may transmit/report the raw sensing data to the first device. It may transmit/report the CI to the first device which would perform some WiFi sensing computational tasks based on the CI to obtain raw sensing data.

In some embodiments, if the local center device is the first device in multiple links in the local sub-network, it may broadcast, multi-cast and/or unicast the wireless signal(s) to the local terminal devices in the multiple links. In some embodiments, if the local center device is the second device in multiple links, the local terminal devices in the multiple links may transmit the respective wireless signals simultaneously and/or sequentially. Such transmission may be in response to some signal (e.g. trigger signal, trigger frame, polling signal) from the local center device.

In some embodiments, the main center device may establish a local subsystem (local sub-network) with itself being the local center device of the star configuration of the local subsystem and may take part in wireless sensing accordingly.

Details of sensing setup and signaling. More than one wireless signals may be simultaneously transmitted using different frequency bands, different frequency subbands, different frequency carriers, different antennas, and/or different beamforming/beamformer. The configuration of the devices, configuration (e.g. sensing session setup, sensing measurement setup, sensing-by-proxy (SBP) setup) of each pair of devices performing pairwise wireless sensing, transmission of the wireless signal, and/or the obtaining of channel information may be based on a standard (e.g. 802.11, 802.11bf, 4G, 5G, 6G, 7G, 8G, etc.). The transmission of the wireless signal may be in response or correlated to another wireless signal or wireless handshake/procedure (e.g. trigger signal, request, SBP request, sensing session set up, sensing measurement set up). The transmission of the wireless signal may be associated with an identification (ID, e.g. session ID, measurement ID, session setup ID, measurement setup ID, measurement instance ID, time code, etc.).

Main network and local sub-network linkage. In some embodiments of the present teaching, a local sub-network may be linked to the main network in 3 possible methods: (a) via the local center device of the local sub-network, (b) via the local terminal devices of the local sub-network, or (c) via both the local center device and at least one terminal device.

In Method (a), the local center device of the local sub-network is linked/connected to the main center device in the main network. In other words, the local center device is also a main terminal device. The local center device may function as the second device such that the wireless signals may be transmitted from the local terminal devices to the local center device. TB sensing with TF sounding may be used. Non-TB sensing with I2R sounding may be used. Alternatively, the local center device may function as the first device such that the wireless signal(s) may be broadcasted/multi-casted/unicasted/transmitted from the local center device to the local terminal devices. TB sounding may be used. NDPA sounding may be used. The CI obtained by the local terminal device, or raw sensing data computed based on the CI by the local terminal device, may be transmitted/reported to the local center device.

In Method (b), each local terminal device is linked/connected to the main center device. In other words, each local terminal device is also a main terminal device. The local center device may function as the first device such that the wireless signal(s) may be broadcasted, multi-casted or unicasted from the local center device to the local terminal devices. Alternatively, the local center device may function as the second device such that the wireless signals are transmitted from the local terminal devices to the local center device. The CI obtained by the local center device, or raw sensing data computed based on the CI by the local center device, may be transmitted/reported to the local terminal device.

In Method (c), both the local center device and at least one local terminal device are linked/connected to the main center device. Method (c) is a hybrid between (a) and (b). The local center device may function as the first device such that the wireless signal(s) may be broadcasted, multi-casted or unicasted from the local center device to the local terminal devices. The local center device may function as the second device in some links such that the wireless signals are transmitted from the local terminal devices to the local center device.

Center devices being AP. Note that each center device may be an access point of the corresponding network. For example, a local center device may be the access point (AP) of the corresponding local sub-network, while the main center device may be AP of the main network. The center device may have broadband/internet access.

Local terminal device network usage. For Method (a), (b) or (c) in which a local device in a local sub-network (either local center device or local terminal device) may be simultaneously a main terminal device, the local device may be associated with the local sub-network using one channel or one band (e.g. a 2.4 GHz channel, a 5 GHz channel, a 60 GHz channel, a millimeter wave channel, a UWB channel) and a second network of the main center device using a second channel or a second band (e.g. a 2.4 GHz channel, a 5 GHz channel, a 60 GHz channel, a millimeter wave channel, a UWB channel) simultaneously. The local device may be a dual-band, tri-band, quad-band or higher-band device. It may use the first network to perform wireless sensing (transmit or receive wireless signal and obtain raw sensing result/data computed based on CI obtained from the wireless signal) and use the second network to transmit the raw sensing data to the main center device.

Main center device network usage. The main center device may simultaneous be a local center device associated with its own or “personal” local sub-network. In addition to be AP for the main network, it may simultaneously be the AP of its personal local sub-network. It may use a first channel or a first band for the main network and use a second channel or a second band for the personal local sub-network. The first channel and the second channel may be the same or different. The personal local sub-network and the main network may be the same network.

The main center device may use the main network to receive raw sensing data (or result) from the local sub-networks and to send configuration or software update information to the local terminal devices. Configuration or software update information for the local center device may be sent by the main center device to the local center device directly using the main network. The configuration or software update information for the local center device may also be sent by the main center device to a local terminal device using the main network enroute to the local center device via the local sub-network.

In some embodiments, the main center device may use its personal local sub-network to perform wireless sensing. The resulting raw sensing data obtained in the wireless sensing may be transmitted/reported to the main center device via the personal local sub-networks or the main network.

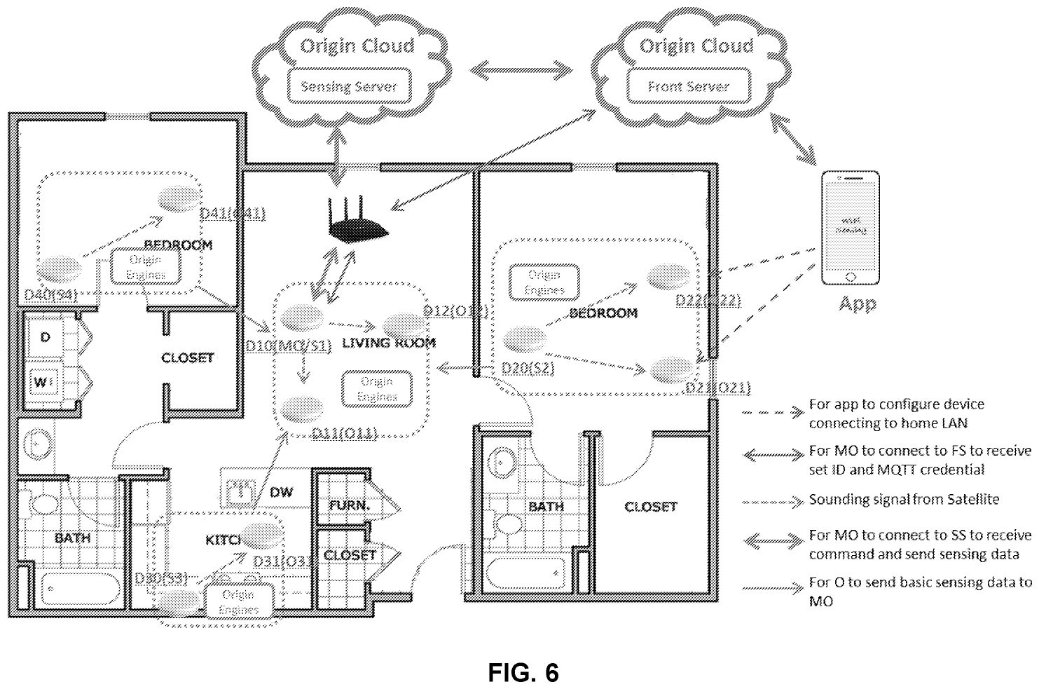

An example of performing wireless sensing in a venue with multiple groups of devices based on the disclosed method is illustrated in FIG. 6. The venue is a house with four zones, including two bedroom areas, a living room area and a kitchen area. The house has a WiFi router that has broadband connection to two cloud servers: a sensing server and a front server. The WiFi router establishes a home WiFi network with SSID MYHOME. The wireless sensing system comprises four subsystems formed by ten WiFi devices in the house. Three of the devices D10, D11, and D12 together form the first subgroup of devices that constitute a first subsystem or local sub-network to monitor a first zone (the living room area). Another three devices D20, D21, and D22 together form the second subgroup of devices that constitute a second subsystem or local sub-network to monitor a second zone (a bedroom area). Two devices D30 and D31 together form the third subgroup of devices that constitute a third subsystem to monitor a third zone (the kitchen area). Two devices D40 and D41 together form the fourth subgroup of devices that constitute a fourth subsystem (local sub-network) to monitor a fourth zone (another bedroom area).

In some embodiments, among the devices, D10 is the designated main center device, called master origin (MO), of the main network and the designated local center device of the first local sub-network. D11 and D12 are the designated local terminal devices of the first local sub-network. D10 has a dual band WiFi router chip with a 2.4 GHz band radio and a 5 GHz band radio. D10 is configured to be an AP to establish the first local sub-network with an SSID of “SENSE-SUBNET-01” using the 5 GHz radio. Each of D11 and D12 is a WiFi-enabled IoT device and is configured to associate with D10 and join the SENSE-SUBNET-01 network using the 5 GHz radio. Wireless sensing is performed in the first local sub-network with D10 broadcasting/multi-casting/unicasting a series of sounding signals to D11 and D12, each of which extracts CSI from the received sounding signals and performs at least one sensing computation task based on the CSI (e.g. motion detection, breathing detection, fall-down detection, etc.) to obtain raw sensing results (e.g. labels such as “motion detected”, “motion not detected”, “breathing detected”, “breathing not detected”, “fall-down detected”, “fall-down not detected”, motion statistics, breathing rate, etc.). In FIG. 6, a device marked “(O ##)” is an Origin (or Type2 device); a device marked “(S #)” (e.g. “S1” or “S2” or “S3” or “S4”) is a Satellite. In some embodiments, a Satellite is basically Tx or transmitter or Type1 device; while an Origin is basically Rx or receiver or Type2 device.

In some embodiments, all the devices (D10, D11, D12, D20, D21, D22, D30, D31, D40, D41) are configured to associate with the MYHOME home WiFi network using the 2.4 GHz radio. The subsystems report/transmit raw sensing results to the main center device (D10) or cloud server using MYHOME home WiFi network.

In a similar manner, each of the other local sub-networks has a designated local center device (e.g. D20 for the second local sub-network, D30 for the third and D40 for the fourth) and a number of designated local terminal devices. The designated local center device is configured to be an AP to establish the corresponding local sub-network with a corresponding SSID (“SENSE-SUBNET-02” for the second local sub-network, “SENSE-SUBNET-03” for the third, “SENSE-SUBNET-04” for the fourth) using the 5 GHz radio. Each designated local terminal device is configured to associate with the corresponding local center device and join the corresponding local sub-network. To perform the wireless sensing, the local center device transmits/broadcasts/multi-casts/unicasts a series of sounding signals to the local terminal device(s). Each local terminal device obtains CSI from the received sounding signals, performs at least one sensing computation task based on the CSI to obtain raw sensing results. The raw sensing results may be reported/transmitted to the main center device (D10) or cloud servers using the MYHOME home WiFi network. In some embodiments, the main center device (D10) may be configured to combine/process/fuse the raw sensing results and/or to report/transmit the results to the cloud servers.

In some embodiments, a plurality of wireless devices (a set of heterogeneous wireless devices) in a venue (e.g. home) may be grouped into N+1 groups/networks (N>2), comprising a “main group” (Tier-1 network) and N “subgroups” (Tier-2/3/ . . . /K networks). The groups/networks may be overlapping, e.g. two groups/networks may share a common device (i.e. a device may be in both the main group and a subgroup). A subgroup (Tier-2/Tier-3/ . . . /Tier-K network) may/may not be a subset of the main group. Each subgroup (Tier-K network for some K>1) may comprise at least one device (called “particular wireless devices”) being also in the main group (Tier-1 network).

In some embodiments, one of the N+1 groups may be a “main” group (first subset) of wireless devices, and may constitute a “main wireless sensing system”, with one device being “main center device” (first device) and the others in the group being “main terminal device(s)” (Tier-1 devices). All devices in the main group may be communicatively coupled in a “main” wireless network/Tier-1 network (e.g. home WiFi network “MyHome”) via a “main” wireless channel (first wireless channel) based on a “main” protocol (first protocol, e.g. 2.4 GHz, WiFi, 802.11 standard, 20 MHz channel). All devices in the main group may be associated with a “main” access-point (AP, e.g. home AP) and the “main” wireless network may be a wireless network associated with the main AP (e.g. home WiFi network).

In some embodiments, each of N remaining groups may be a “subgroup” (or Tier-2 group) of wireless devices, and may constitute a “sub-system” or a local system, with one device being “local center device” and the others in the subgroup being “local terminal device(s)”. All devices in a respective subgroup may be communicatively coupled in a respective wireless network or a respective local sub-network via a respective “local” wireless channel based on a respective “local” protocol (e.g. one subgroup may use 5 GHz, WiFi, 802.11 standard, 20 MHz channel; another subgroup may use 5 GHz, WiFi, 80 MHz channel). The respective local center device may function as a respective AP and the respective wireless network or respective local sub-network may be the associated wireless network.

In a subgroup, the local center device may be either the main center device, or a main terminal device. None, one, more than one, or all, of local terminal device(s) of the subgroup may be either the main center device, or a main terminal device. Wireless channels used by the main group (e.g. 2.4 GHz WiFi) may be different from those used by the subgroups (e.g. 5 GHz WiFi).

Except for the main group, each group (Tier-K network, K>1) may be used to perform wireless sensing measurement (sensing measurement setup, transmission of wireless sounding signals, extraction of channel information (TSCI), polling/reporting/termination, computation of pairwise sensing analytics, aggregation of pairwise sensing analytics to compute combined sensing analytics). A gateway device in each group/Tier-K network may be used to report sensing results obtained/computed in the Tier-K network to a device in a Tier-(K−1) network.

The N+1 networks may be configured to form a network of networks, with a multi-tier structure. A Tier-K network reports sensing results to a Tier-(K−1) network, for any K>1. Tier-1 network may be the main network. The N groups may form N sub-networks (performing sensing measurements), and one group may be in a main network (enabling communication of sensing results/analytics/TSCI).

A gateway device may comprise multiple radios (e.g. 2.4 GHz radio and 5 GHz radio), and may use them to join more than one networks. For example, a Tier-3 gateway device (e.g. third particular wireless device) may use 5 GHz/6 GHz radio to join a Tier-3 network for performing/obtaining sensing measurements (e.g. TSCI, pairwise sensing analytics) and may use 2.4 GHz radio to join Tier-1 network (e.g. first network, home network)) and use the Tier-1 network to send sensing results computed in the Tier-3 network from the Tier-3 network to a gateway device of a Tier-2 network (e.g. second particular wireless device) via the Tier-1 network. Similarly, the Tier-2 network may use its own 2.4 GHz radio to join the Tier-1 network and to use its 5 GHz/6 GHz radio to perform/obtain sensing measurements.

In some embodiments, a gateway device links/connects two networks: a Tier-(K−1) network and a Tier-K network (e.g. Tier-1 network and Tier-2 network). Sensing results obtained in the Tier-K network may be transmitted from the Tier-K network to the Tier-(K−1) network (via the Tier-1 network).

In some embodiments, first combined analytics is associated with first wireless network (Tier-1). First device may compute first combined analytics by aggregating combined analytics from Tier-2 networks. Second combined analytics/particular device are associated with second wireless network (Tier-2). Third combined analytics/particular device are associated with third wireless network (Tier-3). Fourth combined analytics/particular device are associated with fourth wireless network (Tier-3). Fifth combined analytics/particular device are associated with fifth wireless network (Tier-2).

In some embodiments, pairwise sensing analytics may comprise a characteristics/spatial-temporal information(STI)/motion information(MI) of an object or a motion of the object. Pairwise sensing analytics may be based on a similarity score between a pair of temporally adjacent CI of a TSCI. The combined sensing analytics may be simply the pairwise sensing analytics (e.g. in the case of only 2 sensing devices in second network (Tier-K network).

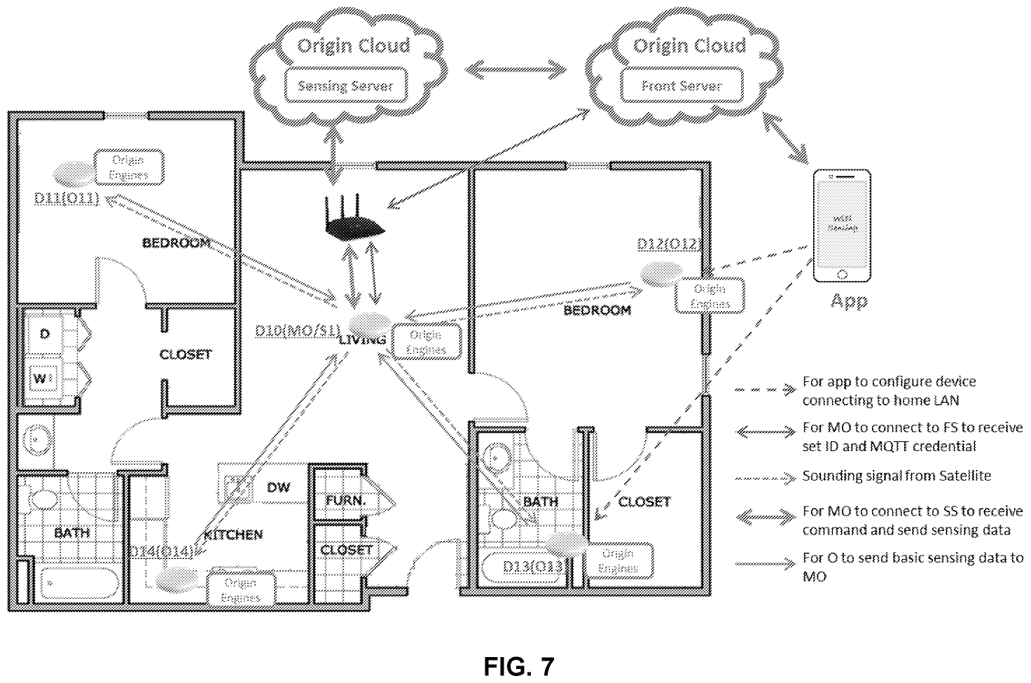

While FIG. 6 illustrates a per-room deployment for wireless sensing, FIG. 7 illustrates a whole-home deployment for wireless sensing. The per-room deployment may be suitable to sense fall detection, automation, and/or activity of daily living (ADL) on a per-room basis. The whole-home deployment may be suitable to sense home security and/or ADL on a whole-home basis. In some embodiments, a same system can support both deployment manners.

In some embodiments, all devices for wireless sensing are provisioned to a front server (FS) with UN/PW (password). One can extend FS or create an AS to support this development. All devices may be in softAP mode with known SSID/PW. As shown in FIG. 6, the set of devices at home includes: {D10, D11, D12, D20, D21, D22, D30, D31, D40, D41}.

During an onboarding process, an app can be used to scan QR codes and register devices to FS under a user account. FS then generates a set ID for the user and creates a sounder.conf file that contains the set ID. When a set is created in FS, FS can generate a default sounder.conf. It is similar to ABC or DEF with AS, where AS generates a set ID and creates dummy sounder.conf with the set ID. The file may be sent to a master Origin (MO) when it connects to AS.

In some embodiments, the app obtains the device credentials from FS. The app connects to the devices (using the device SSID/PW and credentials), provides them the home router SSID and PW for them to connect to the home router as clients. The app can select one device to be MO, e.g. D10. The app may connect to the device to: assign its role to MO, give MO the FS URL, and give MO credentials of other devices in MO network. MO may need credentials to connect to other devices. In some embodiments, the app connects to MO through home LAN.

In some embodiments, using its credential, MO connects to FS to receive: the sounder.conf file with the generated set ID (a.k.a. MO device ID); and sensing server (SS) MQTT credential and URL. A set ID generated by FS may allow changing/replacing MO device without losing sensing settings.

MO can connect to SS using the set ID and MQTT credential. The app may select devices for groups as follows {{D10, D11, D12}; {D20, D21, D22}; {D30, D31}; {D40, D41}}based on room setting. In some embodiments, the grouping can also apply to whole home setting, which includes a single group as shown in FIG. 7.

In some embodiments, the app sends to MO through SS the List-3 in groups, ex {MO ID, {D10, D11, D12}; {D20, D21, D22}; {D30, D31}; {D40, D41}}. For the scenario shown in FIG. 6, cloud and user do not know which one is Satellite or Origins in each group. They only know if these devices belong to which group. For the scenario shown in FIG. 7, the Satellite is in a specific location (e.g. middle of the house) to ensure motion localization performance. So the API should allow app to specify Satellite as well. Specifying Satellite devices could be an option.

In some embodiments, List-3 API will be modified to accommodate grouping. In some embodiments, format is in array and can be updated.

If Satellite is not specified, MO can compare the multicast list. The most recent multicast may be taken as the Satellite for that group. The other ones are the Origins in the group regardless if it is on or not. In this way, there is a device providing sounding.

MO may then build a sounder.conf and save it to FS. The system can modify FS or create an AS for this development. If an MO device is changed, the new MO device can go to FS to get the sounder.conf to restore the services. MO can return to SS the MO network. As such, the app can start the service.

In some embodiments, when receiving a start service command, MO already knows a device in MO network should be Satellite or Origin based on the onboarding. A Satellite can be chosen by MO or by user/app specification. Other devices are Origins.

For a device to be Origin, MO uses the device credential to connect to the Origin. MO provides the Origin the following: the ID and credential of the Satellite associated with the Origin; MO address for Origin to send basic engine output back; and the basic engine types for Origin to run. Origin will use the Satellite credential to connect to the Satellite.

Origin can look up in its multicast table to find the Satellite and its MAC address. Origin may use the Satellite credential to connect to the Satellite. Origin then sends the Satellite the start sounding command.

In some embodiments, Satellite starts the sounding signal if it has not started yet. After that, Origin runs the basic engines that MO requested. Origins send back to MO the basic engine outputs. MO runs fusion engine. MO then sends the fusion engine output to SS.

In some embodiments, when a user stops a service, the app sends MO the stop command. MO sends Origin a stop engine command. Origin stops its associated basic engines. If Origin has no other basic engine to run, Origin then sends the Satellite the stop sounding command.

For example, home security and sleep monitoring are running. Therefore, Origin needs to run motion and breathing. Then a user stops sleep monitoring. MO sends Origin stop breathing engine command. Because Origin still runs motion engine, Origin should not stop Satellite from sounding. In some embodiments, Satellite stops sounding if no other Origins need its sounding signal.

In some embodiments, during operation, MO may be offline or powered down. When resumed online, MO connects to FS to get: Sounder.conf file; SS MQTT credential and URL. MO may then connect to SS to receive service restoration information. If the service was running before MO was offline, MO starts the service. If the service was not running, MO waits to receive start service command.

In some embodiments, during operation, the user may add a device to the sensing network (assuming the device is not MO). Before proceeding adding/removing devices, the app should stop engines on MO. Adding a device is similar to onboarding a device. The device first needs to be provisioned to FS. As a neutral device, the device is in softAP mode with known SSID/PW. Before proceeding, app stops engines on MO. App scans QR codes and registers the device to FS under a user account. App obtains the device credential from FS. App connects to the device (using the device SSID/PW and credential), provides it the home router SSID and PW for it to connect to the home router as a client. App sends MO the new List-3 that includes the new device. MO then builds a sounder.conf and saves it to FS. MO returns to SS the MO network. App then can restart the service.

In some embodiments, during operation, the user may remove a device from the sensing network (assuming the device is not MO). Before proceeding adding/removing devices, app should stop the engines on MO. App stops the engines. App sends MO the new List-3 that excludes the removed device. MO then builds a sounder.conf and saves it to FS. MO returns to SS the MO network. App then can restart the service. After removal, the removed device is still in client mode to home router. Factory reset will neutralize the device. After factory reset, the device is in softAP mode with known SSID/PW, waiting to be configured to connect to home router.

In some embodiments, during operation, the user may replace MO. MO device may not be functional, or user wants to assign another device as MO. App attempts to stop engines on MO. If successful, MO then stops all engines on Origins, and Origins stop Satellite from sending sounding signal. App can deregister MO from user account in FS. Then MO is no longer able to connect to FS unless it gets registered again. FS revolts MQTT credential that MO uses. MO is no longer able to connect to SS. App selects another device to be MO. If the new MO is a neutral device, app connects to the device and makes it connect to home router.

App then connects to the device to: assign its role to MO; give MO the FS URL; and give MO credentials of other devices in MO network. MO may need credentials to connect to other devices. App connects to MO through home LAN. Using its credential, MO connects to FS to receive: the sounder.conf file with the existing set ID (a.k.a MO device ID); and SS MQTT credential and URL. A set ID generated by FS allows changing/replacing MO device without losing sensing settings. MO connects to SS using the set ID and MQTT credential. MO receives restoration information from SS to resume the service. The old MO can be neutralized through factory reset.

In some embodiments, any device (MO, Origin, or Satellite) can be neutralized through factory reset. When neutralized, the device is in softAP mode with known SSID/PW, waiting to be configured to connect to home router.

In some embodiments, any device in the WiFi sensing network can be Satellite. A Satellite device can be chosen by MO or by user/app/cloud. MO can select a device to be Satellite by comparing the multicast list. MO takes the most recent multicast in a group as the Satellite for that group. Satellite keeps track of the start request from Origins. When an Origin requests sounding, if it is not in Satellite list, Satellite will add the Origin into its list. If an Origin is already in Satellite list requests sounding again, Satellite does not add the Origin into the list. In other words, Satellite list does not include duplicated Origins.

Periodically, Origin can tell Satellite to keep sending sounding signal if the Origin still runs its basic engines. If Satellite does not receive the keep going from an Origin, Satellite will remove the Origin from its list. This is to prevent Satellite from keeping sounding when engine is already stopped but Origin could not have a change to stop Satellite from sounding. An example is when an Origin is dead.

When an Origin stops all of its basic engines, the Origin will send the stop sounding to the Satellite. Satellite then removes the Origin from its list. When the list is empty, Satellite will stop sending out sounding signal. In some embodiments, Satellite does not maintain the list of Origins in persistent storage. When power-cycled, the list of Origin is empty, and thus Satellite does not send out sounding signal. If an Origin is running on the CSI from the Satellite, no CSI is received. Origin then sends the Satellite the request for start sounding. When Satellite is powered on and receives the start sounding, it resumes sending out the sounding signal.

In some embodiments, Origin is a device selected by MO. It is to provide basic engine data to MO to run fusion engines. MO can run multiple fusion engines.

MO should keep track which engine an Origin should run and tell the Origin to stop when no fusion engine requests the basic engine data. For example, soft security and ADL are running, where both requires basic motion engine. When stop Soft Security, MO should not send stop motion engine command to Origin because the ADL fusion engine still needs motion data from the Origin. In some embodiments, Origin does not keep track of the number of fusion engine consuming its output as in Linux system.

Periodically, MO sends Origin the start command for the needed basic engine. If Origin does not receive the start command from MO for a basic engine, Origin will stop the basic engine and thus possibly stops Satellite from sending sounding signal. This is to prevent Origin from running basic engines and Satellite from sending sounding signal forever when MO is dead.

In some embodiments, sample code for wireless sensing may include codes to: announce engine capabilities; provide connection among different devices in the sensing network; act in different roles (MO, Satellite, Origin) when assigned; provide connection to cloud; generate sounding signal and capture and parse CSI; send and receive control, command, and sensing data/detection; run engines in library, etc. In some embodiments, the library for wireless sensing may include core algorithms in basic engines and fusion engines, and produce sensing data and detection.

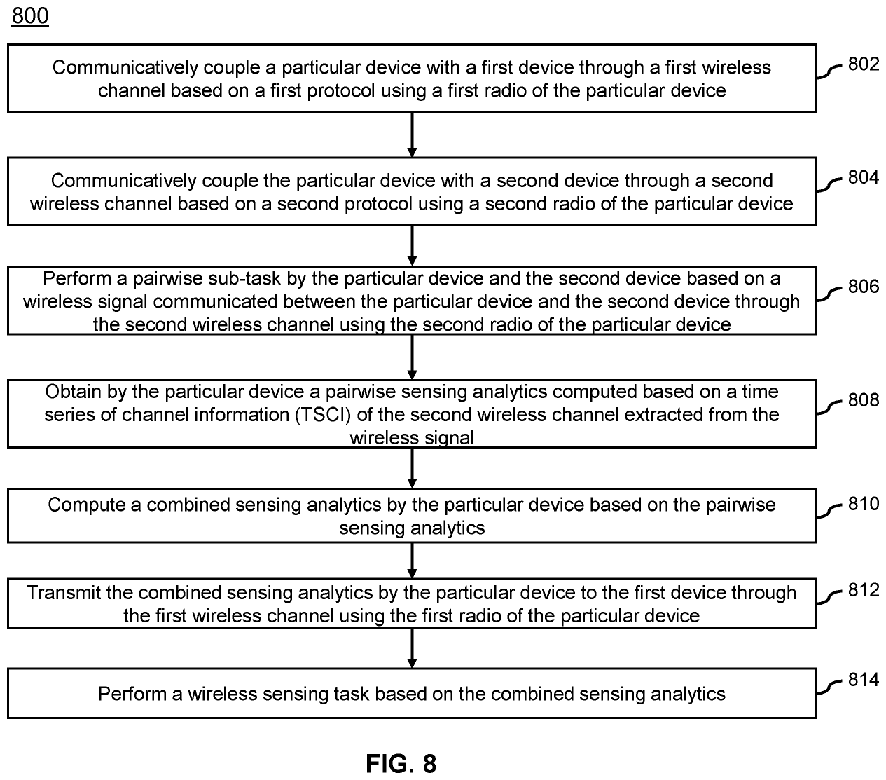

FIG. 8 illustrates a flow chart of an exemplary method 800 for performing wireless sensing in a venue with multiple groups of devices, according to some embodiments of the present disclosure. In various embodiments, the method 800 can be performed by the systems disclosed above. At operation 802, a particular device is communicatively coupled with a first device through a first wireless channel based on a first protocol using a first radio of the particular device. At operation 804, the particular device is communicatively coupled with a second device through a second wireless channel based on a second protocol using a second radio of the particular device. In some embodiments, the first device, the second device, and the particular device are in a same wireless sensing system in a venue.

At operation 806, a pairwise sub-task is performed by the particular device and the second device based on a wireless signal communicated between the particular device and the second device through the second wireless channel using the second radio of the particular device. At operation 808, the particular device obtains a pairwise sensing analytics computed based on a time series of channel information (TSCI) of the second wireless channel extracted from the wireless signal. Each channel information (CI) may comprise at least one of: channel state information (CSI), channel impulse response (CIR) or channel frequency response (CFR). At operation 810, a combined sensing analytics is computed by the particular device based on the pairwise sensing analytics. At operation 812, the combined sensing analytics is transmitted by the particular device to the first device through the first wireless channel using the first radio of the particular device. At operation 814, a wireless sensing task is performed based on the combined sensing analytics. The order of the operations in FIG. 8 may be changed according to various embodiments of the present teaching.

The following numbered clauses provide examples for wireless sensing with multiple groups of wireless devices.

Clause 1. A method/device/system/software of a wireless sensing system, comprising: performing a wireless sensing task by a set of heterogeneous wireless devices in a venue, wherein a second particular heterogeneous wireless device comprises a first radio and a second radio; coupling communicatively the second particular device with a first heterogeneous wireless device of the set through a first wireless channel based on a first protocol using the first radio of the second particular device; coupling communicatively the second particular device with a second heterogeneous wireless device of the set through a second wireless channel based on a second protocol using the second radio of the second particular device; performing a pairwise sub-task of the wireless sensing task by the second particular device and the second device based on a wireless signal communicated between the second particular device and the second device through the second channel using the second radio of the second particular device; obtaining by the second particular device a pairwise sensing analytics computed based on a time series of channel information (TSCI) of the second wireless channel extracted from the received wireless signal, wherein each channel information (CI) comprises at least one of: channel state information (CSI), channel impulse response (CIR) or channel frequency response (CFR); computing a second combined sensing analytics by the second particular device based on the pairwise sensing analytics; transmitting the second combined sensing analytics by the second particular device to the first device through the first wireless channel using the first radio of the second particular device; performing the wireless sensing task based on the second combined sensing analytics.

In some embodiments, first radio and second radio may be same/different. First protocol and second protocol may be same/different. They may have same/different carrier frequency (e.g. 2.4 GHz/5 GHz/6 GHz/28 GHz/60 GHz), frequency channel/band (e.g. band 7 Vs band 23), bandwidth (e.g. 20/40/80/160/320 MHz), protocol (e.g. WiFi, IEEE 802.11n/ac/ax/ay/az/be/bf, 802.15.3/4UWB, Bluetooth, BLE, Zigbee, WiMax, 4G/LTE/5G/6G/7G/8G), protocol settings/parameters, modulation (ASK, PSK, QAM 16/64/256/1024/4096), signaling, etc.

Clause 2. The method/device/system/software of the wireless sensing system of clause 1, comprising: wherein one of the first radio, the first wireless channel, and the first protocol differs from a corresponding one of the second radio, the second wireless channel, and the second protocol in at least one of: carrier frequencies, frequency channel, frequency band, bandwidths, modulation, beamforming, standard protocol, protocol setting, or signaling scheme.

In some embodiments, carrier frequency of one may be higher than the other one, even if they both have the same protocol (e.g. both are WiFi with one being 2.4 GHz and the other 5 GHz, or 2.4 GHz/6 GHz, or 5 GHz/6 GHz; e.g. the second particular device may have dual-band, tri-band or quad-band WiFi). First radio may be 2.4 GHz WiFi. Second radio may be 5 GHz or 6 MHz WiFi. Bandwidth of second radio (e.g. 20/40/80/160/320 MHz) may/may not be higher than bandwidth of first radio (e.g. 20 MHz).

Clause 3. The method/device/system/software of the wireless sensing system of clause 2, comprising: wherein a carrier frequency of the second radio is higher than that the first radio.

Clause 4. The method/device/system/software of the wireless sensing system of clause 3, comprising: wherein a carrier frequency of the second radio is higher than 5 GHz; wherein a carrier frequency of the first radio is less than 4 GHz.

In some embodiments, the set of devices may form a network of networks. The network of networks may have two tiers. Some device may be in a Tier-1 network, a top-level network (e.g. both second particular device and first device are in Tier-1 network). Some may be in a Tier-2 network, a level lower than top level (e.g. second particular device and second device are in a Tier-2 network). A device may be in both the Tier-1 network and the Tier-2 network (e.g. second particular device). (A device may be in more than one Tier-2 networks.) Each network (Tier-1 or Tier-2, or Tier-K) may be used to perform wireless sensing (e.g. all or some devices in the current network may collaborate as a group to do pairwise (wireless sensing) subtask; each pair of devices may transmit/receive wireless signal between themselves; TSCI may be obtained from each received wireless signal; pairwise analytics may be computed based on each TSCI; pairwise analytics may be sent to a selected device (in current network) that perform fusion to compute a combined analytics based on all pairwise analytics and any combined analytics received from lower level networks linked to the current network; combined analytics may be sent to upper level network linked to current network). Each Tier-2 network may form a local wireless sensing subsystem. The Tier-1 network may form a main wireless sensing system.

A Tier-2 network may be linked/connected to a Tier-1 network by having one or more devices in the Tier-2 network to function as gateway devices between the two networks. Each gateway device (e.g. the second particular device) may have at least two radios and may use them both to connect/associate with the two networks (e.g. the second particular device may uses first radio to join the Tier-1 network and second radio to join the Tier-2 network). More than one Tier-2 networks may be linked/connected to the same Tier-1 network. The Tier-1 network (e.g. its AP) may have access to internet, some external network or some cloud server. The Tier-2 networks may access the internet, the external network or the cloud server via the Tier-1 network (and the corresponding gateway devices). A network-of-networks may have more than 2 tiers. A (or more than one) Tier-K network may be linked/connected to a Tier-(K−1) network (e.g. recursively) and may be communicatively coupled with upper level networks (i.e. Tier-(K−2) network, Tier-(K−3) networks, . . . , Tier-2 networks, Tier-1 network), internet, the external network and the cloud server via the Tier-(K−1) network. Recursively, a Tier-(K−1) network may link/connect one or more Tier-K networks. A Tier-(K−1) network may be associated with a zone/region/area (e.g. Tier-1 network may be associated with the whole venue), for any K>1. Each Tier-K network may be associated with a sub-zone/sub-region/sub-area (e.g. Tier-2 networks may be associated with living room, dining room, family room, kitchen, entrance, exit, garage, basement, bedroom1, bedroom 2, first floor, second floor, or some combination/grouping) of the zone/region/area associated with the Tier-(K−1) network. Two sub-zones/sub-regions/sub-areas may/may not overlap. The zone/region/area may comprise a union of more than sub-zones/sub-regions/sub-areas. A portion of the zone/region/area may not belong to any sub-zone/sub-region/sub-area.

For example, Tier-1 may be associated with the whole venue which may be a 2-floor house. A first Tier-2 network may be associated with the whole first floor (a first sub-zone of venue) and a second Tier-2 network may be associated with the whole second floor (a second sub-zone of venue). A first Tier-3 network, under the first Tier-2 network, may be associated with the kitchen (a first sub-sub-zone of first sub-zone) in first floor. A second Tier-3 network, under the first Tier-2 network, may be associated with the living room (a second sub-sub-zone of first sub-zone) in first floor. A third Tier-3 network (under first Tier-2 network) may be associated with the dining room (a third sub-sub-zone of first sub-zone) in the first floor. A fourth Tier-3 network (under second Tier-2 network) may be associated with a first bedroom (a first sub-sub-zone of second sub-zone) in the second floor. A fifth Tier-3 network (under second Tier-2 network) may be associated with a second bedroom (a second sub-sub-zone of second sub-zone) in the second floor. The entrance/foyer area of first floor may be a portion of first sub-zone that is not in any sub-sub-zone of first sub-zone.

Devices in a Tier-K network (called “Tier-K devices”) may be used in pairs to perform pairwise wireless sensing in the associated sub-zone/sub-region/sub-area, and corresponding TSCI in Tier-K (called “Tier-K TSCI”) may be obtained. Pairwise sensing analytics for Tier-K (called “Tier-K pairwise analytics”) may be computed based on the corresponding Tier-K TSCI. A Tier-K combined analytics may be computed based on the Tier-K pairwise analytics, the Tier-K TSCI and any Tier-(K+1) combined analytics obtained from any Tier-(K+1) networks linked/connected to the Tier-K network. The Tier-K combined analytics may be transmitted to the linked/connected Tier-(K−1) network via respective gateway device(s) between the Tier-K and the Tier-(K−1) networks. And this may be recursively performed for all K. In some examples, two or more devices in kitchen network (Tier-3 network, first sub-sub-zone of first sub-zone) in first floor (first sub-zone) may be used to perform pairwise wireless sensing to generate Tier-3 TSCI in the kitchen. Two or more devices in living-room network (Tier-3 network, second sub-sub-zone of first sub-zone) in first floor may be used to perform pairwise wireless sensing in the living room to generate Tier-3 TSCI in living room. Two or more devices in dining-room network (Tier-3 network, third sub-sub-zone of first sub-zone) in first floor may be used to perform pairwise wireless sensing in the dining room to generate Tier-3 TSCI in living room.

For each of the three sub-sub-zones of first sub-zone (say, the kitchen area), one or more Tier-3 pairwise analytics of/for/corresponding to the sub-sub-zone (e.g. kitchen) may be computed based on respective Tier-3 TSCI of the sub-sub-zone (e.g. kitchen or kitchen network). A Tier-3 combined analytics for the sub-sub-zone (e.g. kitchen) may be computed based on all the Tier-3 pairwise analytics and Tier-3 TSCI of the sub-sub-zone (e.g. kitchen area) (e.g. by a respective fusion algorithm). The three Tier-3 combined analytics of the three sub-sub-zones of the first sub-zone may be transmitted from the respective Tier-3 network (kitchen network, living-room network or dining-room network) to a first-floor network (Tier-2 network, first sub-zone) via the respective gateway device. In the first sub-zone (first floor), two or more devices in first-floor network (e.g. in entrance/foyer area, kitchen area, living room area, dining room area of first floor) may be used to perform pairwise wireless sensing to generate Tier-2 TSCI in the first floor. One or more Tier-2 pairwise analytics of the first floor may be computed based on respective Tier-2 TSCI of the first floor. A Tier-2 combined analytics for the first floor may be computed based on all the Tier-2 pairwise analytics and Tier-2 TSCI of the first floor and all the Tier-3 combined analytics from the three Tier-3 networks (e.g. by some respective fusion algorithm).

Different Tier-K network may have different radio, wireless channels, or protocols. E.g. One Tier-K network may be a 5 GHz WiFi network; a second Tier-K may be a 6 GHz WiFi. For example, a first Tier-2 network may be a first WiFi (e.g. 5 GHz), a secondTier-2 network may be a second WiFi (e.g. 6 Hz), a third Tier-2 network may be UWB, a fourth Tier-2 network may be Bluetooth, a fifth Tier-2 network may use millimeter wave (mmWave, e.g. 28 GHz, 60 GHz, 70+GHz). The first WiFi may use 11az for sensing while second WiFi may use 11bf for sensing. The first/second WiFi may have same/different carrier frequency, frequency channel/band, bandwidth, protocol, etc.

Tier-K network may have one or more access point (AP). The second particular device and/or second device may be AP. The wireless signal may be communicated in a trigger-based (TB) manner or non-TB manner. In TB sensing, a train (time series) of sounding signals (e.g. null-data-packet (NDP) may be sent from a first Tier-K device (e.g. AP, non-AP, and/or Type1 heterogeneous wireless device) to other Tier-K device(s) (e.g. non-AP, or another AP in mesh network) in the Tier-K network using uni-cast, multi-cast, and/or broadcast. A non-AP (or another AP) Tier-K device may transmit or receive a sounding signal in response to a trigger signal from a Tier-K AP device (e.g. transmit in response to a trigger frame (TF) in TF sounding, or receive in response to a NDP announcement frame (NDPA) in NDPA sounding). In peer-to-peer sounding, a non-AP Tier-K device may transmit a sounding signal to another non-AP Tier-K device. In non-TB sensing, a train of sounding signals (e.g. NDP) may be sent from a Tier-K AP device to a Tier-K non-AP (or another Tier-K AP) device, each sounding signal accompanied by another sounding signal sent in reverse direction, i.e. from non-AP to AP. In some embodiments, the first radio/wireless channel/protocol may be for Tier-(K−1) network (called “first wireless network”), for any K>1, such as 2, 3, 4, . . . The second radio/wireless channel/protocol may be for Tier-K network (called “second wireless network”).

Clause 5. The method/device/system/software of the wireless sensing system of clause 1, comprising: performing the wireless sensing task by a first subset of the set of heterogeneous wireless devices using a first wireless network in the venue, wherein the first subset comprises the second particular device and the first device; performing the wireless sensing task by a second subset of the set of heterogeneous wireless devices using a second wireless network in the venue, wherein the second subset comprises the second particular device and the second device; wherein the first radio, the first wireless channel, and the first protocol are associated with the first wireless network; wherein the second radio, the second wireless channel, and the second protocol are associated with the second wireless network; wherein one of the first protocol or the second protocol comprises at least one of: a WiFi standard, a UWB standard, a WiMax standard, an IEEE standard, an IEEE 802 standard, an IEEE 802.11 standard, an IEEE 802.11bf standard, an 802.15 standard, an 802.15.4 standard, and an 802.16 standard.

Clause 6. The method/device/system/software of the wireless sensing system of clause 5, comprising: wherein the second particular device and first device are authenticated and associated in the first wireless network; wherein the second particular device and second device are authenticated and associated in the second wireless network.

In Case 1: wireless signal received by second particular device. Pairwise analytics computed by second particular device. In Case 1a: Non-TB sensing (TB=“trigger based”). No trigger signal may be needed.

Clause 7. The method/device/system/software of the wireless sensing system of clause 5, comprising: transmitting the wireless signal from the second device to the second particular device based on the second protocol; extracting the TSCI from the received wireless signal by the second particular device; computing the pairwise sensing analytics based on the TSCI by the second particular device.

In Case 1: Trigger based sensing. AP may sent trigger signal to non-AP before sounding signal (e.g. NDP) being received by non-AP (e.g. triggered by NDPA), or transmitted by non-AP (e.g. triggered by TF). In Case 1b: TB sensing with TF sounding. AP may be second particular device. Trigger signal may be TF. Alternatively, AP may be a third device. Both second particular device and second device may be peer devices. This may be peer-to-peer sensing. Transmission of wireless signal may be triggered.

Clause 8. The method/device/system/software of the wireless sensing system of clause 7, comprising: transmitting the wireless signal based on a trigger signal received by the second device from an access point device (AP) of the second wireless network, based on the second protocol.

Clause 9. The method/device/system/software of the wireless sensing system of clause 8, comprising: wherein the second particular device is the AP of the second wireless network.

In Case 1c: TB sensing with NDPA sounding. AP may be second device. Trigger signal may be NDPA. Alternatively, AP may be a third device. Both second particular device and second device may be peer devices. This may be peer-to-peer sensing. Reception of wireless signal may be triggered.

Clause 10. The method/device/system/software of the wireless sensing system of clause 7, comprising: receiving the wireless signal by the second particular device based on a trigger signal received by the second particular device from an access point device (AP) of the second wireless network, based on the second protocol.

Clause 11. The method/device/system/software of the wireless sensing system of clause 10, comprising: wherein the second device is the AP of the second wireless network.

In Case 2: Wireless signal received by second device. TSCI extracted in second device. Similar to Case 1, this may be non-TB sensing, TB-sensing with NDPA sounding or TB-sensing with TF sounding. In Case 2a: Pairwise analytics computed by second device and reported to second particular device.

Clause 12. The method/device/system/software of the wireless sensing system of clause 5, comprising: transmitting the wireless signal from the second particular device to the second device based on the second protocol; extracting the TSCI from the received wireless signal by the second device; computing the pairwise sensing analytics based on the TSCI by the second device; transmitting the pairwise sensing analytics from the second device to the second particular device.

In Case 2b: TSCI reported to second particular device. Pairwise analytics computed by second particular device.

Clause 13. The method/device/system/software of the wireless sensing system of clause 5, comprising: transmitting the wireless signal from the second particular device to the second device based on the second protocol; extracting the TSCI from the received wireless signal by the second device; transmitting the TSCI from the second device to the second particular device; computing the pairwise sensing analytics based on the TSCI by the second particular device.

In some embodiments, there may be other devices in Tier-K network. Two devices in the Tier-K network may perform a similar pairwise sensing sub-task, by communicating another wireless signal using the Tier-K network/second protocol/second wireless channel, extracting another TSCI from the received another wireless signal, obtaining another pairwise analytics (computed based on the another TSCI) by the second particular device, and computing the combined analytics based on both the pairwise analytics and the another pairwise analytics. Tier-K combined analytics may be computed based further on the TSCI and another TSCI. The Tier-K combined analytics may comprise the pairwise analytics, the another pairwise analytics, the TSCI and/or the another TSCI. The third device may/may not be the second particular device or the second device. The fourth device may/may not be the second particular device or the second device. Combined sensing analytics may be computed in/for the second network based on an aggregation of the pairwise sensing analytics and the second pairwise sensing analytics (and any additional pairwise analytics generated in the second network).

Clause 14. The method/device/system/software of the wireless sensing system of clause 5, comprising: performing a second pairwise sub-task of the wireless sensing task by a third heterogeneous wireless device in the second subset and a fourth heterogeneous wireless device in the second subset based on a second wireless signal transmitted from the third device to the fourth device through the second wireless channel in the second wireless network, wherein the two devices of the set of heterogeneous wireless devices are associated with the second wireless network; obtaining a second TSCI of the second wireless channel by the fourth device based on the received second wireless signal; obtaining by the second particular device a second pairwise sensing analytics computed based on the second TSCI; computing the second combined sensing analytics by the second particular device further based on the second pairwise sensing analytics.

In some embodiments, second pairwise sensing analytics computed by fourth device, then sent to second particular device (e.g. using the second wireless network/Tier-K network, or using the first wireless network/Tier-(K−1) network).

Clause 15. The method/device/system/software of the wireless sensing system of clause 14, comprising: computing the second pairwise sensing analytics by the fourth device based on the second TSCI; transmitting the second pairwise sensing analytics by the fourth device to the second particular device.

In some embodiments, second pairwise sensing analytics computed by second particular device based on second TSCI transmitted from fourth device to second particular device (e.g. using the second wireless network/Tier-K network, or using the first wireless network/Tier-(K−1) network).

Clause 16. The method/device/system/software of the wireless sensing system of clause 14, comprising: transmitting the second TSCI by the fourth device to the second particular device; computing the second pairwise sensing analytics by the second particular device based on the second TSCI.

In some embodiments, Tier-K combined sensing analytics may be computed based on combined analytics from Tier-(K+1) network, called “third wireless network”.

Clause 17. The method/device/system/software of the wireless sensing system of clause 14, comprising: obtaining a third combined sensing analytics associated with a third wireless network by the second particular device; computing the second combined sensing analytics by the second particular device further based on the third combined sensing analytics.

Clause 18. The method/device/system/software of the wireless sensing system of clause 17, comprising: performing the wireless sensing task further by a third subset of the set of heterogeneous wireless devices using the third wireless network in the venue; performing a third pairwise sub-task of the wireless sensing task by a fifth heterogeneous wireless device in the third subset and a sixth heterogeneous wireless device in the third subset based on a third wireless signal transmitted from the fifth device to the sixth device through a third wireless channel in the third wireless network, wherein the two devices of the third subset are associated with the third wireless network; obtaining a third TSCI of the third wireless channel by the sixth device based on the received third wireless signal; obtaining by a third particular heterogeneous wireless device in the third subset a third pairwise sensing analytics computed based on the third TSCI; computing the third combined sensing analytics by the third particular device based on the third pairwise sensing analytics; obtaining by the particular device the third combined sensing analytics from the third particular device.

Clause 19. The method/device/system/software of the wireless sensing system of clause 18, comprising: obtaining a fourth combined sensing analytics associated with a fourth wireless network by the particular device; computing the second combined sensing analytics by the particular device further based on the fourth combined sensing analytics.

Clause 20. The method/device/system/software of the wireless sensing system of clause 19, comprising: performing the wireless sensing task further by a fourth subset of the set of heterogeneous wireless devices using the fourth wireless network in the venue; performing a fourth pairwise sub-task of the wireless sensing task by a seventh heterogeneous wireless device in the fourth subset and a eighth heterogeneous wireless device in the fourth subset based on a fourth wireless signal transmitted from the seventh device to the eighth device through a fourth wireless channel in the fourth wireless network, wherein the two devices of the fourth subset are associated with the fourth wireless network; obtaining a fourth TSCI of the fourth wireless channel by the eighth device based on the received fourth wireless signal; obtaining by a fourth particular heterogeneous wireless device in the fourth subset a fourth pairwise sensing analytics computed based on the fourth TSCI; computing the fourth combined sensing analytics by the fourth particular device based on the fourth pairwise sensing analytics; obtaining by the particular device the fourth combined sensing analytics from the fourth particular device.

In some embodiments, there may be another Tier-K network, in parallel to the Tier-K network (second wireless network) described in clause 1/5, doing similar things. It may be associated with Tier-(K−1) network (first wireless network and may perform wireless sensing (sending wireless signals, obtaining TSCI, computing pairwise analytics, then computing combined analytics) and send its combined analytics to first device in Tier-(K−1) network.

Clause 21. The method/device/system/software of the wireless sensing system of clause 20, comprising: performing the wireless sensing task further by a fifth subset of the set of heterogeneous wireless devices using a fifth wireless network in the venue; performing a fifth pairwise sub-task of the wireless sensing task by a ninth heterogeneous wireless device in the fifth subset and a tenth heterogeneous wireless device in the fifth subset based on a fifth wireless signal transmitted from the ninth device to the tenth device through a fifth wireless channel in the fifth wireless network, wherein the two devices in the fifth subset are associated with the fifth wireless network; obtaining a fifth TSCI of the fifth wireless channel by the tenth device based on the received fifth wireless signal; obtaining by a fifth particular heterogeneous wireless device in the fifth subset a fifth pairwise sensing analytics computed based on the fifth TSCI; computing a fifth combined sensing analytics by the fifth particular device based on the fifth pairwise sensing analytics; obtaining the fifth combined sensing analytics by the first device from the fifth particular device; performing the wireless sensing task based on the fifth combined sensing analytics.

In some embodiments, Fifth subset=first subset. Fifth particular device=first device. First device may be in two (or more) networks: the first wireless network (e.g. 2.4 GHz) and the fifth wireless network (e.g. 5 GHz). The fifth wireless network may be for performing sensing measurement (sensing measurement setup, polling, sending wireless sounding signal/trigger signal, reporting raw sensing measurements/TSCI, sensing measurement termination). The first network may be for communicating any of: user/system wireless sensing parameters/setup/control, computed results based on raw measurements, pairwise analytics/combined analytics, etc.

Clause 22. The method/device/system/software of the wireless sensing system of clause 21, comprising: wherein the fifth subset is the first subset; wherein the fifth particular device is the first device.

Clause 23. The method/device/system/software of the wireless sensing system of clause 22, comprising: performing the wireless sensing task by the set of heterogeneous wireless devices using more than one wireless networks in the venue, with at least two of the heterogeneous wireless devices in each of the wireless networks in the venue; configuring the more than one wireless networks to have a multi-tier structure, comprising at least two tiers, wherein the first wireless network is a Tier-1 network comprising at least the second particular device, and the first device, wherein the second wireless network is a Tier-2 network comprising at least the second particular device, the second device, the third device and the fourth device, wherein the second particular device being in both the first and the second networks serves as a gateway device between the two networks such that sensing results can be transmitted from the second particular device via the first wireless network to the first device; configuring the heterogeneous wireless devices in a Tier-K network to report sensing results obtained in the Tier-K network to a heterogeneous wireless device in a Tier-(K−1) network via a gateway device between the two networks, wherein K is an integer greater than one, wherein sensing results comprise at least one of: combined sensing analytics, pairwise sensing analytics and TSCI.

Clause 24. The method/device/system/software of the wireless sensing system of clause 23, comprising: wherein the first wireless network further comprises the third particular device and the fourth particular device; wherein the third wireless network is a Tier-3 network, comprising at least the third particular device, the fifth device, and the sixth device, wherein the third particular device is a gateway device; wherein the fourth wireless network is a Tier-3 network, comprising at least the fourth particular device, the seventh device, and the eighth device, wherein the fourth particular device is a gateway device; wherein sensing results obtained in the third wireless network are transmitted from the third particular device via the first wireless network to the second particular device; wherein sensing results obtained in the fourth wireless network are transmitted from the fourth particular device via the first wireless network to the second particular device.

Clause 25. The method/device/system/software of the wireless sensing system of clause 24, comprising: wherein the first wireless network further comprises the fifth particular device; wherein the fifth wireless network is a Tier-2 network comprising the fifth particular device, the ninth device, and the tenth device, wherein the fifth particular device is a gateway device; wherein sensing results are transmitted from the fifth particular device via the first wireless network to the first device.

Clause 26. The method/device/system/software of the wireless sensing system of clause 25, comprising: associating the first wireless network with a zone of the venue; associating the second wireless network with a first sub-zone of the zone; associating the third wireless network with a first sub-sub-zone of the first sub-zone; associating the fourth wireless network with a second sub-sub-zone of the first sub-zone.

Clause 27. The method/device/system/software of the wireless sensing system of clause 26, comprising: performing the wireless sensing task for the zone based on at least one of: any pairwise sensing analytics associated with the first wireless network; the combined sensing analytics associated with the second wireless network, or a fourth combined sensing analytics associated with a fifth network in the venue; performing the wireless sensing task for the first sub-zone based on at least one of: the combined sensing analytics associated with the second wireless network, any pair-wise sensing analytics associated with the second wireless network, the second combined sensing analytics associated with the third wireless network, or the third combined sensing analytics associated with the fourth wireless network; associating the third wireless network with a first subzone of the zone; performing a wireless sensing subtask associated with the first subzone based on the third wireless network and the another combined sensing analytics, associating the fourth wireless network with a second subzone of the zone.

In some embodiments, the present teaching discloses systems and methods for a display of WLAN sensing motion statistics(MS)/motion information(MI)/analytics/spatial-temporal-information (STI) associated with more than one “regions” or “zones” in a venue.

In some embodiments, the regions or zones may be established and named by a user. For example, the venue may be a room; a zone or region may be “living room”, “dining room”, “kitchen”, “bedroom 1”, “bedroom 2”, . . . , “rest room 1”, “rest room 2”, . . . , “first floor”, “second floor”, “basement”, “garage”, “office 1”, “office 2”, etc. A region may be large, special or important s.t. more than one “sub-regions” of the region may be established and named by the user. For example, a living room may be a large region of a house s.t. the user established/named sub-regions such as “part of living room near kitchen”, “part of living room near front door”, “part of living room near back door”, “part of living room facing the street”, “part of living room near dining room”, “part of living room around the TV”, part of living room around the piano”, etc.

There may be multiple Type1 (Tx) devices and Type2 (Rx) devices in the venue such that TSCI may be obtained for each region/zone and/or sub-region. For each region or sub-region, one or more MS/MI/STI/analytics may be computed, and a magnitude/characteristics of such may be displayed graphically using graphical user-interface (GUI).

In some embodiments, some related MS may be grouped together in the GUI display. Some MS associated with same or neighboring region/sub-region may be grouped together in GUI. Some MS of same kind may be grouped together. For example, some or all breathing statistics (or fall-down statistics, or presence statistics or sleep analytics) may be grouped together.

In some embodiments, some grouped MS may be displayed in a number of ways. They may be displayed in a consecutive/connected/linked/chained manner, forming a line/ring, or spanning/scanning (e.g. zigzag spanning, or raster scanning) of a connected area of the GUI. MS that are grouped together may be displayed in a physically close proximity manner (e.g. forming a cluster).

The MS may be displayed in a number of ways. A MS may be displayed by itself. For example, it may be displayed as a figure/sliding figure/graph/plot/chart/bar/pie/circle/shape/histogram/histogram-like graph/animation. A magnitude of the MS and/or a function of the magnitude may be displayed/represented/coded/encoded as a number/numeral, a x-coordinate/y-coordinate of a figure/graph/plot, a coordinate/height/length (e.g. of a bar or bar chart), an area (e.g. of a circle, rectangle, or shape), a volume (e.g. of a 3D animation), a size (e.g. of a circle, rectangle, bar, shape, graph, figure, chart), an animation, animation characteristics, duration, timing, flashing, pattern, shading, effect, color, and/or light/color intensity. The function of the magnitude may be different for different MS.

Some MS may be displayed together (e.g. overlaid, stacked, staggered, and/or concentric). Each MS may be displayed as a figure and the multiple figures may be overlaid, stacked and/or staggered. Each MS may be displayed as a concentric “ring” (e.g. circular or rectangular) around a center point. The rings may/may not overlap. Two MS may be displayed as a two-dimensional shape (e.g. ellipse/rectangle).

The magnitude of MS may be a magnitude/phase of a complex number, value/absolute value/sign of a real number, a norm of a vector (e.g. L_1/L_2/ . . . , L_k/, . . . , L_infinity norm), a statistics, a mean/variance/correlation/covariance, and/or a thresholding/hard/soft thresholding. The function may be univariate, monotonic increasing, monotonic non-decreasing, piecewise linear, and/or an exponential/logarithmic/polynomial/trigonometric/hyperbola function, and/or a function of another function. The function may be a univariate function (e.g. as described) of a multivariate function (e.g. filtering, transform, moving average, weighted average, median/mean/mode, arithmetic/geometric/hyperbolic mean, maximum/minimum, statistics, ordered statistics, variance, percentile, histogram, probability function, cumulative distribution function, count) of a sliding window of MS. The function may be a multivariate function of univariate function(s) of the sliding window of MS. The function may also be univariate function of multivariate function of univariate function(s) of the sliding window of MS.

Different MS measuring different characteristics of motion may have different functions. For example, a function of breathing MS may be different from a function of fall-down MS. A function of an MS may be determined based on online/offline learning, or training/update using training/past data, and/or analysis of characteristics of motion.

Different MS measuring same characteristics of motion may have different functions. For example, breathing MS may have different functions for different regions/sub-regions. Alternatively, MS for some regions/sub-regions (e.g. some grouped MS) may be same, at least for a period of time. The function of a MS may be adaptively determined based on the MS (e.g. past MS or training MS from training data) and/or associated TSCI.

At least one statistics is wireless-sensing MS computed based on TSCI. Some statistics may be non-wireless-sensing statistics obtained in some ways. The statistics may be presented in some presentation device (e.g. displayed visually on a screen/monitor/smart phone/tablet, generate visual signal/animation using lamp/light bulb/panel, play sound on a speaker, generate vibration/motion/action).

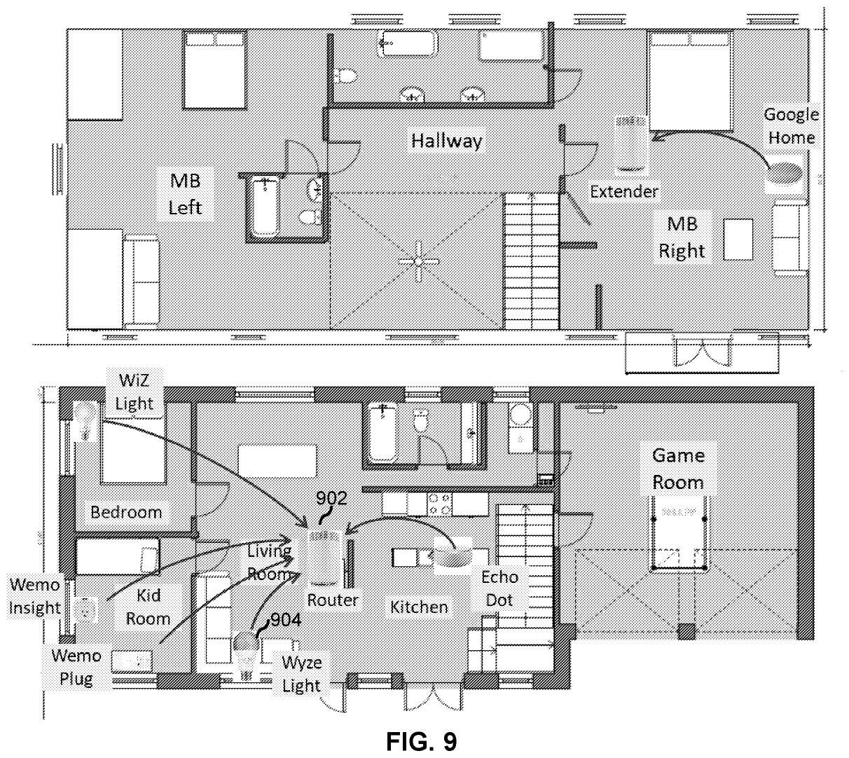

FIG. 9 illustrates an exemplary floor plan for wireless sensing to display sensing motion statistics and analytics, according to some embodiments of the present disclosure. In some embodiments, a location name is assigned to each wireless device, e.g. a router, an extender, etc., based on its location, e.g. bedroom, living room, kitchen, etc. Then, devices with a same location name can be grouped together. For example, a router 902 and a Wyze light 904 in FIG. 9 may be grouped together because they have the same location name: Living Room.

In some embodiments, the grouping can enable a system to have multiple IoT devices in the same room to cover big rooms. There may be overlapping sensing zones. In some embodiments, the system may use the wireless sensing and detection to gate a display of motion statistics, e.g. in form of live-view bubbles in a graphical user interface. The system may display sensing motion statistics and analytics that are not the same as the original output of the detection. For example, the system can apply an exponential curve to amplify detections with strong motion statistics and subpress detections with weak motion statistics.

The following numbered clauses provide examples for a wireless sensing presentation system.

Clause B1. A method/device/system/software of a wireless sensing presentation system, comprising: obtaining a plurality of time series of channel information (TSCI) of respective wireless multipath channels in a venue, wherein each TSCI is obtained based on a respective wireless signal transmitted from a respective Type1 heterogeneous wireless device to a respective Type2 heterogeneous wireless device through a respective wireless multipath channel in the venue, wherein the wireless multipath channels are impacted by a motion of an object in the venue; computing a plurality of time series of motion statistics (TSMS) associated with the motion of the object based on a processor, a memory and a set of instructions, each TSMS computed based on at least one respective TSCI; computing a mapping function for each TSMS based on a respective characteristics of the TSMS; processing each TSMS with the respective mapping function; presenting the plurality of processed TSMS on a presentation device of a user.

Clause B2. The method/device/system/software of the wireless sensing presentation system of Clause B1: wherein any mapping function comprises at least one of: a linear function, a piecewise-linear function, a non-linear function, a monotonic function, a piecewise monotonic function, a monotonic increasing function, a monotonic decreasing function, a monotonic non-increasing function, a monotonic non-decreasing function, a piecewise monotonic increasing function, a piecewise monotonic decreasing function, a polynomial function, an exponential function, a logarithmic function, a trigonometric function, a hyperbolic function, a sigmoid function, a thresholding function, an indicator function, an inverse function, a look-up table, a composite function, or a function of function.

The mapping function may be a univariate function of a MS, or a univariate function of a scalar feature/magnitude/phase of the MS. It may be a multivariate function of more than one MS (e.g. a sliding window of the TSMS), or a multivariate function of a scalar feature/magnitude/phase of each of more than one MS. The mapping function may be a combination of univariate or multivariate functions (e.g. composite function or nested function).

Clause B3. The method/device/system/software of the wireless sensing presentation system of Clause B2: wherein each mapping function comprises at least one of: a univariate function, a multivariate function, a composite function comprising a univariate function of a multivariate function, a composite function comprising a multivariate function of univariate functions, a composite function comprising a univariate function of a multivariate function of other univariate functions, a composite function comprising a multivariate function of univariate functions of other multivariate functions, or a vectored function with each vector component being one of the above.

The mapping function may be piecewise concave and piecewise convex.

Clause B4. The method/device/system/software of the wireless sensing presentation system of Clause B3: wherein a mapping function is at least one of: globally concave, globally convex, locally concave, locally convex, piecewise concave, piecewise convex, or partly concave and partly concave.

The mapping function may be applied to MS, feature/magnitude of MS, sliding window of MS, weighted average of the sliding window of MS (e.g. filtering or transformation). TSMS may be filtered or transformed or processed before mapping function is applied. The filtering/transformation/processing may be applied to MS, or feature/magnitude of MS.

Clause B5. The method/device/system/software of the wireless sensing presentation system of Clause B4: applying the respective mapping function to at least one of: a MS of the respective TSMS, a feature or magnitude of the MS, a sliding window of the TSMS, a weighted average of the sliding window of the TSMS, a filtered MS of a filtered TSMS obtained by applying a filter on the TSMS, a feature or magnitude of the filtered MS, a sliding window of the filtered TSMS, a weighted average of the sliding window of the filtered TSMS, another filtered MS of another filtered TSMS obtained by applying a filter on a feature or magnitude of the TSMS, a feature or magnitude of the another filtered MS, a sliding window of the another filtered TSMS, or a weighted average of the sliding window of the another filtered TSMS.

The mapping function for a TSMS may be computed (e.g. using histogram equalization) based on probability density function (pdf) or histogram of MS. The histogram may be the historical histogram based on the TSMS, or the past MS in the TSMS, or a past window in the TSMS, or another TSMS. The another TSMS may be training TSMS obtained using another wireless signal transmitted from another (e.g. same, similar or different) Type1 device to another (e.g. same, similar or different) Type2 device in another (e.g. same, similar or different) venue when the wireless multipath channel of the another venue is impacted by another (e.g. same, similar or different) motion of another (e.g. same, similar or different) object.

Clause B6. The method/device/system/software of the wireless sensing presentation system of Clause B5, further comprising: computing the mapping function for a TSMS based on at least one of: a probability distribution (or histogram) of the MS (or feature/magnitude of the MS) based on the TSMS, a probability distribution (or histogram) of the MS (or its feature/magnitude) based on another TSMS, a modification of a probability distribution, a statistic characteristics of the MS (or its feature/magnitude), a histogram equalization applied to the histogram of the MS (or its feature/magnitude) or a modification of the histogram, an emphasis of a first domain and a de-emphasis of a second domain of the MS (or feature/magnitude), or a selection or preference of the user.

More details of “emphasis of first domain” and “de-emphasis of second domain”.

Clause B7. The method/device/system/software of the wireless sensing presentation system of Clause B6: wherein the first domain is mapped to a first range, and the second domain is mapped to a second range through the mapping function; wherein a first fraction of a first length of the first range over a second length of the first domain is larger than a second fraction of the first length of the second range over the second length of the second domain.

More details of “emphasis of first domain” and “de-emphasis of second domain”.

Clause B8. The method/device/system/software of the wireless sensing presentation system of Clause B7: wherein the emphasis of the first domain causes the first fraction to be greater than a first threshold; wherein the de-emphasis of the second domain causes the second fraction to be smaller than a second threshold.

Clause B9. The method/device/system/software of the wireless sensing presentation system of Clause B8: wherein the first threshold is not less than one.

Clause B10. The method/device/system/software of the wireless sensing presentation system of Clause B8: wherein the second threshold is not greater than one.

More details of “emphasis of first domain” and “de-emphasis of second domain”.

Clause B11. The method/device/system/software of the wireless sensing presentation system of Clause B8: wherein the mapping function has a first local slope in the first domain greater than a second local slope in the second domain.

Clause B12. The method/device/system/software of the wireless sensing presentation system of Clause B11: wherein the mapping function has a local slope greater than one in the first domain and a local slope less than one in the second domain.

Some description of a generalization of histogram equalization. In histogram equalization, the first and second reference function should both be uniform distribution (which has a constant value over its support). The support of first and second pdf should be the same as that of the MS. The support of first and second pdf should be from the minimum support of the MS to the maximum support of MS.

Clause B13. The method/device/system/software of the wireless sensing presentation system of Clause B6: computing a first difference between the probability distribution of the MS (or feature/magnitude of the MS, or the filtered MS, or the another filtered MS) and a first reference function; computing the first domain as the domain where the first difference is positive; computing a second difference between the probability distribution of the MS and a second reference function; computing the second domain as the domain where the second difference is negative.

Clause B14. The method/device/system/software of the wireless sensing presentation system of Clause B13: wherein at least one of the following is true: the first reference function is a constant function, the first reference function is non-negative, the first reference function is a probability distribution, the first reference function is a uniform distribution, the first reference function has the same support as the probability distribution of the MS (or feature/magnitude of the MS), the second reference function is a constant function, the second reference function is non-negative, the second reference function is a probability distribution, the second reference function is a uniform distribution, the second reference function has the same support as the probability distribution of the MS (or feature/magnitude of the MS), or the first reference function and the second reference function are the same.

Grouping of MS. More than one MS may be computed for a region/sub-region, such as presence, motion intensity, speed, breathing, activity, fall-down, sleep, etc. MS of the region/sub-region may be grouped together. MS of different sub-regions of a region may be grouped together. MS of nearby or related regions/sub-region may be grouped together (e.g. all rooms in second floor, or all rooms in first floor, or all toilets, or all bedrooms, or “Peter's activity region”, or “Peter's activity region on weekdays”, or “Peter's activity region on weekends”). Grouping may be based on some criteria or characteristics (e.g. proximity, location, functionality, timing, user behavior, naming). For example, the user may enter a name or classification for each region/sub-region. The grouping may be based on the naming or classification. Or, the grouping may be chosen/selected/performed by the user. There may be more than one way to do the groupings (e.g. a toilet in first floor may be grouped into both “all rooms in first floor”, and “all toilets”).

Clause B15. The method/device/system/software of the wireless sensing presentation system of Clause B1 or Clause B6, further comprising: grouping a number of subsets of the plurality of TSMS into the number of groups based on respective grouping criteria, each subset being grouped into a respective group based on a respective grouping criterion; coordinating a presentation of the number of groups of TSMS on the presentation device of the user.

Clause B16. The method/device/system/software of the wireless sensing presentation system of Clause B15, further comprising: partitioning the venue into more than one regions; associating each region with at least one respective TSMS; grouping at least one TSMS comprising those associated with a particular region into a particular group, wherein the respective grouping criteria is based on at least one of: the association with the particular region, an event or a timing.

Clause B17. The method/device/system/software of the wireless sensing presentation system of Clause B16, further comprising: grouping at least one TSMS comprising those associated with the particular region or another region into another particular group, wherein the respective grouping criteria is based on at least one of: the association with at least one of the particular region or the another region, a distance between the particular region and the another region, a proximity between the particular region and the another region, a relationship between the particular region and the another region, an event, or a timing.

Clause B18. The method/device/system/software of the wireless sensing presentation system of Clause B16, further comprising: partitioning a particular region into more than one sub-regions; associating each sub-region with at least one respective TSMS; grouping at least one TSMS comprising those associated with a particular sub-region into another particular group, wherein the respective grouping criteria is based on at least one of: the association with the particular sub-region, an association with the particular region, an event, or a timing.

Clause B19. The method/device/system/software of the wireless sensing presentation system of Clause B18 or Clause B17, further comprising: grouping at least one TSMS comprising those associated with the particular sub-region or another sub-region into the group, wherein the grouping criteria is based on at least one of: the association with at least one of: the particular sub-region, the another sub-region, the particular region, or another region encompassing the another sub-region, a distance between the particular sub-region and the another sub-region, a proximity between the particular sub-region and the another sub-region, a distance between the particular region and the another region, a proximity between the particular region and the another region, an event, or a timing.

Clause B20. The method/device/system/software of the wireless sensing presentation system of Clause B15, further comprising: coordinating the presentation of the number of groups of TSMS by at least one of the following: presenting a group of TSMS in a spatially neighboring manner, presenting a group of TSMS in a spatial neighborhood, presenting a group of TSMS in a spatially connected manner, presenting a group of TSMS in a chained manner, presenting a group of TSMS in neighboring locations in a matrix arrangement, presenting a group of TSMS in neighboring locations in a lattice arrangement, or presenting a group of TSMS in neighboring locations in a patterned arrangement.

Clause B21. The method/device/system/software of the wireless sensing presentation system of Clause B15, further comprising: coordinating the presentation of the number of groups of TSMS by at least one of the following: presenting a group of TSMS each with a respective set of presentation attributes, presenting a group of TSMS each with a respective coordinated set of presentation attributes, presenting a group of TSMS with a common set of presentation attributes (e.g. color scheme, texture, patterns, intensity, shading, animation, shape size to represent magnitude, animation frequency to represent magnitude, etc.), presenting a group of TSMS with a common presentation attribute, presenting a group of TSMS with a same set of presentation attributes, presenting a group of TSMS with a same presentation attribute, presenting a group of TSMS with a first set of presentation attributes for a first type of TSMS in the group (e.g. breathing statistics) and a second set of presentation attributes for a second type of TSMS in the group (e.g. fall-down statistics), presenting a group of TSMS with a first presentation attribute for a first type of TSMS in the group (e.g. breathing statistics) and a second presentation attribute for a second type of TSMS in the group (e.g. fall-down statistics), presenting a group of TSMS each with a respective mapping function (in Clause B1), presenting a group of TSMS each with a respective coordinated set of mapping function, presenting a group of TSMS with a common mapping function, presenting a group of TSMS with a same mapping function, presenting a group of TSMS with a first mapping function for a first type of TSMS in the group (e.g. breathing statistics) and a second mapping function for a second type of TSMS in the group (e.g. fall-down statistics), or presenting a group of TSMS with a same set of mapping function.

In some embodiments, the present teaching discloses systems and methods for wireless sensing using two-way sensing in which sounding signals are transmitted between two wireless devices in both ways: from a first device to a second device and from the second device to the first device such that sensing measurement results are obtained/generated in both devices. In one-way sensing, sounding signals are transmitted in one way only such that sensing results are generated in one device only. The sensing results may be used locally in the device or optionally reported to another device.

One disadvantage of one-way sensing is that, when sensing results are generated in a first device but is needed in a second device, undesirable reporting frames may be used by the first device to transmit/report the sensing results to the wirelessly second device. The use of reporting frames is undesirable because they tend to be very large/bulky and may take a long time and a lot of data bandwidth to transmit, and a lot of memory to store, especially when there are many antenna pairs between a TX (wireless transmitter) and a RX (wireless transmitter), many TX/RX pairs, many TX/RX pairs, and wide analog BW used to obtain sensing results (e.g. channel information/CI, such as CSI, CIR, CFR, etc.). An advantage of two-way sensing over one-way sensing is that, with sounding signals transmitted both ways, sensing results are generated in both the first device and the second device, and there may be no need to use the undesirable reporting frames to report the sensing results.

Wireless sensing may be performed in a wireless network based on a standard (e.g. IEEE 802.11, 802.11bf, 4G/5G/6G/7G/8G, 802.15, 802.16, UWB, Bluetooth, etc.), a specification and/or a protocol. In the wireless network, there may be one or more access point (AP) station (STA) (e.g. WiFi AP, mesh network AP, 4G/5G/6G/7G base station, cellular base station, repeater, etc.), and there may be one or more non-AP STA. WLAN or WiFi sensing may be performed based on WLAN/WiFi signal (e.g. compliant to IEEE 802.11, 802.11bf standard, WiFi Alliance).

Non-data packet (NDP) may be used as a sounding signal. A Sensing NDP Announcement (NDPA) frame may be defined that allows a STA to indicate the transmission of NDP frame(s) used to obtain sensing measurements. A Trigger frame variant may be defined that allows an AP STA to solicit NDP transmission(s) from STA(s) to obtain sensing measurements.

Non-TB Wireless Sensing. A non-AP STA may be the sensing initiator and an AP STA may be the sensing responder, and together they may perform non-triggered-based (non-TB or NTB) wireless sensing. The non-AP STA may send an NDPA frame to AP followed by two NDPs: an I2R NDP (initiator-to-responder NDP frame, for uplink sounding) from non-AP STA to AP and an R2I NDP (responder-to-initiator NDP frame, for downlink sounding) from AP to non-AP STA. For the I2R NDP, the non-AP STA is the Type1 device (TX) and the AP is the Type2 device (RX). For the R2I NDP, the AP is the Type1 device (TX) and the non-AP STA is the Type2 device (RX).

One-way non-TB sensing may be performed in which only one of the two NDPs may be used for generating sensing measurement results (e.g. CI, CSI, CIR, CFR, etc.) while the other NDP may not. For example, I2R NDP may be used for uplink sounding to generate sensing measurement results at the AP while the R2I NDP may not lead to sensing measurement results at the non-AP STA. The sensing responder (AP) may optionally report the sensing results to sensing initiator (non-AP STA). When the sensing results are generated, the MAC layer management entity (MLME) of AP may send a first signal/message/primitive to the Station management entity (SME) of AP to indicate the availability of the sensing measurement results. The AP may optionally use sensing measurement report frame to report the sensing results to the non-AP STA (initiator). To do so, the SME may send a second signal/message/primitive to the MLME to request the transmission of the sensing measurement report frame.

In another example, R2I NDP may be used for downlink sounding to generate sensing results at the non-AP STA (initiator). No sensing measurement report frame may be needed because the initiator already has the results. When the sensing results are generated, the MLME of non-AP STA may send the first signal/message/primitive to the SME of non-AP STA to indicate the availability of the sensing measurement results. The SME may not send the second signal/message/primitive to the MLME to request the transmission of the sensing measurement report frame.

Two-way non-TB sensing may be performed in which both NDP are used for generating sensing results on both side (i.e. at sensing initiator and also at sensing responder).

For example, the I2R NDP may be transmitted from non-AP STA to the AP to generate sensing results at AP (responder) while the R2I NDP may be transmitted from AP to non-AP STA to generate sensing results at non-AP STA (initiator). No sensing measurement report frame may be needed/used by sensing responder to report any sensing results to sensing initiator, as both AP and non-AP already have a version of the sensing measurement results.

Upon the generation of a first (AP-side) sensing results at AP, the MLME of AP may send the first signal/message/primitive to the SME of AP to indicate the availability of the first sensing results. And upon the generation of a second (non-AP side) sensing results at non-AP STA, the MLME of non-AP STA may send the first signal/message/primitive to the SME of non-AP STA to indicate the availability of the second sensing measurement results. As no sensing measurement report frames may be used, none of the SME (SME of AP and SME of non-AT STA) may send the second signal/message/primitive to the respective MLME to request the transmission of sensing measurement report frames.

In an alternative example, the AP (responder) may optionally report its sensing results to the non-AP STA (initiator) using sensing measurement report frames. If so, the SME of AP may send the second signal/message/primitive to MLME of AP to request the transmission of sensing measurement report frames to the non-AP STA (initiator).

TB Wireless Sensing. An AP STA may be the sensing initiator and a number (one or more) of STA(s) (e.g. other AP STA or non-AP STA) may be the sensing responders. They may jointly perform trigger-based (TB) sensing. There may be a polling phase in which the AP transmits a polling frame to check the availability of the number of STA(s) for TB sensing. If a STA is available, it may respond with a CTS-to-self. After the polling phase, there may be a one-way downlink sounding phase (e.g. NDPA sound phase), a one-way uplink sounding phase (e.g. trigger frame sounding phase), or a two-way uplink-downlink sounding phase.

One-way TB sensing. In the one-way downlink sounding phase, for each STA that is available, the AP may send an NDPA frame followed by an NDP frame as downlink sounding signal to the STA to generate sensing measurement results at the STA. A separate NDPA frame may be sent to each available STA, or a common/shared NDPA frame may be sent to multiple (e.g. some or all) available STA(s). Each STA (responder) may optionally use sensing measurement report frame to report its sensing results to the AP (initiator). When the sensing results are available at an STA, the MLME of the STA may send the first signal/message/primitive to the SME of the STA. If sensing results of the STA is optionally reported to the AP, the SME may send the second signal/message/primitive to the MLME of the STA to request the transmission of sensing measurement report frame to the AP (initiator).

In the one-way uplink sounding phase, for each STA that is available, the AP (initiator) may send a Trigger frame (TF) to the STA (responder), followed by the STA sending an NDP as uplink sounding signal to the AP to generate sensing measurement results at the AP (initiator). A separate Trigger frame may be sent to each available STA, or a common/shared Trigger frame may be sent to multiple (e.g. some or all) available STA(s). When sensing results are available at a STA, the MLME of the STA may send the first signal/message/primitive to the SME of the STA to indicate availability of the sensing results. No sensing measurement report frame may needed/used to transmit sensing results to the initiator, because the sensing results are already generated at the initiator. As such, the SME of the STA may not send the second signal/message/primitive to request transmission of sensing measurement report frame.

Two-way TB sensing. In the two-way uplink-downlink sounding phase, for each STA that is available, the AP may send a special “NDPA-Trigger” frame to the STA followed by two NDPs: an I2R NDP (initiator-to-responder NDP frame) transmitted from AP to the STA as downlink sounding signal to generate sensing results at the STA, and an R2I NDP (responder-to-initiator NDP frame) transmitted from the STA to AP as uplink sounding signal to generate sensing results at AP. The I2R NDP may precede the R2I NDP, or the R2I NDP may precede the I2R NDP. The special NDPA-Trigger frame may be the NDPA frame, the Trigger frame or another frame. A separate NDPA-Trigger frame may be sent to each available STA, or a common/shared NDPA-Trigger frame may be sent to multiple (e.g. some or all) available STA(s). No sensing measurement report frame may be needed/used by sensing responder to report any sensing results to sensing initiator, as both AP and STA already have a version of the sensing measurement results.

Upon the generation of a first (AP-side) sensing results at AP, the MLME of AP may send the first signal/message/primitive to the SME of AP to indicate the availability of the first sensing results. And upon the generation of a second (non-AP side) sensing results at the STA, the MLME of the STA may send the first signal/message/primitive to the SME of the STA to indicate the availability of the second sensing measurement results. As no sensing measurement report frames may be used, none of the SME (SME of AP and SME of non-AT STA) may send the second signal/message/primitive to the respective MLME to request the transmission of sensing measurement report frames to the initiator.

In an alternative two-way uplink-downlink sounding phase, the STA (responder) may optionally report its sensing results to AP (initiator) using sensing measurement report frames. If so, the SME of the STA may send the second signal/message/primitive to MLME of STA to request the transmission of sensing measurement report frames to the AP (initiator).

Peer-to-peer Wireless Sensing (P2P sensing). In peer-to-peer wireless sensing, one or more pairs of non-AP STA may be determined in a wireless network associated with an AP. With each pair, NDP(s) may be transmitted between a first non-AP STA and a second non-AP STA as sounding signal(s) to generate sensing results in non-AP STA(s). The NDP(s) transmission may/may not be transmitted with a help/signaling/trigger from an associated AP.

One-way P2P sensing. In one example of one-way P2P sensing, the AP may be the sensing initiator and both the first and second non-AP STA may be sensing responders. In another example, a non-AP STA may be a sensing-by-proxy (SBP) initiator that requests the AP (SBP responder) to perform one-way P2P sensing in which the AP may be the sensing initiator and both the first and second non-AP STAs may be sensing responders.

In both examples, the AP may configure/negotiate/arrange individually with the two non-AP STAs such that the two non-AP STAs can identify each other (each with at least one corresponding ID, e.g. identifiable network address, identifiable wireless network address/ID, AP assigned ID, initiator assigned ID, user defined ID, MAC address) and the first non-AP STA would send NDP as sounding signal to the second non-AP STA so that sensing measurement results may be obtained/generated in the second non-AP STA. The AP may send a first P2P-sensing-triggering frame to the pair of non-AP STAs. The first P2P-sensing-triggering frame may be a NDPA frame, a Trigger Frame, the special NDPA-Trigger frame (mentioned above), or another frame. A separate first P2P-sensing-triggering frame may be sent to each pair of non-AP STAs, or a common/shared first P2P-sensing-triggering frame may be sent to multiple (e.g. some or all) available STA(s). The first non-AP STA would then send the NDP to the second non-AP STA to generate sensing measurement results at the second non-AP STA. The sensing measurement results may be used/needed in the second non-AP STA, or the sensing results can optionally be transmitted from the second non-AP STA (sensing responder) to the AP (sensing initiator). In the SBP example, the AP (SBP responder) may further report the sensing results to the SBP initiator.

Two-way P2P sensing. In one example of two-way P2P sensing, the AP may be the sensing initiator and both the first and second non-AP STA may be sensing responders. In another example, a non-AP STA may be a sensing-by-proxy (SBP) initiator that requests the AP (SBP responder) to perform two-way P2P sensing in which the AP may be the sensing initiator and both the first and second non-AP STAs may be sensing responders.

In both examples, the AP may configure/negotiate/arrange individually with the two non-AP STAs such that the two non-AP STAs can identify each other (each with at least one corresponding ID, e.g. identifiable network address, identifiable wireless network address/ID, AP assigned ID, initiator assigned ID, user defined ID, MAC address) and the two non-AP STAs would send NDP as sounding signal to each other so that sensing measurement results may be obtained/generated in both non-AP STA. The AP may send a second P2P-sensing-triggering frame to the pair of non-AP STAs. The second P2P-sensing-triggering frame may be a NDPA frame, a Trigger Frame, the special NDPA-Trigger frame (mentioned above), the first P2P-sensing-triggering frame, or another frame. A separate first P2P-sensing-triggering frame may be sent to each pair of non-AP STAs, or a common/shared first P2P-sensing-triggering frame may be sent to multiple (e.g. some or all) available STA(s). Then the first non-AP STA would send NDP to the second non-AP STA to generate sensing measurement results at the second non-AP STA and the second non-AP STA would send NDP to the first non-AP STA to generate sensing measurement results at the first non-AP STA. The sensing measurement results may be used/needed in the second non-AP STA, or the sensing results can optionally be transmitted from the second non-AP STA (sensing responder) to the AP (sensing initiator). In the SBP example, the AP (SBP responder) may further report the sensing results to the SBP initiator.

In another example, the first and second non-AP STA may perform the one-way P2P sensing or the two-way P2P sensing without signaling from AP. The two non-AP STA may be able to identify each other and configure/negotiate/arrange with each other. In one-way P2P sensing, NDP may be transmitted one-way from a first non-AP STA to a second non-AP STA to generate sensing results in the second non-AP STA. The second non-AP STA may optionally transmit its sensing results to the first non-AP STA. In two-way P2P sensing, NDPs may be transmitted both ways between the two non-AP STA, without signaling from AP.

Generalized Daisy-chain sensing. An AP may, or a non-AP STA may request/cause the AP to, configure/negotiate/arrange/set up a number of STA(s) (e.g. the AP, another AP, or non-AP STAs) to establish a scanning order (e.g. a daisy chain, or a fully-connected configuration) for sensing. For example, the AP may send a daisy-chain sensing polling frame to check availability of the number of STA(s). If a STA is available, it may respond with a response frame accordingly (e.g. with a CTS-to-self). NDP may be transmitted among adjacent STAs in the daisy chain to generate sensing measurement results.

One-way daisy-chain sensing. One-way daisy-chain sensing may be performed by NDP being transmitted in one way (from upstream to downstream along the daisy chain).

The AP may send a first daisy-chain trigger frame (e.g. NDPA frame, NDPA frame variant, Trigger frame, Trigger frame variant, “NDPA-Trigger” frame, first P2P sensing-trigger frame, second P2P sensing-trigger frame, another frame) to the number of STA(s). A first STA may transmit a first NDP to a second STA. The second STA may (a) receive the first NDP and generate first sensing measurement results (e.g. CSI computed based on the received first NDP), and (b) transmit a second NDP (downstream) to a third STA (which may be the first STA or second STA). The second NDP may be transmitted after a first time delay (e.g. SIF) after reception of the first NDP. The third STA may receive the second NDP and generate sensing measurement results, and to transmit a third NDP to a fourth STA (perhaps after a second time delay), and so on. The first, second, third, fourth, . . . STA may form a daisy, each receiving an NDP from “upstream” or previous STA, and transmit another NDP to “downstream” or next STA (perhaps with some time delay). The daisy chain may form a close loop (i.e. the last STA in the daisy chain may be the first STA or another STA in the daisy chain).

For any of the number of STA(s), the sensing measurement results may be used locally by the STA for sensing, or may optionally be reported to the AP. In the case of SBP, the reported sensing results may be reported to the SBP-requesting non-AP STA.

Two-way daisy-chain sensing may be performed by NDP being transmitted in both manners (from upstream to downstream, and also from downstream to upstream along the daisy chain).

The AP may send a second daisy-chain trigger frame (e.g. NDPA frame, NDPA frame variant, Trigger frame, Trigger frame variant, “NDPA-Trigger” frame, first P2P sensing-trigger frame, second P2P sensing-trigger frame, the first daisy-chain trigger frame, another frame) to the number of STA(s). A first STA may transmit a first NDP to a second STA. The second STA may (a) receive the first NDP and generate first sensing measurement results (e.g. CSI computed based on the received first NDP), (b) transmit a second NDP (downstream) to a third STA, and (c) transmit another NDP (upstream) back to the first STA to generate sensing measurement results at the first STA. The second NDP may precede the another NDP, or vice versa. There may be a first time delay (e.g. SIF) after reception of the first NDP before transmission of the second NDP and the another NDP. The third STA may receive the second NDP and generate sensing measurement results, transmit a third NDP to a fourth STA and transmit yet another NDP back to second STA, and so on. The first, second, third, fourth, . . . STA may form a scanning order or a daisy chain, each receiving an NDP from upstream/previous STA, transmit an NDP to downstream/next STA (perhaps with some time delay) and transmit an NDP (upstream) back to upstream/previous STA. The scanning order/daisy chain may form a close loop (i.e. the last STA in the daisy chain may be the STA device or another STA in the daisy chain).

Termination/Pause of a session setup/measurement setup associated with a sensing responder. An AP may determine, or AP may receive a determination from SBP initiator in the case of sensing-by-proxy (SBP), that the sensing measurement results (e.g. CSI, CTR, CFR, RSSI) associated with a particular sensing responder may be useless, not useful, and/or least useful for a task (e.g. too noisy, too unstable, too chaotic, too much interference, unreliable, faulty, or a user “pause” or “stop” the sensing associated with the particular responder, or a user “pause” or “stop” the sensing associated with all sensing responders, etc.). The determination may be based on (i) a test on the sensing measurement results (e.g. based on a test/measure for noise, stability, variability, randomness/chaos, interference, reliability, fault, error and/or mistakes) and/or (ii) a state/condition/test of system (e.g. the sensing measurement results transmission/storage/associated processing/sensing computation may consume too much bandwidth/memory/processing power/time, or generate too much power, or another task of higher priority needs resources currently allocated to the sensing measurement results). There may be a determination that sensing measurement results associated with another sensing responder may be useful, not useless and/or more useful for the task.

As a result, the AP may, or may receive a request from SBP initiator in the case of SBP to, terminate the sensing session setup associated with the particular sensing responder. The AP may, or may receive a request from SBP initiator in the case of SBP to, wait for a period of time (e.g. wait until some interfering/noisy/9unstable/unreliable/adverse condition is finished, or wait until a user “un-pause” or “un-stop” the sensing) and then start another sensing session (by performing sensing session setup) with the particular sensing responder, using identical or similar or modified sensing session setup settings as the terminated sensing session setup. The determination of the period time may be based on some criteria.

Alternatively, instead of terminating the sensing session setup, the AP may, or may receive a request from SBP initiator in the case of SBP to, terminate a particular sensing measurement setup associated with the particular sensing responder. The AP may, or may receive a request from SBP initiator in the case of SBP to, wait for the period of time and then start another sensing measurement setup with the particular sensing responder, with identical or similar setting as the particular terminated sensing measurement setup.

Alternatively, the AP may, or may receive a request from SBP initiator in the case of SBP to, pause the sensing session (i.e. sensing session setup) with the particular sensing responder for the period of time, and resume the sensing session after the period of time.

Alternatively, the AP may, or may receive a request from SBP initiator in the case of SBP to, pause a particular sensing measurement session with the particular sensing responder for the period of time, and resume the particular sensing measurement session after the period of time.

Multicast or Broadcast of sounding signals from AP to more than one sensing responders in SBP. An AP may be a sensing initiator and also a sensing transmitter (e.g. in sensing session, or in SBP). It may send a sounding signal (e.g. NDP) to each of a number of sensing responders separately (i.e. point-to-point sounding). Alternatively, it may send sounding signal (e.g. NDP) to more than one sensing responders using multicast or broadcast such that sensing measurement results may be generated in the more than one sensing responders simultaneously or contemporaneously. The sensing measurement results may optionally (i.e. may/may not) be reported to the AP. In the case of SBP, the AP may optionally (i.e. may/may not) report the sensing measurement results to the SBP initiator.

Selective SBP. A proxy-initiator (e.g. SBP-initiator) may send a request to a wireless access point (AP) which is a proxy-responder (e.g. SBP-responder), such that non-selective wireless sensing (e.g. SBP) is performed between the AP (acting as sensing initiator, on behalf of the proxy-initiator) with any available sensing responders (e.g. non-AP STAs/devices, another AP, mesh AP) in the AP's wireless network. Each of the available sensing responders may be assigned/associated with an identity (ID, e.g. MAC address). The proxy-initiator (e.g. SBP-initiator) may send another request to the AP to perform selective wireless sensing (e.g. selective SBP) with a group of selected sensing responders in the AP's wireless network. Each selected sensing responders may be identified by the respective ID. Same or different sensing settings may be used for different sensing responders. For a sensing responder, same or different sensing settings may be used for different target tasks (for the case of more than one target tasks) or different proxy-initiators (for the case of more than one proxy-initiators).

The proxy-initiator may request the AP to provide a list of sensing-capable devices in the AP's network that support/is capable of wireless sensing (e.g. 802.11bf compatible), with associated device information (e.g. device name, host name, vendor class ID, device product name). The proxy-initiator may select the selected sensing responders based on the list and the associated device information.

The proxy-initiator may use a two-stage approach to do selective wireless sensing for a target task. In stage 1, the proxy-initiator may request/perform/use non-selective wireless sensing (i.e. sensing with all available sensing responders) to perform a trial/testing/training task with all the sensing responders and select the selected sensing responders based on the sensing results and some criteria. The trial/testing/training task may be a motion detection task. A location (or a mapping to some target physical device) of each sensing responder in a venue may be estimated in the trial/testing/training task and the selection may be based on the estimated locations (or the mapping) of the sensing responders. The proxy-selector may also select some device from the list of sensing-capable devices that did not participate in stage 1.

Then in stage 2, the proxy-initiator may request/perform selective wireless sensing for the target task with the selected sensing responders. The trial/testing/training task may be related to the target task in a certain way. The trial/testing/training task may have a low sensing requirement such that all sensing-capable wireless responders can satisfy the requirement and are capable of taking part in the non-selective wireless sensing. The trial/testing/training task may have sensing results useful for the selection of the selected sensing responders.

The proxy-initiator may use the two-stage approach to do selective wireless sensing for two target tasks. For each target task, a respective stage 1 followed by a respective stage 2 may be performed. Alternatively, a common stage 1 may be performed in which a first group of selected sensing responders may be selected for the first target task and a second group selected for the second target task. The first group may or may not overlap with the second group. Then separate stage 2 may be performed for the two target tasks (e.g. sequentially, simultaneously or contemporaneously) based on the respective group of selected sensing responders. If the first group and the second group overlap with at least one common sensing responder appearing in both groups, sensing results associated with the common sensing responder may be shared by both target tasks.

Two different proxy-initiators may use the two-stage approach to do selective wireless sensing for their respective target tasks. For each target task of each proxy-initiator, a respective stage 1 followed by a respective stage 2 may be performed. Alternatively, a first common stage 1 may be performed for the first proxy-initiator (to select a group of selected sensing responders for each of its target tasks) followed by separate stage 2 (to perform selective wireless sensing for each of its target tasks). Similarly, a second common stage 1 may be performed for the second proxy-initiator followed by separate stage 2 for each of its target tasks. Alternatively, a third common stage 1 may be performed for both proxy-initiators followed by separate stage 2 for each target tasks. If a common sensing responder is selected for more than one target tasks, sensing results associated with the common sensing responder may be shared by the more than one target tasks.

The proxy-initiator may be an “authorized” or “trusted” device that the AP allows/authorizes/authenticates to initiate one of the non-selective SBP, or non-selective SBP, or both. A first qualification test/setup/procedure may be performed in order for the SBP-initiator to be authorized by the AP to initiate non-selective SBP (first authorization). A second qualification test/setup/procedure may be performed in order for the SBP-initiator to be authorized by the AP to initiate selective SBP (second authorization). The SBP-initiator may have one of the first authorization and the second authorization, or both. One of the first authorization and the second authorization may imply the other.

The proxy-initiator may be connected to the AP via a wireless connection (e.g. the AP's wireless network, WiFi, WiMax, 4G/5G/6G/7G/8G, Bluetooth, UWB, mmWave, etc.) or via a wired connection (e.g. Ethernet, USB, fiber optics, etc.).

A sensing responder may/may not support non-selective proxy sensing (e.g. SBP), or selective proxy sensing or both. When sending sensing results to the AP for onward transmission to the proxy-initiator, a sensing responder may encrypt/process the sensing results so that the sensing results may not be decrypted/interpreted/consumed/made sense by AP (which does not have decryption key) but may be by the proxy-initiator (which has the decryption key).

Two devices each sending respective wireless signal (e.g. NDP) in respective ways (i.e. directions) in session based on a protocol/standard. First device transmits first wireless signal to second device which generates sensing measurement results (e.g. channel info/CI, TSCI, CSI, CIR, CFR, RSSI, etc.) from received first wireless signal. Second device transmits second wireless signal to third device (e.g. first device) which generates CI from received second wireless signal. The sensing measurement generations are in succession also.

Important special case: third device is first device, s.t. both first and second devices have their own TSCI and can perform wireless sensing computing. And there is no reporting of sensing measurement results. Protocol may be a default protocol, an industry standard, a national standard, an international standard, WLAN standard, WiFi, IEEE 802.11, 802.11bf, Bluetooth, UWB, 802.15, 802.16, cellular communication standard, 4G/5G/6G/7G/8G, WiMax, etc.

The following numbered clauses provide examples for two-way sensing.

Clause C1. A method/device/system/software of a wireless two-way sensing system, comprising: transmitting two wireless (sounding) signals in succession by two devices through a wireless multipath channel of a venue based on a protocol, a first wireless signal transmitted from a first heterogeneous wireless device to a second heterogeneous wireless device and a second wireless signal transmitted from the second heterogeneous wireless device to a third heterogeneous wireless device, wherein the wireless multipath channel is impacted by a motion of an object in the venue; receiving the two wireless signals in two ways in succession by two devices, the first wireless signal by the second device in the first way and the second wireless signal by the third device in the second way, wherein the transmitted first wireless signal differs from the received first wireless signal due to the multipath channel and the motion of the object, wherein the transmitted second wireless signal differs from the received second wireless signal due to the multipath channel and the motion of the object; obtaining two time series of channel information (TSCI) of the wireless multipath channel in the venue in succession by two devices based on the two received wireless signals, a first TSCI obtained by the second device based on the received first wireless signal and a second TSCI obtained by the third device based on the received second wireless signal; making the two TSCI available in two devices, the first TSCI available in the second device and the second TSCI available in the third device for applications.

In second and third devices: respective MLME sends a respective internal (electronic) signal/message to respective SME to indicate availability of respective TSCI in the respective device.

Clause C2. The method/device/system/software of the wireless two-way sensing system in clause C1, further comprising: sending two electronic signals in succession to indicate the availability of the two TSCI in the two devices based on the protocol; sending a second electronic signal within the second device from a second MAC layer management entity (MLME) of the second device to a second station management entity (SME) of the second device to indicate the availability of the first TSCI; sending a third electronic signal within the third device from a third MLME of the third device to a third SME of the third device to indicate the availability of the second TSCI.

Special case 1: First device=third device. First device is sensing initiator.

Clause C3. The method/device/system/software of the wireless two-way sensing system in clause C1 or 2, further comprising: initiating a sensing session by the first device based on the protocol, wherein the third device is the first device, wherein the first device is a sensing initiator, wherein the second device is a sensing responder, wherein the first wireless signal is an initiator- to responder (I2R) sounding signal, wherein the second wireless signal is a responder-to-initiator (R2I) sounding signal.

No report frame may be used by sensing responder to report its sensing measurement results to sensing initiator.

Clause C4. The method/device/system/software of the wireless two-way sensing system in clause C3, further comprising: wherein no wireless report frames are used by the sensing responder to transmit its TSCI (i.e. first TSCI) to the sensing initiator.

Alternatively, report frame may be optionally used by sensing responder to its report sensing measurement results to sensing initiator.

Clause C5. The method/device/system/software of the wireless two-way sensing system in clause C3, further comprising: wherein wireless report frames are optionally used by the second device (sensing responder) to transmit the first TSCI (i.e. sensing measurement generated in second device) to the first device (sensing initiator) such that both the first TSCI and second TSCI are available to the first device.

Trigger signal may be used to trigger the transmission of the two wireless signals in succession by the two devices. Trigger signal may be an NDPA frame, a Trigger Frame (TF), or another frame for triggering.

Clause C6. The method/device/system/software of the wireless two-way sensing system in clause C6, further comprising: transmitting a trigger signal by the sensing initiator to the sensing responder based on the protocol to trigger the transmission of the two wireless signals in succession by the two devices.

Special case 1a: Non-TB sensing, with a non-AP STA initiating sensing session. AP may be AP in WiFi/WLAN or base station in cellular communication.

Clause C7. The method/device/system/software of the wireless two-way sensing system in clause C3, further comprising: wherein the first device is a non-access point device (non-AP station or non-AP STA).

Special case 1b: TB sensing with an AP initiating sensing session. AP may be AP in WiFi/WLAN or base station in cellular communication.

Clause C8. The method/device/system/software of the wireless two-way sensing system in clause C3, further comprising: wherein the first device is an access point device (AP).

TB sensing may have a polling phase for sensing initiator (first device) to check “availability” of a number of devices (including second device). Each available device may reply to indicate that it is available.

Clause C9. The method/device/system/software of the wireless two-way sensing system in clause C8, further comprising: checking wirelessly for availability of a number of wireless heterogeneous devices (i.e. wireless station/STA) by the AP based on the protocol, wherein the second device is one of the number of wireless heterogeneous devices and is available.

The AP may send at least one polling frame to check for availability of the devices.

Clause C10. The method/device/system/software of the wireless two-way sensing system in clause C9, further comprising: transmitting a polling frame by the AP to the number of wireless heterogeneous devices based on the protocol to check wirelessly for their availability.

The available devices may send some wireless reply signal (e.g. “availability signal”) as a reply to indicate they are available.

Clause C11. The method/device/system/software of the wireless two-way sensing system in clause C9, further comprising: transmitting a wireless availability signal by any available wireless heterogeneous device to the AP based on the protocol to indicate it is available.

The wireless reply signal in previous clause C may be a “reply frame”.

Clause C12. The method/device/system/software of the wireless two-way sensing system in clause C11, further comprising: transmitting a reply frame by any available wireless heterogeneous device to the AP based on the protocol to indicate it is available.

All the devices being polled by AP may send some wireless reply signal (e.g. “availability signal”) as a reply to indicate its “availability”.

Clause C13. The method/device/system/software of the wireless two-way sensing system in clause C11, further comprising: transmitting a wireless availability signal by any wireless heterogeneous device to the AP based on the protocol to indicate its availability.

The wireless reply signal in previous clause C may be a “reply frame”.

Clause C14. The method/device/system/software of the wireless two-way sensing system in clause C13, further comprising: transmitting a reply frame by any wireless heterogeneous device to the AP based on the protocol to indicate its availability.

(SBP case) In SBP, a non-AP STA requests the AP to initiate sensing session.

Clause C15. The method/device/system/software of the wireless two-way sensing system in clause C8, further comprising: requesting the AP to initiate the sensing session by a non-AP heterogeneous wireless device.

(SBP case) In SBP, the non-AP STA initiates an SBP session by making SBP-request to AP.

Clause C16. The method/device/system/software of the wireless two-way sensing system in clause C15, further comprising: initiating a sensing-by-proxy (SBP) session by the non-AP device based on the protocol; making a SBP request by the non-AP device to the AP based on the protocol.

(SBP case) In SBP, the non-AP STA configures the SBP session.

Clause C17. The method/device/system/software of the wireless two-way sensing system in clause C16, further comprising: configuring the SBP session by the non-AP device.

(SBP case) In SBP, the non-AP STA configures the SBP session.

Clause C18. The method/device/system/software of the wireless two-way sensing system in clause C17, further comprising: configuring the sensing session indirectly by the non-AP device, by configuring the SBP session.

(SBP case) In SBP, the non-AP STA configures the SBP session.

Clause C19. The method/device/system/software of the wireless two-way sensing system in clause C18, further comprising: configuring the SBP session such that the AP does not report any TSCI to the non-AP device.

(SBP case) In SBP, the non-AP STA configures the SBP session.

Clause C20. The method/device/system/software of the wireless two-way sensing system in clause C19, further comprising: configuring the sensing session indirectly such that sensing responders do not use wireless report frames to report their TSCI to the AP.

Clause C21. The method/device/system/software of the wireless two-way sensing system in clause C8, further comprising: configuring the second device by the AP regarding the transmission of the second wireless signal and the reception of the first wireless signal in succession, the generation of the first TSCI based on the received first wireless signal, and the making available of the first TSCI, based on the protocol.

Clause C22. The method/device/system/software of the wireless two-way sensing system in clause C21, further comprising: configuring the second device and another device jointly by the AP based on at least one of: a combined set-up, a combined negotiation, or a combined configuration.

Clause C23. The method/device/system/software of the wireless two-way sensing system in clause C21, further comprising: configuring the second device and another device separately by the AP based on at least one of: respective individual set-ups, respective individual negotiations, or respective individual configurations.

A generalized daisy chain sensing with a scanning order of a plurality of devices (at least two devices). For example, a daisy chain comprises a simple scanning order in which each device appears once and only once in the scanning order except that the last device in the scanning order may be the first device in the scanning ordering.

The following numbered clauses provide examples for daisy-chain sensing.

Clause D1. A method/device/system/software of the wireless two-way sensing system, comprising: monitoring a motion of an object in a venue based on a plurality of heterogeneous wireless devices in the venue; determining a scanning order of the plurality of devices, wherein each device is scanned at least once in the scanning order; configuring the plurality of devices to perform sequential and iterative wireless sensing in succession according to the scanning order by obtaining wireless sensing measurement result between each pair of consecutively “scanned” devices based on the scanning order; transmitting sequentially and iteratively a series of wireless signals in succession through a wireless multipath channel of the venue based on a protocol among the plurality of devices according to the scanning order, each respective wireless signal transmitted between a respective pair of consecutively scanned devices; receiving the series of wireless signals sequentially and iteratively among the plurality of devices in succession according to the scanning order, each respective received wireless signal differs from the respective transmitted wireless signal due to the multipath channel and the motion of the object in the venue; obtaining a series of the wireless sensing measurement results sequentially and iteratively in succession based respectively on the series of wireless signals received sequentially and iteratively, making the series of wireless sensing measurement results available.

Clause D2. The method/device/system/software of the wireless two-way sensing system of Clause D1, further comprising: initializing the iterative wireless sensing by transmitting a wireless signal from a first scanned device to a second scanned device; receiving the wireless signal by the second scanned device; obtaining a second wireless sensing measurement result by the second scanned device based on the received wireless signal; making the second wireless sensing measurement result available by the second scanned device; transmitting another wireless signal from the second scanned device to a third scanned device; iteratively and sequentially receiving by a current scanned device a current wireless signal transmitted from a previous scanned device to the current scanned device; iteratively and sequentially obtaining a current wireless sensing measurement result by the current scanned device based on the received current wireless signal; iteratively and sequentially making the current wireless sensing measurement result available by the current scanned device; iteratively and sequentially transmitting a next wireless signal from the current scanned device to a next scanned device.

Clause D3. The method/device/system/software of the wireless two-way sensing system of Clause D2, further comprising: transmitting yet another wireless signal from the second scanned device to the first scanned device; iteratively and sequentially transmitting a current backward wireless signal from the current scanned device to the previous scanned device.

Clause D4. The method/device/system/software of the wireless two-way sensing system of Clause D3, further comprising: transmitting the yet another wireless signal before the another wireless signal; iteratively and sequentially transmitting the current backward wireless signal before the next wireless signal.

Clause D5. The method/device/system/software of the wireless two-way sensing system of Clause D1, comprising: initiating a sensing session by an access-point device (AP); transmitting a polling signal by the AP to poll the plurality of devices for their availability; transmitting a reply signal by each of the plurality of devices to the AP to indicate that it is available; configuring the plurality of devices by the AP. A non-AP STA (SBP initiator) may request the AP to initiate the sensing session.

Clause D6. The method/device/system/software of the wireless two-way sensing system of Clause D5, comprising: requesting by a non-AP heterogeneous wireless device the initiation of the sensing session by the AP.

Clause D7. The method/device/system/software of the wireless two-way sensing system of Clause D5, comprising: configuring the plurality of devices separately by the AP.

Clause D8. The method/device/system/software of the wireless two-way sensing system of Clause D5, comprising: configuring the plurality of devices jointly by the AP.

Coordinate the transmission/reception of wireless signals and TSCI generation.

Clause D9. The method/device/system/software of the wireless two-way sensing system of Clause D5, comprising: coordinating by the AP the sequential and iterative transmission and reception of the series of wireless signals and generation of the series of wireless sensing measurement results based on the wireless signals in succession by the plurality of devices according to the scanning order.

Clause D10. The method/device/system/software of the wireless two-way sensing system of Clause D5, comprising: triggering the plurality of devices to transmit the series of wireless signals sequentially and iteratively in succession.

Clause D11. The method/device/system/software of the wireless two-way sensing system of Clause D10, comprising: triggering by the AP the transmission of the wireless signal by the first scanned device; iteratively triggering the transmission of the next wireless signal by the reception of the current wireless signal.

Clause D12. The method/device/system/software of the wireless two-way sensing system of Clause D10, comprising: triggering by the AP all the transmission of the wireless signals by the respective scanned device.

Clause D13. The method/device/system/software of the wireless two-way sensing system of Clause D1, comprising: wherein the scanning order comprises every possible pairing among the plurality of devices, similar to a fully-connected network.

Clause D14. The method/device/system/software of the wireless two-way sensing system of Clause D1, comprising: wherein the last scanned device is the first scanned device in the scanning order.

Clause D15. The method/device/system/software of the wireless two-way sensing system of Clause D1, comprising: wherein the scanning order establishes a daisy chain of devices.

In regular SBP, any client devices of the network can be considered by AP (sensing initiator) as sensing responder. But in “selective SBP,” only some client devices can be considered. SBP is “selective” because the number N (or amount) and the N particular client devices (identified by MAC) are selected by SBP-initiator and ultimately by SBP-responder, and are specified/communicated/negotiated between SBP-initiator and SBP-responder.

The following numbered clauses provide examples for selective SBP.

Clause E1. A method/device/system/software of a wireless sensing system, comprising: configuring an access-point (AP) device of a wireless data communication network based on a wireless protocol by a first particular client device of the wireless network to perform a sensing-by-proxy (SBP) procedure selectively, wherein the wireless protocol comprises one of: a wireless local area network (WLAN) protocol, WiFi, Zigbee, Bluetooth, IEEE 802, IEEE 802.11, IEEE 802.11bf, IEEE 802.15, IEEE 802.16, 4G/5G/6G/7G/8G, wherein the first particular client device functions as a SBP-initiator device and the AP device functions as a SBP-responder device in the SBP procedure; performing the SBP procedure selectively by the AP device based on the wireless protocol by configuring, on behalf of the first particular client device, a number of second particular client devices of the wireless network to perform a wireless sensing procedure, where the AP device functions as a sensing-initiator device and all the second particular client devices function as sensing-responder devices in the wireless sensing procedure.

Clause E2. The method/device/system/software of a wireless sensing system of clause E1, comprising: configuring the AP device by the first particular client device using at least one configuration field of at least one configuration frame exchanged between the two devices during a setup procedure of the SBP procedure based on the wireless protocol.

Clause E3. The method/device/system/software of a wireless sensing system of clause E2, comprising: communicating at least one selected item between the AP device and the first particular client device based on the wireless protocol using the at least one configuration field of the at least one configuration frame.

In one embodiment, SBP-initiator may want N sensing responders, and may select/specify k particular ones. The other (N-k) may be selected by SBP-responder.

Clause E4. The method/device/system/software of a wireless sensing system of clause E3, comprising: selecting at least one of the second particular client devices by the first particular client device and ultimately by the AP device.

Clause E5. The method/device/system/software of a wireless sensing system of clause E4: wherein at least one of the second particular client devices is not selected by the first particular client device, but is selected by the AP device.

In another embodiment, SBP-initiator may want N sensing responders, and select/specify N particular ones.

Clause E6. The method/device/system/software of a wireless sensing system of clause E4, comprising: selecting all of the second particular client devices by the first particular client device and ultimately by the AP device.

Clause E7. The method/device/system/software of a wireless sensing system of clause E6, comprising: selecting by the first particular client device to include itself in the number of the selected second particular client devices.

Clause E8. The method/device/system/software of a wireless sensing system of clause E6, comprising: selecting by the first particular client device not to include itself in the number of the selected second particular client devices.

Clause E9. The method/device/system/software of a wireless sensing system of clause E6, comprising: selecting an amount of the second particular client devices by the first particular client device and ultimately by the AP device.

Clause E10. The method/device/system/software of a wireless sensing system of clause E4, comprising: selecting an amount of the at least one of the second particular client devices by the first particular client device and ultimately by the AP device.

In yet another embodiment, SBP-initiator may select/provide a wish-list of N+k candidate sensing responders. SBP-responder may choose N out of the N+k candidates.

Clause E11. The method/device/system/software of a wireless sensing system of clause E4, comprising: providing by the first particular client device to the AP device based on the wireless protocol a list of selected client devices comprising the number of second particular client devices.

Clause E12. The method/device/system/software of a wireless sensing system of clause E11, comprising: wherein the list comprise the first particular client device, as selected by the first particular client device.

Clause E13. The method/device/system/software of a wireless sensing system of clause E6, comprising: wherein the list do not comprise the first particular client device, as selected by the first particular client device.

SBP-initiator may identify each sensing responder/candidate sensing responder with associated MAC address. SBP-responder may reply with associated MAC address and ID.

Clause E14. The method/device/system/software of a wireless sensing system of clause E6, comprising: identifying each selected second particular client device by at least one of: its respective MAC address, or a identifier (ID) in the at least one configuration field of the at least one configuration frame.

Clause E15. The method/device/system/software of a wireless sensing system of clause E14, comprising: selecting a set of sensing measurement setup parameters for the wireless sensing procedure by the first particular client device and ultimately by the AP device.

Sensing transmitter may be Type1 device. Sensing receiver may be Type2 device.

Clause E16. The method/device/system/software of a wireless sensing system of clause E15, comprising: for each of the number of second particular client devices: determining the AP device and the respective second particular client device to function as a pair of sensing-transmitter device and a sensing-receiver device based on the set of sensing measurement setup parameters, transmitting a time series of wireless sounding signals (WSS) based on the wireless protocol by the sensing-transmitter device; receiving the time series of WSS (TSWSS) based on the wireless protocol by the sensing-receiver device through a wireless multipath channel; obtaining a time series of channel information (TSCI) of the wireless multipath channel by the sensing-receiver device based on the received TSWSS based on the wireless protocol, wherein each CI comprises at least one of: a channel state information (CSI), a channel impulse response (CIR), or a channel frequency response (CFR), wherein each channel information (CI) of the TSCI is obtained based on a respective received WSS; making the TSCI available either at the sensing receiver or the first particular client device, wherein the TSCI is labeled with the respective ID associated with the respective second particular client device when it is made available at the first particular client device.

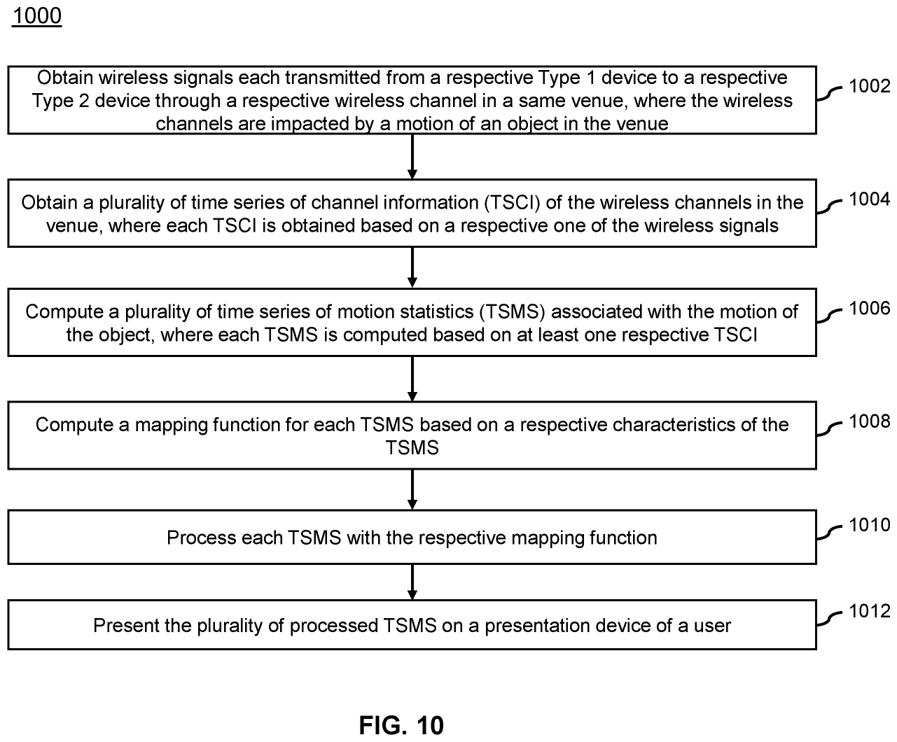

FIG. 10 illustrates a flow chart of an exemplary method 1000 of a wireless sensing presentation system, according to some embodiments of the present disclosure. In various embodiments, the method 1000 can be performed by the systems disclosed above. At operation 1002, the wireless sensing presentation system obtains wireless signals each transmitted from a respective Type 1 device to a respective Type 2 device through a respective wireless channel in a same venue, where the wireless channels are impacted by a motion of an object in the venue. At operation 1004, the system obtains a plurality of time series of channel information (TSCI) of the wireless channels in the venue, where each TSCI is obtained based on a respective one of the wireless signals.

At operation 1006, the system computes a plurality of time series of motion statistics (TSMS) associated with the motion of the object, where each TSMS is computed based on at least one respective TSCI. At operation 1008, a mapping function is computed for each TSMS based on a respective characteristic of the TSMS. At operation 1010, each TSMS is processed with the respective mapping function. At operation 1012, the plurality of processed TSMS are presented on a presentation device of a user. The order of the operations in FIG. 10 may be changed according to various embodiments of the present teaching.

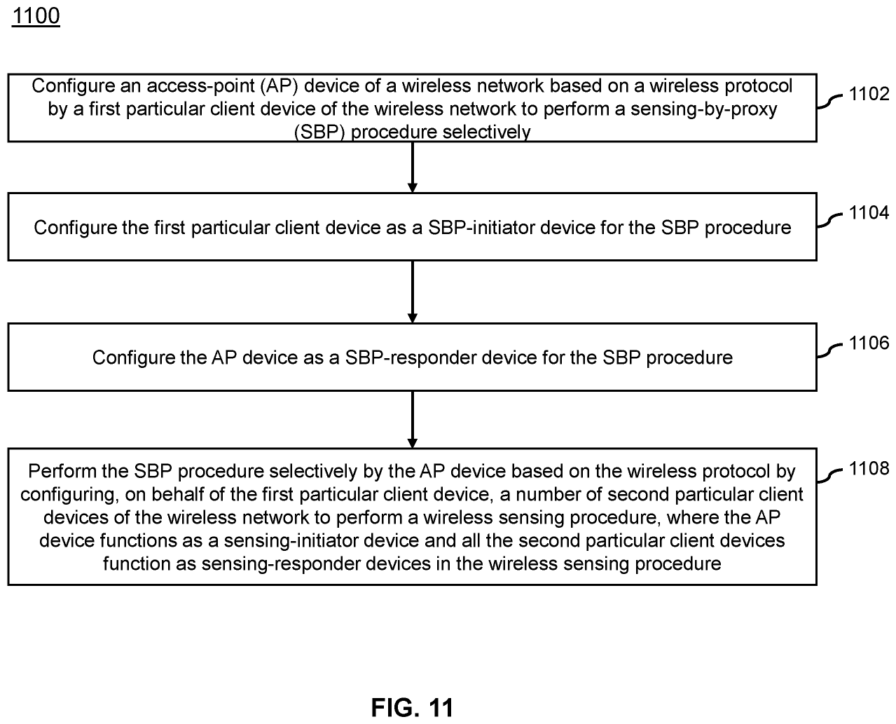

FIG. 11 illustrates a flow chart of an exemplary method 1100 for performing a selective sensing-by-proxy procedure, according to some embodiments of the present disclosure. In various embodiments, the method 1100 can be performed by the systems disclosed above. At operation 1102, an access-point (AP) device of a wireless network is configured based on a wireless protocol by a first particular client device of the wireless network to perform a sensing-by-proxy (SBP) procedure selectively. At operation 1104, the first particular client device is configured as a SBP-initiator device for the SBP procedure. At operation 1106, the AP device is configured as a SBP-responder device for the SBP procedure. At operation 1108, the SBP procedure is performed selectively by the AP device based on the wireless protocol based on configuring, on behalf of the first particular client device, a number of second particular client devices of the wireless network to perform a wireless sensing procedure, where the AP device functions as a sensing-initiator device and all the second particular client devices function as sensing-responder devices in the wireless sensing procedure. The order of the operations in FIG. 11 may be changed according to various embodiments of the present teaching.

The features described above may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., C, Java), including compiled or interpreted languages, and it may be deployed in any form, including as a stand-alone program or as a module, component, subroutine, a browser-based web application, or other unit suitable for use in a computing environment.

Suitable processors for the execution of a program of instructions include, e.g., both general and special purpose microprocessors, digital signal processors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

While the present teaching contains many specific implementation details, these should not be construed as limitations on the scope of the present teaching or of what may be claimed, but rather as descriptions of features specific to particular embodiments of the present teaching. Certain features that are described in this specification in the context of separate embodiments may also be implemented in combination in a single embodiment. Conversely, various features that are described in the context of a single embodiment may also be implemented in multiple embodiments separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described. Any combination of the features and architectures described above is intended to be within the scope of the following claims. Other embodiments are also within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A system for wireless sensing, comprising:
a set of heterogeneous wireless devices in a venue, wherein
the set of heterogeneous wireless devices comprise: a first device, a second device, and a particular device,
the particular device comprises a first radio and a second radio,
the particular device is configured to communicate with the first device through a first wireless channel based on a first protocol using the first radio,
the particular device is configured to communicate with the second device through a second wireless channel based on a second protocol using the second radio; and
a processor configured for:
obtaining a time series of channel information (TSCI) of the second wireless channel based on a wireless signal that is communicated between the particular device and the second device through the second wireless channel using the second radio of the particular device, wherein each channel information (CI) comprises at least one of: channel state information (CSI), channel impulse response (CIR) or channel frequency response (CFR),
computing a pairwise sensing analytics based on the TSCI, and
computing a combined sensing analytics based on the pairwise sensing analytics,
wherein the particular device is configured to transmit the combined sensing analytics to the first device through the first wireless channel using the first radio of the particular device,
wherein the set of heterogeneous wireless devices is configured to perform a wireless sensing task based on the combined sensing analytics.

2. The system of claim 1, wherein:
a first subset of the set of heterogeneous wireless devices is configured to perform the wireless sensing task using a first wireless network in the venue;
the first subset comprises the particular device and the first device;
a second subset of the set of heterogeneous wireless devices is configured to further perform the wireless sensing task using a second wireless network in the venue;
the second subset comprises the particular device and the second device;
the first radio, the first wireless channel, and the first protocol are associated with the first wireless network;
the second radio, the second wireless channel, and the second protocol are associated with the second wireless network; and
one of the first protocol or the second protocol comprises at least one of: a WiFi standard, a UWB standard, a WiMax standard, an IEEE standard, an IEEE 802 standard, an IEEE 802.11 standard, an IEEE 802.11bf standard, an 802.15 standard, an 802.15.4 standard, or an 802.16 standard.

3. The system of claim 2, wherein:
the particular device and the first device are authenticated and associated in the first wireless network; and
the particular device and the second device are authenticated and associated in the second wireless network.

4. The system of claim 3, wherein:
the wireless signal is transmitted from the second device to the particular device based on the second protocol; and
the TSCI is extracted from the wireless signal by the particular device.

5. The system of claim 4, wherein:
the wireless signal is transmitted based on a trigger signal received by the second device from an access point (AP) of the second wireless network, based on the second wireless protocol.

6. The system of claim 4, wherein:
the wireless signal is received based on a trigger signal received by the particular device from an access point (AP) of the second wireless network, based on the second wireless protocol.

7. The system of claim 3, wherein:
the wireless signal is transmitted from the particular device to the second device based on the second protocol; and
the TSCI is extracted from the wireless signal by the second device.

8. The system of claim 3, wherein:
the second subset of the set of heterogeneous wireless devices comprises: a third device and a fourth device that are associated with the second wireless network;
the fourth device is configured to obtain a second TSCI of the second wireless channel based on a second wireless signal that is transmitted from the third device to the fourth device through the second wireless channel in the second wireless network;
the particular device is configured to obtain a second pairwise sensing analytics computed based on the second TSCI; and
the combined sensing analytics is computed based on the pairwise sensing analytics and the second pairwise sensing analytics.

9. The system of claim 8, wherein the fourth device is configured to:
compute the second pairwise sensing analytics based on the second TSCI; and
transmit the second pairwise sensing analytics to the particular device.

10. The system of claim 8, wherein:
the fourth device is configured to transmit the second TSCI to the particular device; and
the particular device is configured to compute the second pairwise sensing analytics based on the second TSCI.

11. The system of claim 8, wherein the particular device is configured to:
obtain a second combined sensing analytics associated with a third wireless network, wherein the combined sensing analytics is computed based on the second combined sensing analytics.

12. The system of claim 11, wherein:
a third subset of the set of heterogeneous wireless devices is configured to further perform the wireless sensing task using the third wireless network in the venue;
the third subset comprises: a fifth device and a sixth device that are associated with the third wireless network, and a second particular device;
the sixth device is configured to obtain a third TSCI of a third wireless channel based on a third wireless signal that is transmitted from the fifth device to the sixth device through the third wireless channel in the third wireless network;
the second particular device is configured to obtain a third pairwise sensing analytics computed based on the third TSCI, and compute the second combined sensing analytics based on the third pairwise sensing analytics; and
the particular device is configured to obtain the second combined sensing analytics from the second particular device.

13. The system of claim 12, wherein the particular device is configured to:
obtain a third combined sensing analytics associated with a fourth wireless network, wherein the combined sensing analytics is computed further based on the third combined sensing analytics.

14. The system of claim 13, wherein:
a fourth subset of the set of heterogeneous wireless devices is configured to further perform the wireless sensing task using the fourth wireless network in the venue;
the fourth subset comprises: a seventh device and an eighth device that are associated with the fourth wireless network, and a third particular device;
the eighth device is configured to obtain a fourth TSCI of a fourth wireless channel based on a fourth wireless signal that is transmitted from the seventh device to the eighth device through the fourth wireless channel in the fourth wireless network;
the third particular device is configured to obtain a fourth pairwise sensing analytics computed based on the fourth TSCI, and compute the third combined sensing analytics based on the fourth pairwise sensing analytics; and
the particular device is configured to obtain the third combined sensing analytics from the third particular device.

15. The system of claim 14, wherein:
a fifth subset of the set of heterogeneous wireless devices is configured to further perform the wireless sensing task using a fifth wireless network in the venue;
the fifth subset comprises: a ninth device and a tenth device that are associated with the fifth wireless network, and a fourth particular device;
the tenth device is configured to obtain a fifth TSCI of a fifth wireless channel based on a fifth wireless signal that is transmitted from the ninth device to the tenth device through the fifth wireless channel in the fifth wireless network;
the fourth particular device is configured to obtain a fifth pairwise sensing analytics computed based on the fifth TSCI, and compute a fourth combined sensing analytics based on the fifth pairwise sensing analytics; and
the first device is configured to obtain the fourth combined sensing analytics from the fourth particular device, wherein the wireless sensing task is performed based on the fourth combined sensing analytics.

16. The system of claim 15, wherein:
the wireless sensing task is performed by the set of heterogeneous wireless devices using multiple wireless networks in the venue, with at least two of the set of heterogeneous wireless devices assigned to each of the multiple wireless networks;
the multiple wireless networks have a multi-tier structure comprising at least two tiers;
the first wireless network is a Tier-1 network of the multiple wireless networks and comprises at least: the particular device and the first device;
the second wireless network is a Tier-2 network of the multiple wireless networks and comprises at least: the particular device, the second device, the third device and the fourth device;
the particular device serves as a gateway device between the first wireless network and the second wireless network, such that sensing results of the wireless sensing task are transmitted from the particular device via the first wireless network to the first device;
heterogeneous wireless devices in a Tier-K network of the multiple wireless networks are configured to report sensing results obtained in the Tier-K network to a heterogeneous wireless device in a Tier-(K−1) network of the multiple wireless networks via a gateway device between the Tier-K network and the Tier-(K−1) network, wherein K is an integer greater than one, wherein the reported sensing results comprise at least one of: a combined sensing analytics, a pairwise sensing analytics or TSCI.

17. The system of claim 16, wherein:
the first wireless network further comprises: the second particular device and the third particular device;
the third wireless network is a Tier-3 network of the multiple wireless networks and comprises at least: the second particular device that is a gateway device, the fifth device, and the sixth device,
the second particular device is a gateway device, such that sensing results obtained in the third wireless network are transmitted from the second particular device via the first wireless network to the particular device;
the fourth wireless network is a Tier-3 network of the multiple wireless networks and comprises at least: the third particular device that is a gateway device, the seventh device, and the eighth device; and
the third particular device is a gateway device, such that sensing results obtained in the fourth wireless network are transmitted from the third particular device via the first wireless network to the particular device.

18. The system of claim 17, wherein:
the first wireless network further comprises the fourth particular device;
the fourth wireless network is a Tier-2 network of the multiple wireless networks and comprises at least: the fourth particular device, the ninth device, and the tenth device; and
the fourth particular device is a gateway device, such that sensing results are transmitted from the fourth particular device via the first wireless network to the first device.

19. The system of claim 18, wherein:
the first wireless network is associated with a zone of the venue;
the second wireless network is associated with a first sub-zone of the zone;
the third wireless network is associated with a first sub-sub-zone of the first sub-zone; and
the fourth wireless network is associated with a second sub-sub-zone of the first sub-zone.

20. The system of claim 19, wherein the set of heterogeneous wireless devices is configured to:
perform the wireless sensing task for the zone based on at least one of:
any pairwise sensing analytics associated with the first wireless network,
the combined sensing analytics associated with the second wireless network, or
the fourth combined sensing analytics associated with the fifth wireless network;
perform the wireless sensing task for the first sub-zone based on at least one of:
any pairwise sensing analytics associated with the second wireless network,
the combined sensing analytics associated with the second wireless network,
the second combined sensing analytics associated with the third wireless network, or
the third combined sensing analytics associated with the fourth wireless network;
associate the third wireless network with the first sub-zone of the zone;
perform a wireless sensing subtask associated with the first sub-zone based on the third wireless network and another combined sensing analytics; and
associate the fourth wireless network with a second sub-zone of the zone.

21. A method performed by a set of heterogeneous wireless devices in a venue for wireless sensing, comprising:
communicatively coupling a particular device of the set with a first device of the set through a first wireless channel based on a first protocol using a first radio of the particular device;
communicatively coupling the particular device with a second device of the set through a second wireless channel based on a second protocol using a second radio of the particular device;
performing a pairwise sub-task by the particular device and the second device based on a wireless signal communicated between the particular device and the second device through the second wireless channel using the second radio of the particular device;
obtaining by the particular device a pairwise sensing analytics computed based on a time series of channel information (TSCI) of the second wireless channel extracted from the wireless signal, wherein each channel information (CI) comprises at least one of: channel state information (CSI), channel impulse response (CIR) or channel frequency response (CFR);
computing a combined sensing analytics by the particular device based on the pairwise sensing analytics;
transmitting the combined sensing analytics by the particular device to the first device through the first wireless channel using the first radio of the particular device; and
performing a wireless sensing task based on the combined sensing analytics.
